(19) United States
(12) Patent Application Publication
(10) Pub. No.: US 2026/0071608 A1
(43) Pub. Date: Mar. 12, 2026

(54) Solar Vortex Clamshell Greenhouse

(71) Applicants: William Wallace Graham, Palos Hills, IL (US); Earl Lee Senchuk, Marquette, MI (US)

(72) Inventors: William Wallace Graham, Palos Hills, IL (US); Earl Lee Senchuk, Marquette, MI (US)

(21) Appl. No.: 19/324,032

(22) Filed: Sep. 9, 2025

Related U.S. Application Data
(60) Provisional application No. 63/732,643, filed on Sep. 9, 2024.

(51) Int. Cl. F03D 9/00; A01G 7/04; A01G 31/00; A01G 31/02; F03D 9/11; F03D 9/45; F24S 20/67

(52) U.S. Cl. CPC F03D 9/007; A01G 7/045; A01G 31/008; A01G 31/02; F03D 9/11; F03D 9/45; F24S 20/67; F05B 2240/9112

(57) ABSTRACT

The present invention relates to a dual-use solar vortex greenhouse with a clamshell-shaped roof comprising a plurality of multi-paned, paired trapezoidal chutes (1) configured to capture and concentrate solar-heated air. Heated and moistened air flows through vanes (32, 33) into a swirl chamber (27), forming a vortex that spins an electric wind turbine (10) to generate electricity. A cone (2) and stack (16) assembly stabilize the vortex and directs exhaust upward. The interior of the greenhouse (55) supports hydroponic plant cultivation with integrated climate control systems, including shutters and/or orifice closure doors (11,42,35), dampers (23,30,31) misters (34), and radiators (43), which are electronically regulated by a plurality of thermostats (41) including a humidistat, anemometers (41), actuators (24) including a photocell sensor. The structure is modular and latitude-adjustable for maximizing solar capture, and can be prefabricated. The invention integrates renewable energy generation with sustainable food production, providing efficient use of land, water, and solar resources.

### PRIORITY

This application claims priority for the U.S. provisional application Ser. No. 63/732,643 filed on Sep. 9, 2024.

### FIELD OF THE INVENTION

The present invention generally relates to renewable energy systems and sustainable agricultural technology. More specifically, it relates to a solar-powered greenhouse featuring a clamshell structure that generates electricity through a controlled vortex of heated air powered by the energy harvested from the Sun, while also supporting hydroponic food production.

### INCORPORATION BY REFERENCE

All publications, patents, and patent applications mentioned in this specification are herein incorporated by reference in their entirety to the same extent as if each publication or patent application were specifically and individually indicated to be incorporated by reference.

### BACKGROUND OF THE INVENTION

The accelerating processes of desertification, soil degradation, and the depletion of potable water resources increasingly challenge agricultural production worldwide. Expanding arid regions and shifting climate conditions reduce the amount of viable farmland available for cultivation. Traditional open-field farming methods often depend on large tracts of fertile soil and consistent rainfall or irrigation from fresh water sources. As these resources become scarcer, sustaining crop yields through conventional means is becoming less feasible.

Greenhouses are widely used in agriculture, horticulture, and research to provide controlled environments for plant growth independent of outdoor weather conditions. Traditional greenhouses rely on natural sunlight for photosynthesis, while requiring supplemental energy for heating, cooling, lighting, and irrigation systems. These translate into substantial energy inputs for climate regulation, irrigation, and lighting. These energy requirements are commonly met through connection to electrical grids or the use of non-renewable, fossil-fuel-based power sources. Such reliance increases operating costs, introduces limitations in remote or off-grid locations, and contributes to environmental impacts associated with conventional energy generation. These energy needs limit their efficiency and adaptability in remote or desert-bordering regions where power infrastructure may be lacking.

Another problem with conventional greenhouse technology requiring energy-intensive heating, ventilation, and air conditioning (HVAC) systems powered by fossil fuels is that these solar energy collection systems, such as photovoltaic panels and solar concentrators developed to supply electricity, require large areas, expensive materials, and complicated maintenance. Similarly, large-scale wind turbines and solar tower power plants involve costly infrastructure, are subject to weather variability, and typically do not integrate food production.

Efforts have been made to reduce the energy footprint of greenhouses by incorporating renewable energy systems. Solar energy, in particular, has been explored as a sustainable source of power for greenhouse operations. Conventional approaches often utilize rooftop-mounted photovoltaic panels or adjacent solar arrays. However, these solutions may present challenges, including shading of crops, reduced efficiency due to suboptimal panel placement, limited surface area for installation, and lack of integration with the greenhouse's structural and environmental control systems.

In addition, conventional farming and greenhouse systems face challenges in extreme climates, where stagnant heat, low humidity, and limited rainfall reduce crop survival. High heat absorption by bare ground in near-desert or desertified conditions intensifies thermal stress, creating inhospitable environments for both open-field crops and livestock. An additional challenge lies in the absence of microclimate regulation, where conventional methods rarely alter localized atmospheric conditions such as cloud cover or albedo, which could otherwise mitigate excess heat and improve growing conditions.

For decades, inventors have explored the concept of harnessing solar energy by creating artificial atmospheric vortices to drive turbines. However, many previous attempts suffered from inefficiencies, unstable airflow, or impractical construction requirements. A need exists for a greenhouse structure that can both maximize solar energy capture for power generation and simultaneously provide a viable environment for agriculture, while maintaining cost-effectiveness, scalability, and structural resilience.

Examples exist in the art where researchers have studied solar updraft towers and atmospheric vortex-based engines as means to convert solar heating into mechanical and electrical energy, disclosing solar updraft and vortex engines using vertical towers and vane structures. These systems face critical drawbacks, including high capital costs due to tall chimney structures or massive reinforced bases; drag losses in chimney-based updraft systems, reducing efficiency; limited use of collector area, which is typically barren and unproductive; no dual-use benefit, as collector fields are dedicated only to energy generation; and operational instability when solar input is reduced (with clouds, or at night).

Accordingly, there remains a need for improved greenhouse systems that integrate solar energy harvesting directly into their design, enabling efficient use of available sunlight for both plant growth and energy generation on the one hand, and provide greenhouse designs that integrate solar power generation with advanced environmental control systems to address both energy independence and water efficiency on the other hand. Such systems would ideally provide self-sufficiency in power supply, reduce dependence on external energy sources, and enhance greenhouse operation in off-grid, rural, or resource-limited settings. Further, such systems would ideally enable farming in regions without access to traditional farmland, provide improved water recycling or condensation-based irrigation methods, and establish microclimates that not only sustain crops but also reduce heat accumulation. By increasing localized albedo and promoting the formation of protective cloud cover over greenhouse and farming areas, these systems could reduce stagnant heat loads and extend the viability of agriculture even under near-desert conditions.

The present invention addresses this need and problem by providing a clamshell-shaped solar vortex greenhouse that integrates energy production with food cultivation, water efficiency, and climate control in a single unified structure.

### SUMMARY OF THE INVENTION

The following listing of embodiments is a non-limiting statement of various aspects of the invention. Other aspects and variations will be evident in light of the entire disclosure.

The present invention relates to solar thermal energy conversion, more specifically to a solar vortex clamshell greenhouse that integrates atmospheric vortex generation, greenhouse farming, and hybrid mist/heat-exchange systems. In other words, it provides a solar vortex clamshell greenhouse that converts solar-heated air into electrical power while functioning as an agricultural enclosure, particularly for hydroponics.

The present invention provides a solar vortex clamshell greenhouse designed to generate renewable electrical power while simultaneously providing a controlled micro-climate for agricultural use. The present invention provides a solar vortex generator greenhouse that combines atmospheric vortex power generation with plant cultivation in a climate-controlled greenhouse, using a clamshell array of solar-heated chute assemblies, antifreeze-buffered heat storage, and misting augmentation systems.

The present invention, as disclosed, provides a greenhouse with the roof of the greenhouse made by a plurality of triangular chutes (1) arranged in a clamshell configuration around a central column. Each of the chutes (1) includes: transparent UV-resistant plastic sheeting, a black open-weave cloth for controlled heat absorption, and structural framing optimized for local solar incidence angles. The chutes (1) guide solar-heated air, humidified by misting with water vapor pumped into the chutes (1) by a plurality of misters (34), increasing the air pressure of the forming vortex spinning into a central swirl chamber (27) at the top of the greenhouse. The vortex from the chutes (1) is supplemented by supplementary heated and moistened air entering through a plurality of sails (39) from the interior of the greenhouse (55). The heated and humidified air exits through a right-side-up funnel exhaust through a cone (2) and stack (16) assembly at the top of the greenhouse, which reduces drag compared to chimney-style towers. An electric wind turbine (27) in a turbine assembly located above the funnel cone (2) captures rotational energy of the vortex to generate electricity. A misting system formed by the plurality of misters (34) injects heated water vapor into the rising air in the chutes (1). The water is heated via a solar-heated antifreeze-buffered storage system, ensuring extended vortex operation even during low sunlight, at night, and in the cold climate. The clamshell enclosure doubles as a greenhouse farm in the interior of the greenhouse (55) below the clamshell roof, enabling the cultivation of plants under moderated micro-climate conditions, where the misting system provides water vapor while a solar-heated antifreeze solution circulates through a plurality of radiators (46) to help maintain the humidity and temperature for optimal plant growth inside the greenhouse. The modular design supports scalability from small-acre community farms to multi-acre vortex power stations.

In other words, the present invention provides a solar vortex clamshell greenhouse that (i) collects solar heat in an array of triangular chute assemblies arranged in a clamshell dome at the top of the greenhouse around a central chamber; (ii) guides heated air into a vortex using transparent spiral sails and vanes both from the interior of the greenhouse and from the chutes; (iii) exhausts the vortex through a wide-topped funnel, which is right side up to reduce drag; (iv) converts airflow into energy with an electric wind turbine nested in a swirl chamber; (v) sustains operation with a misting system powered by an antifreeze-buffered thermal storage tank; (vi) functions as a greenhouse enclosure, producing plants including crops alongside renewable energy, where systems are powered by the electricity generated by the turbine; and (vii) creates a micro-environment in and around the greenhouse for sustainable agriculture in otherwise challenging environmental regions with difficult terrain, desertification, energy supply challenges, and paucity of water.

Other objects, features, and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF THE DRA WINGS

The accompanying drawings are included to provide a further understanding of the invention and are incorporated in and constitute a part of the present invention and, together with the description, serve to explain the principle of the invention.

In the drawings,

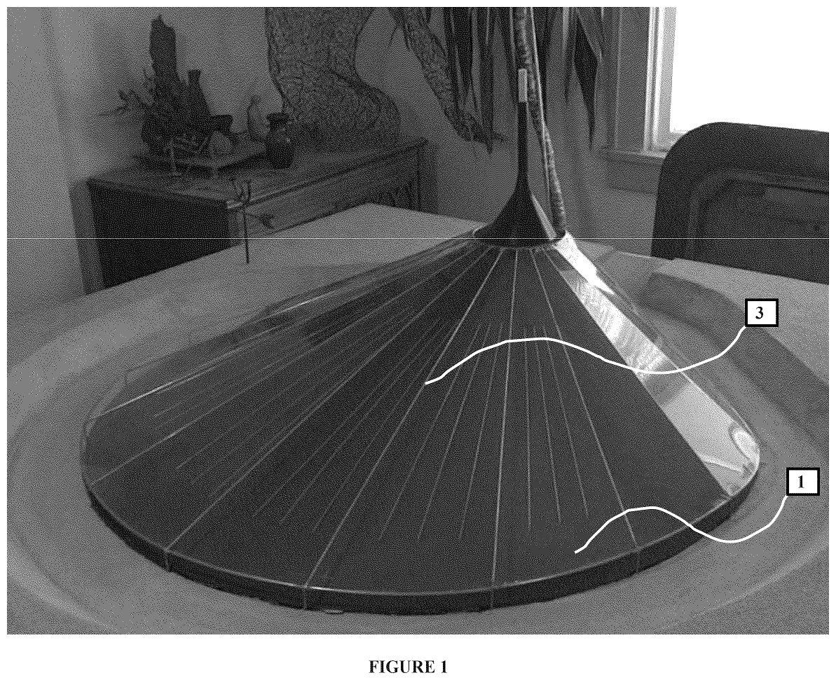

FIG. 1 illustrates a representative illustration of an initial prototype photograph of the inventors' concept used as the foundation for the present functional design for the present invention. It is a side view of the original clamshell prototype before current modifications that lead to the current design of the present invention's solar vortex clamshell greenhouse.

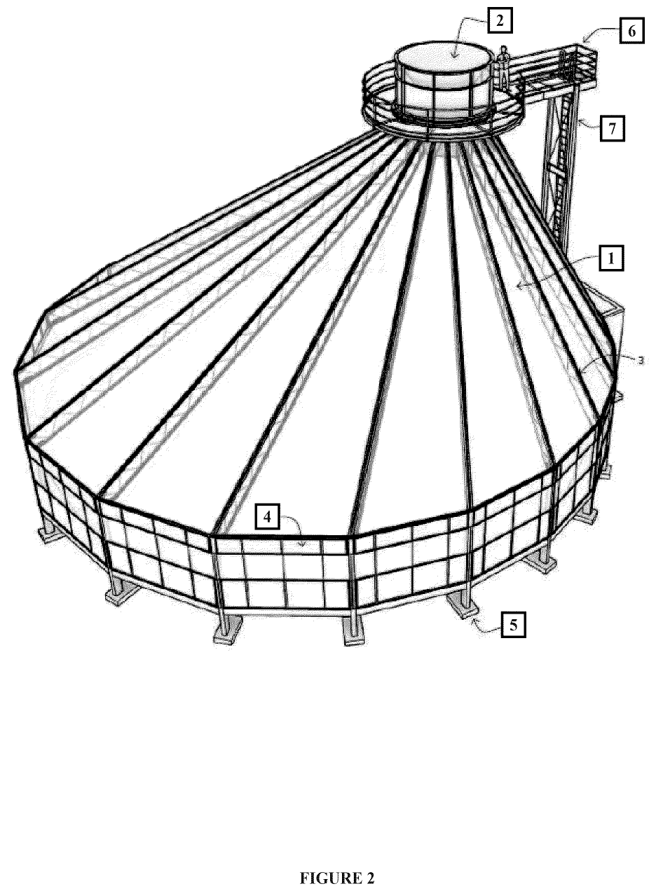

FIG. 2 illustrates a representative illustration of a schematic of an improved functional design of an embodiment of the present invention. It is a three-quarter exterior view of southern exposure of clamshell greenhouse of the present invention.

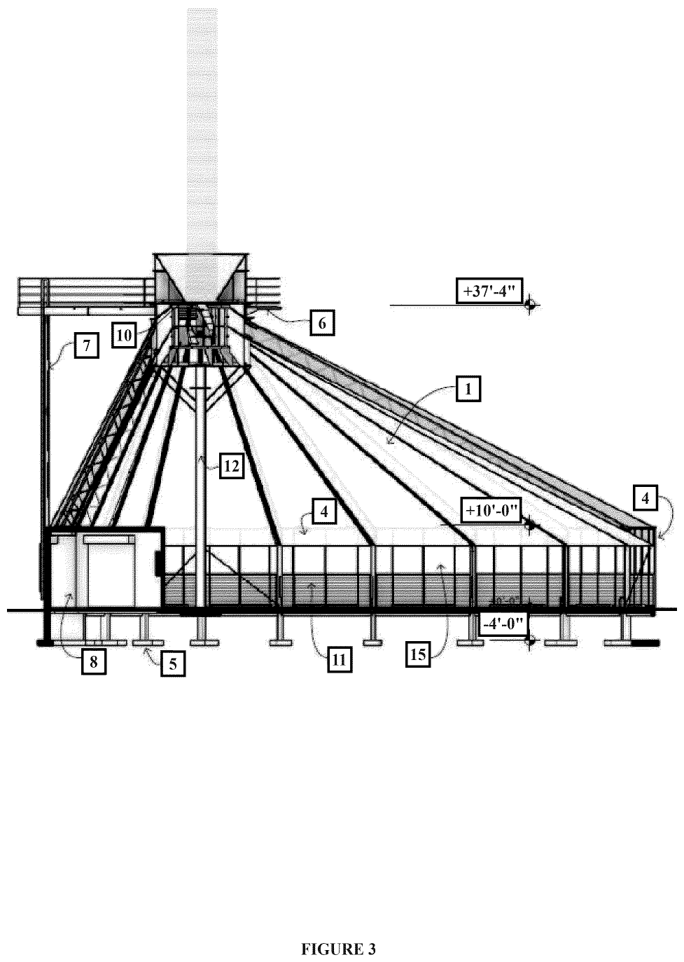

FIG. 3 illustrates a representative illustration of a schematic of a sectional view of the improved functional design of an embodiment of the present invention. It is a sectional view of west side of clamshell greenhouse of the present invention.

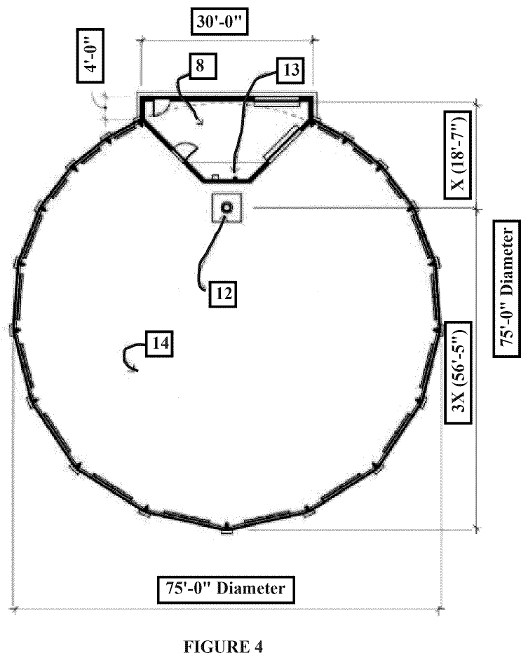

FIG. 4 illustrates a representative illustration of a schematic of an embodiment of the present invention providing an additional view of the support of the greenhouse. It is a representation of the present invention's solar vortex clamshell greenhouse floor with support points around circumference.

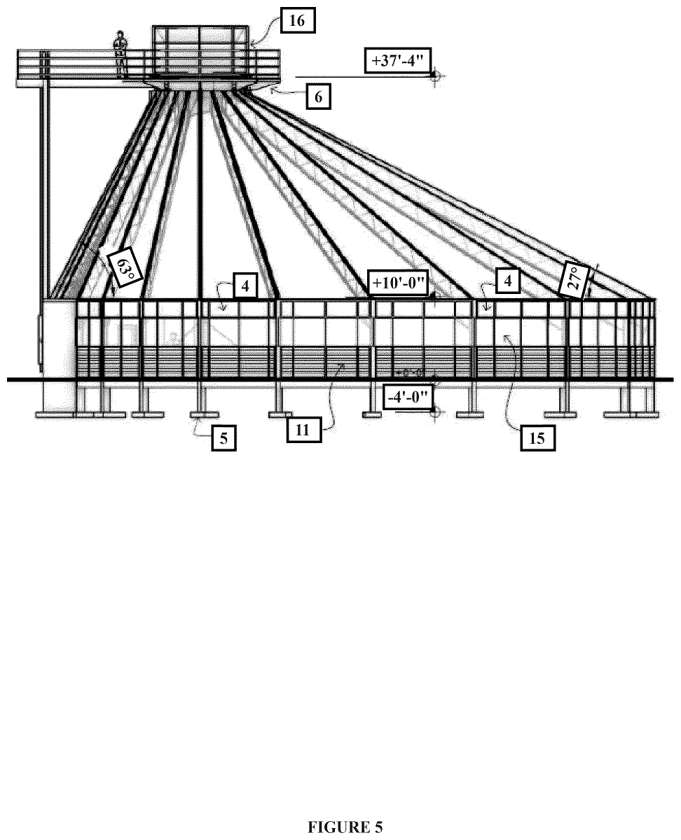

FIG. 5 illustrates a representative illustration of a schematic of an embodiment of the present invention providing another side view of the greenhouse to illustrate how the functional design of the present invention maintains maximum solar exposure with the least reflectivity from the roof panes of the chutes (1). It is a representation of slope of roof of the present invention's clamshell greenhouse with West elevation and Southern exposure showing 27-degree slope of the present invention.

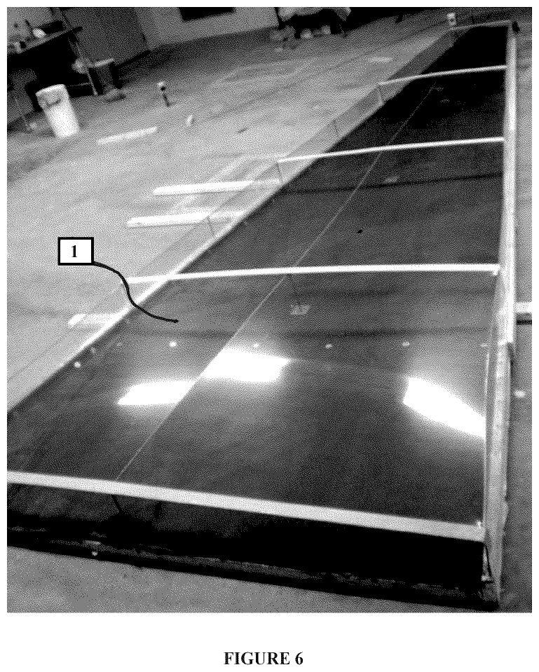

FIG. 6 illustrates a representative illustration of a photograph of an embodiment of the present invention providing a prototype of an experimental chute in the plurality of chutes (1). It is an illustrative photograph of chutes (1) used for solar heat test.

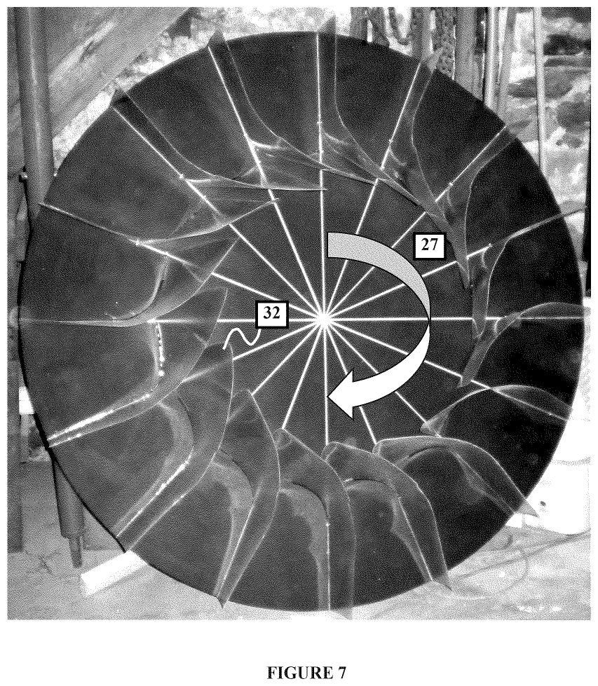

FIG. 7 illustrates a representative illustration of a photographical rendering of a top-down view of an actual set of 16 vanes, chute vanes (32) within and adjacent to the swirl channel (27) with a spin direction (clockwise) opposite to that of the spin direction (counter-clockwise) of the embodiment of the present invention. It is an illustrative photograph of top-down view of prototype vanes.

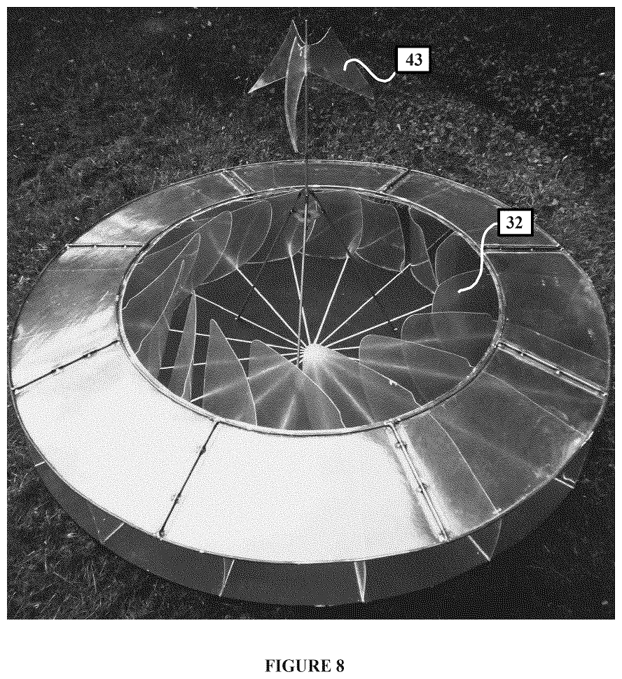

FIG. 8 illustrates a representative illustration of a photographical rendering of an enclosure that captured the air flow from the prototype chute with the chute vanes (32) and the blades of a turbine (43). It is an illustrative photograph of prototype shroud, vents, vanes, and a 4-blade turbine simulator.

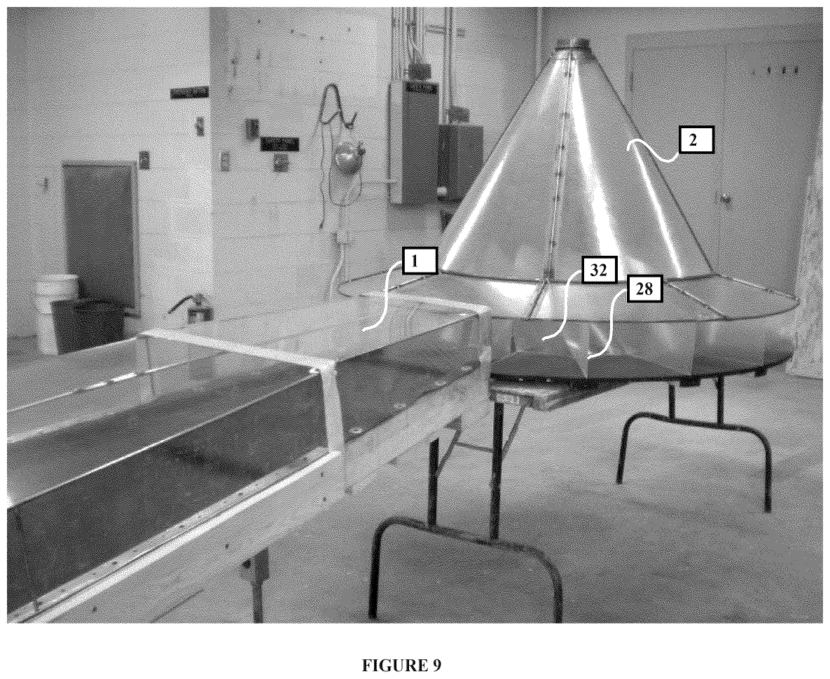

FIG. 9 illustrates a representative illustration of a photographical rendering of the completed assemblage of the one of the chutes (1), chute vanes (32), chute vents (28), and the swirl chamber (27) of the present invention along with the cone (2) at the top of the prototype of the greenhouse. It is an illustrative photograph of chute with connection to experimental vanes, swirl chamber and turbine blades.

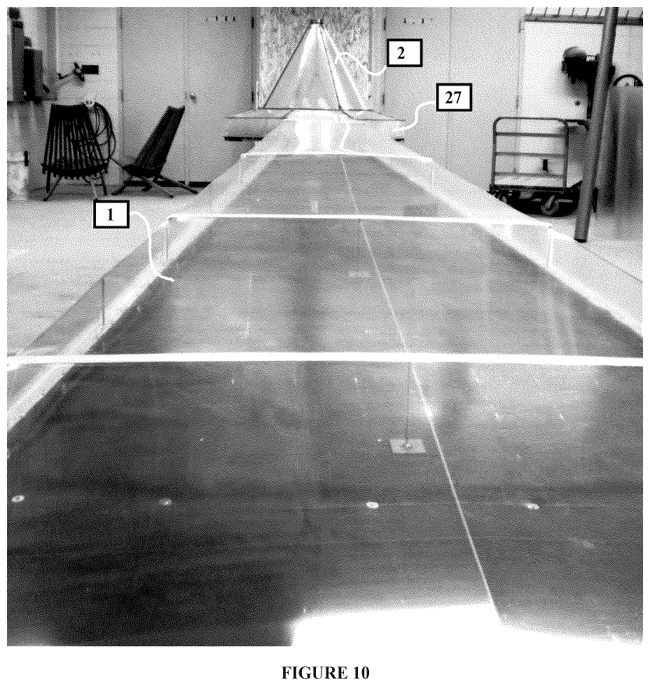

FIG. 10 illustrates a photographic rendering of an earlier design showing a photographic rendering of the full distance view of an individual chute representing the plurality of chutes (1) connected to an enclosure that contains the swirl chamber (27) and the inverted cone system (2) of the earlier prototypes unlike the current functional design of the right-side-up cone (2) as shown in FIGS. 2, 3 and 5 above, to capture the cycling air inside the swirl chamber (27). It is an illustrative photograph of end view of chute (1) connected to swirl chamber (27), blade assembly, and cone (2).

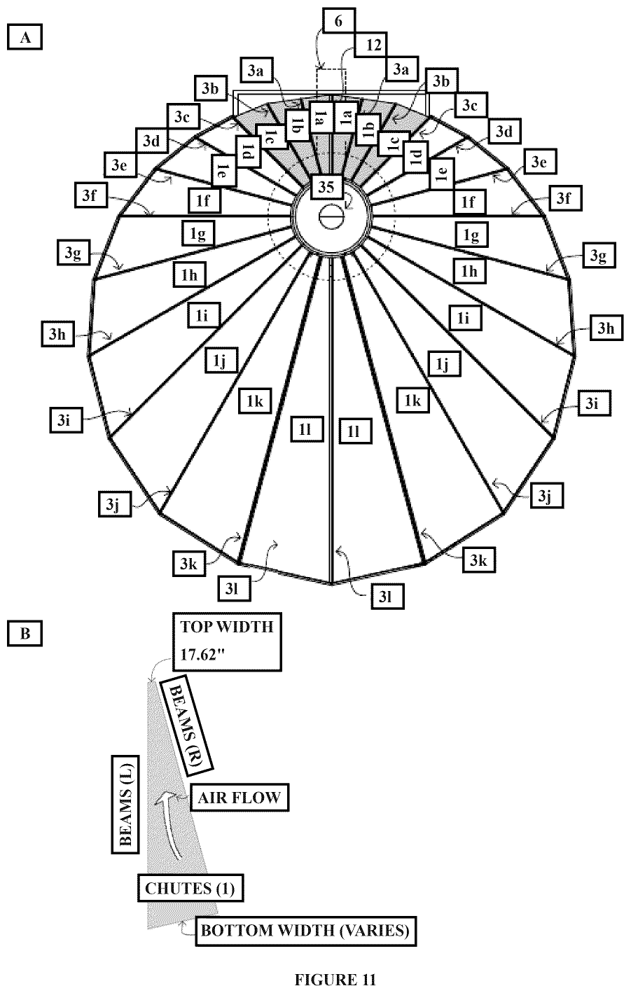

FIG. 11 illustrates a representative illustration of a schematic of an embodiment of the present invention providing how the beams (represented by the top rails or joists of the beams (3)) and chutes (1) are planned to be assembled in the present invention in an exemplified arrangement of the total group of beams (12 on each side, i.e., right and left, 3a to 3l for a total of 24 beams) and chutes (1a to 1l, 12 on each side of the central support pole (12) for a total of 24 chutes) with a top-down view. It is a representative diagram of 18 active (9 on each side, i.e., right and left, 3d to 3l and 1d to 11 for a total of 18 beams and 18 chutes) and 6 inactive (6 on each side, i.e., right and left, 3a to 3c and 1a to 1c for a total of 6 beams and 6 chutes) beams and chutes forming the top of the greenhouse of the present invention.

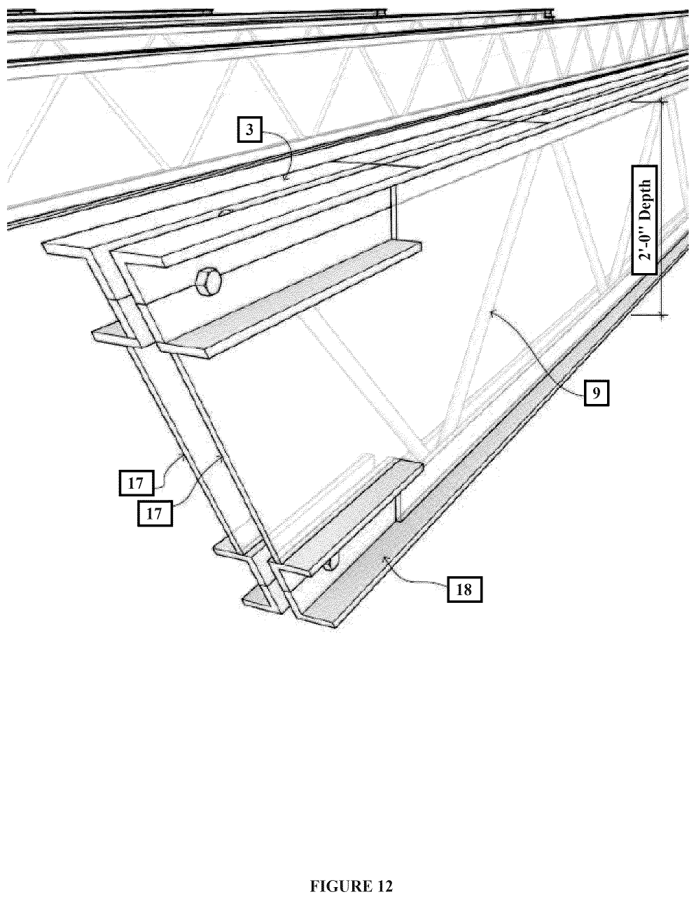

FIG. 12 illustrates a representative illustration of a schematic of an embodiment of the present invention providing details of the beams of the present invention, showing a webbing made of metal in the center of the beams (9) for Lexan sheathing supports the top rails or joists of the beams (3) and the bottom rails or joists of the beams (18) and sheets of Lexan plastic panels (17) that seal the central webbing area encasing both sides of the webbing inside the beams. It is a representation close up of elements of beam and chute structure of the present invention.

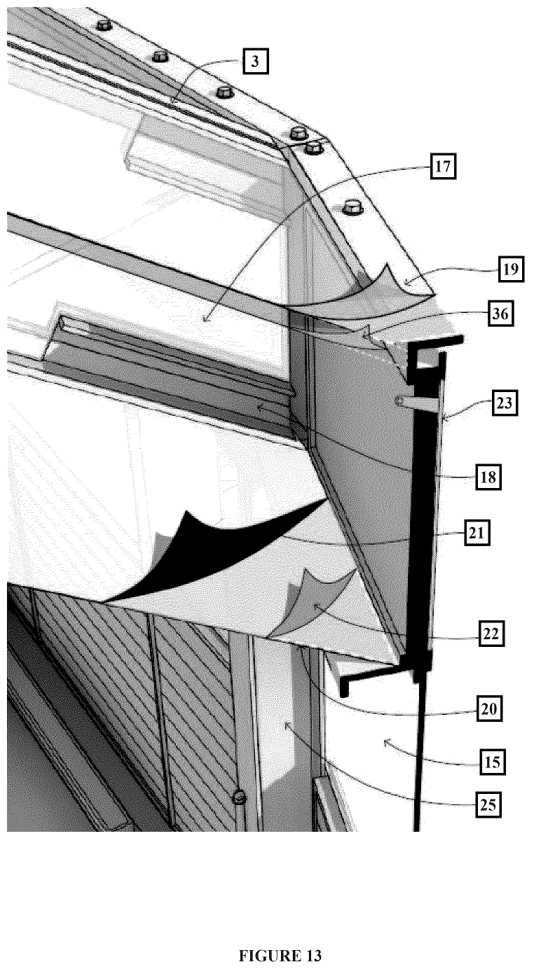

FIG. 13 illustrates a representative illustration of a schematic of an embodiment of the present invention providing a view of the bottom of the chutes (1) showing its air control devices and its solar exposure control devices. It is representation of structure and coatings on chutes with damper door on chute bottom of the present invention.

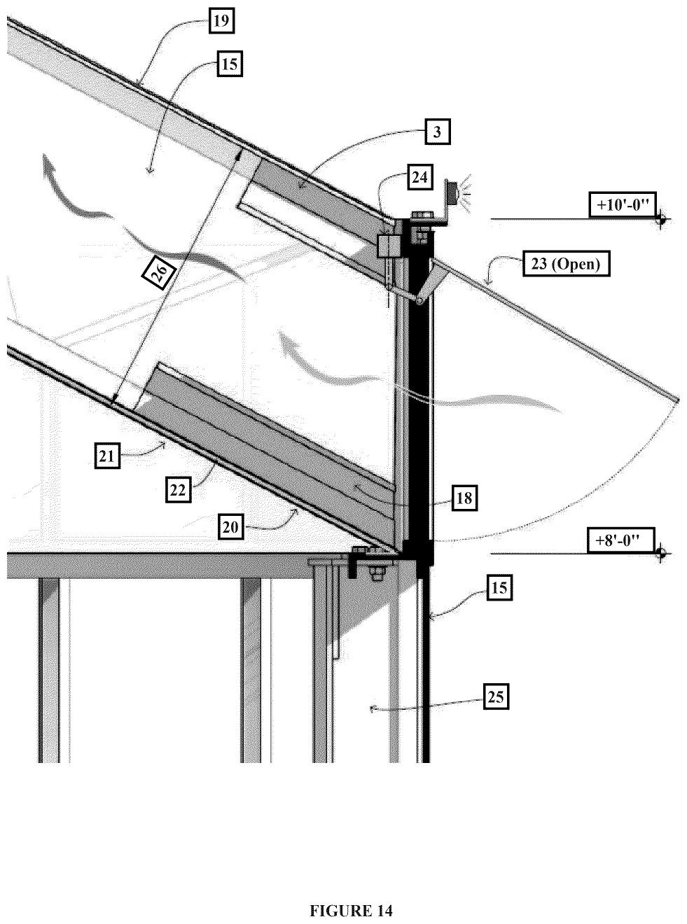

FIG. 14 illustrates a representative illustration of a schematic of an embodiment of the present invention providing the same view of the bottom of one of the chutes (1) as in FIG. 13 but additionally showing the operable damper door (23), controlled by one of the actuators (24) which has a photocell on its top. It is a representation of elements of chute construction at bottom of chute with solar actuator for bottom damper of the present invention.

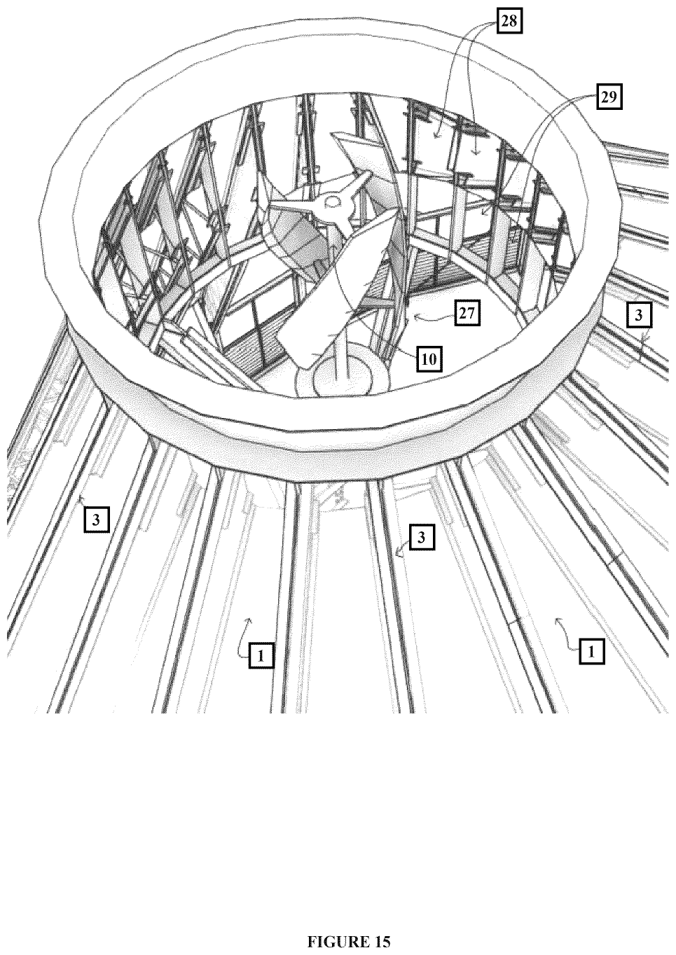

FIG. 15 illustrates a representative illustration of a schematic of an embodiment of the present invention providing a cutaway view of the chute vents (28) for hot air coming out of the chutes (1) carried by the beams attached to the chutes (1) by the top rails or joists of the beams (3) holding the chutes (1) in place and below them are the lower vents referred to as interior greenhouse vents (29) that flow from the interior of the greenhouse (55) into the swirl chamber (27) nestling the electric wind turbine (10) in its center to receive the air pressure as vortex driving the blades of the turbine (43). It is an open view of turbine receiving air through vents from chutes and greenhouse interior of the present invention.

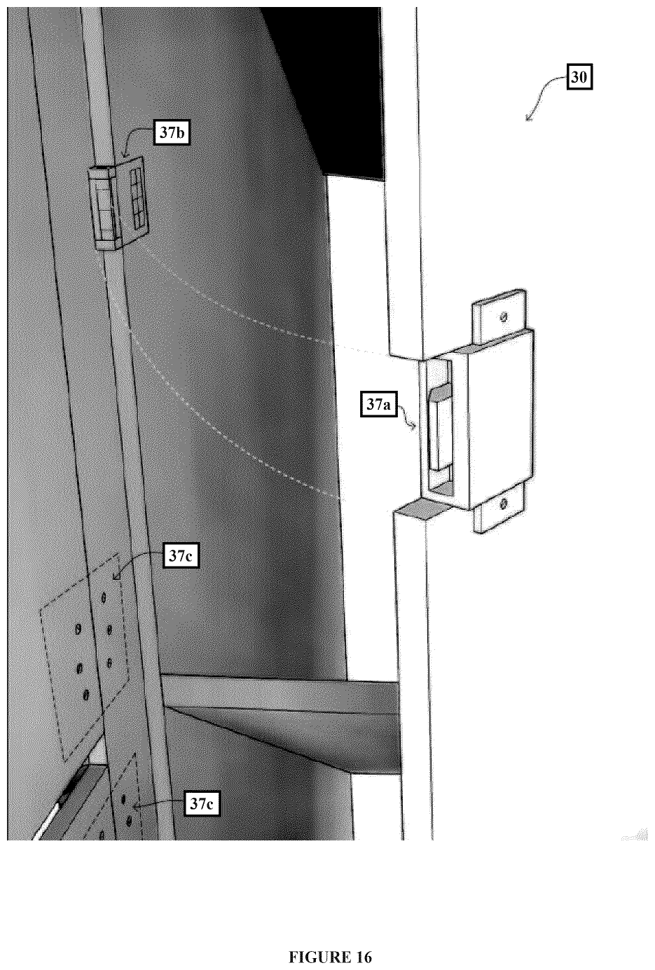

FIG. 16 illustrates a representative illustration of a schematic of an embodiment of the present invention providing the mechanisms that control the flow of hot air from the chutes (1) and the interior of the greenhouse (55) using a plurality of dampers, including the chute dampers (30) and the interior greenhouse dampers (31) and a spring and latch system (37) comprising a snap latch (37a), an electric striker plate (37b), and a spring-loaded adjustable hinge (37c). It is a representation of elements of latch, electric strike and adjustable hinges for dampers on vanes of the present invention.

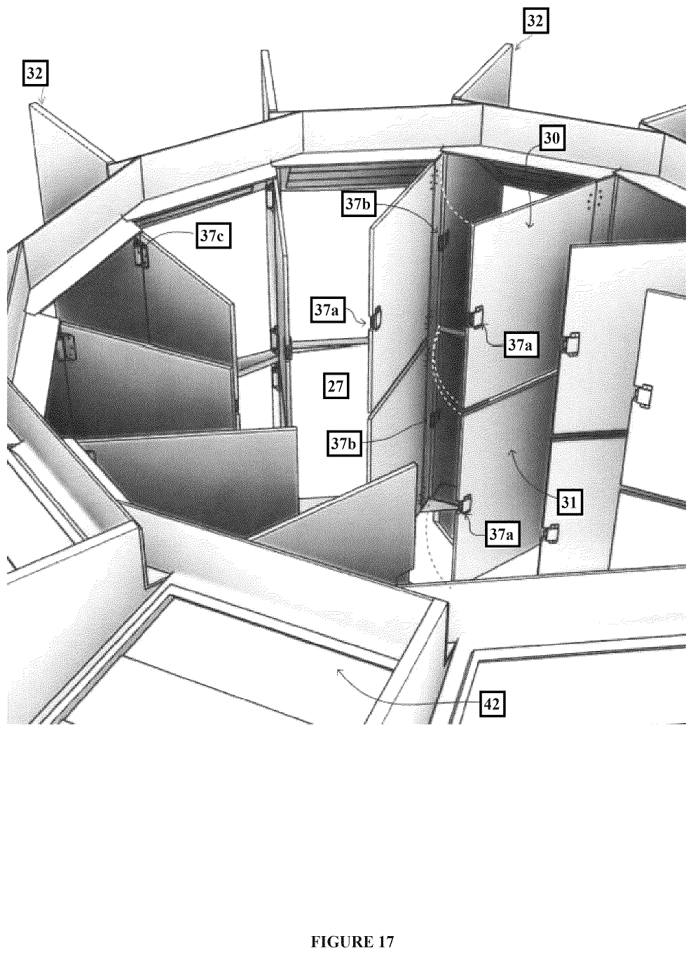

FIG. 17 illustrates a representative illustration of a schematic of an embodiment of the present invention providing examples of chute vanes (32) (not showing interior greenhouse vanes (33)), and chute dampers (30) and interior greenhouse dampers (31) that supply the air to the swirl chamber (27) of the present invention. It is a representation of all damper doors shown in open configuration into swirl chamber of the present invention.

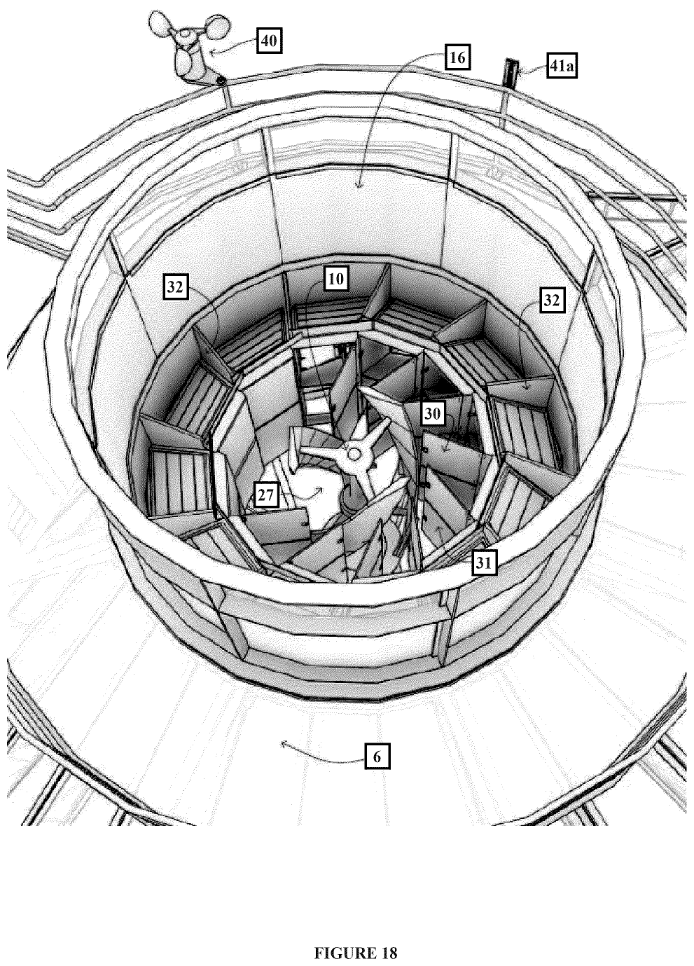

FIG. 18 illustrates a representative illustration of a schematic of an embodiment of the present invention providing shows the whole arrangement of the vanes from the chutes or the chute vanes (32) facing in a counterclockwise direction for the greenhouse structure situated in the Northern Hemisphere. It is a representative view of chute and interior vanes delivering hot air through dampers to swirl chamber of the present invention.

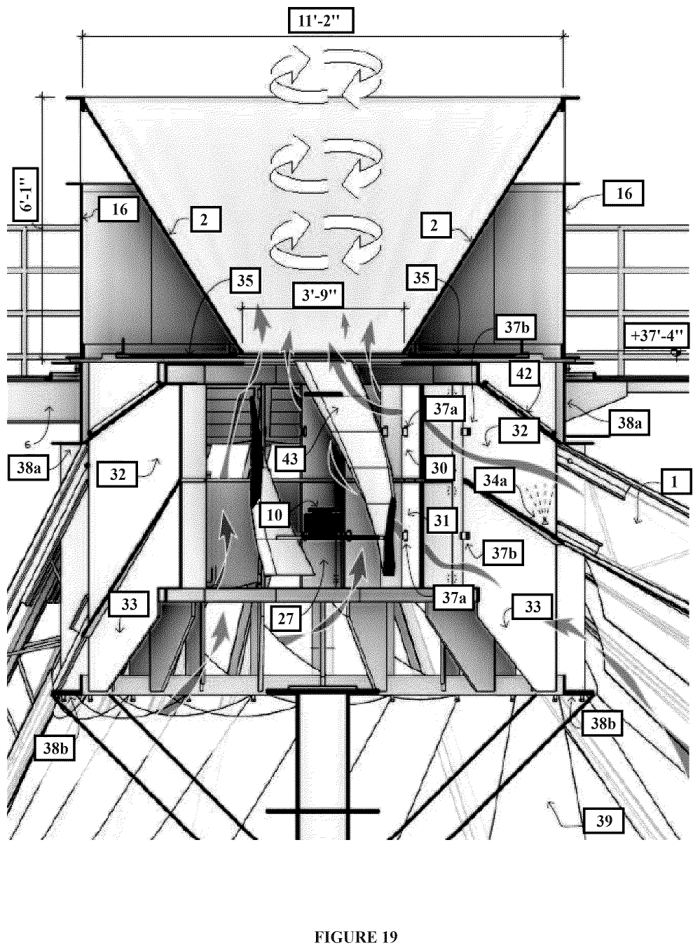

FIG. 19 illustrates a representative illustration of a schematic of an embodiment of the present invention providing a large sectional view (East-looking) of all of the elements that move the air flow to the turbine (10) and then up through the central orifice, control vent to the bottom of the cone (2) and then vertically out of the greenhouse. It is a sectional view of chute and greenhouse interior vents delivering hot, moistened air to feed turbine of the present invention.

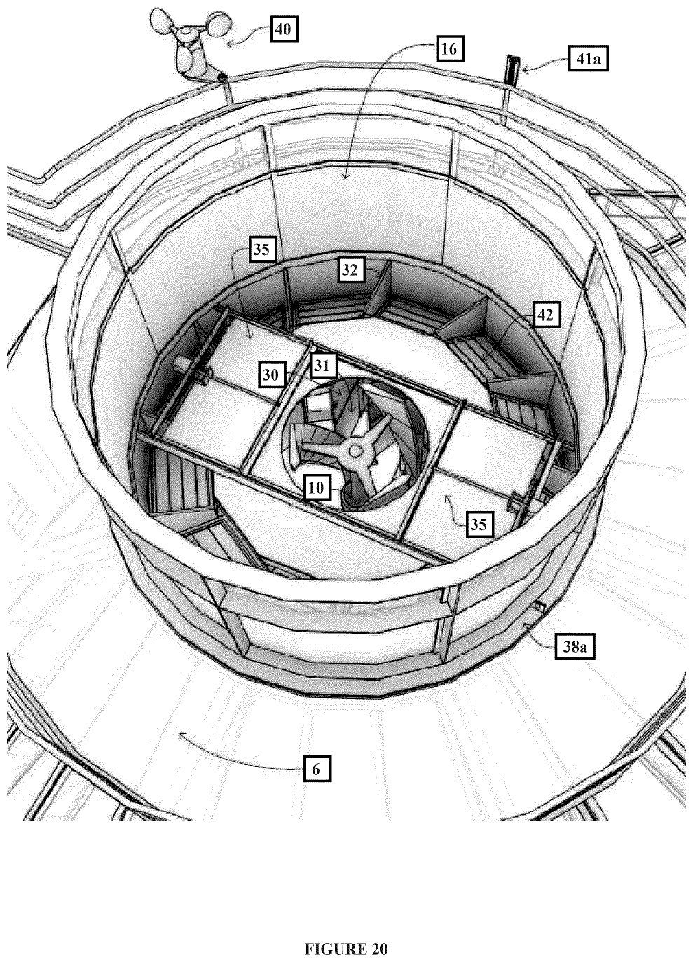

FIG. 20 illustrates a representative illustration of a schematic of an embodiment of the present invention providing a view from above of the orifice closure device (35) that is shown with representations of aluminum metal sheets that are attached to the bottom of the closure device. It is a representation of detail of remote-controlled orifice doors (35), when still open, also shown are chute vanes (32), and emergency pressure relief vents (42) of the present invention.

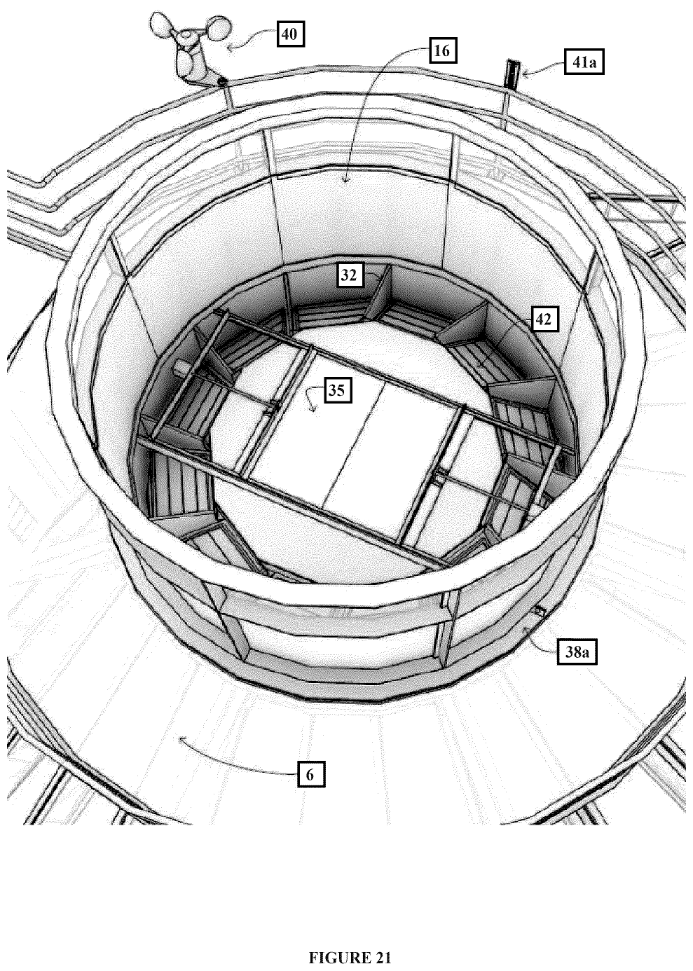

FIG. 21 illustrates a representative illustration of a schematic of an embodiment of the present invention providing another view from above of the orifice closure device (35) which is fully closed. It is a representation of details of remote-controlled orifice doors (35) when closed of the present invention.

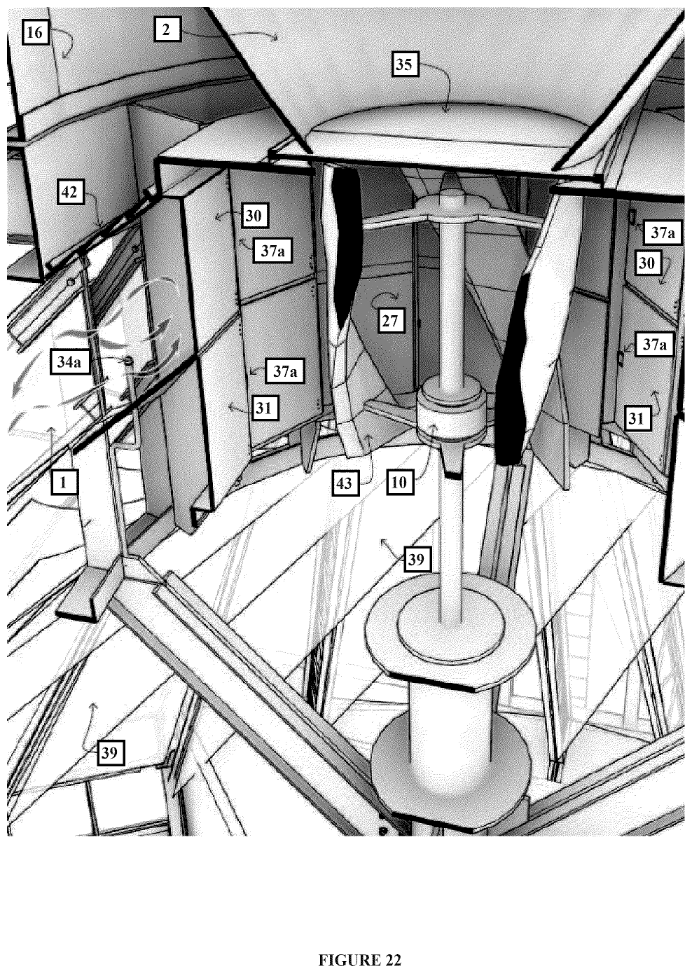

FIG. 22 illustrates a representative illustration of a schematic of an embodiment of the present invention providing further details of the process when the thermostat (41) closes the various ventilation dampers as the air inside the greenhouse becomes cool. It is a representation of complete interior view of turbine (10) and swirl chamber (27) dampened for night operation of the present invention.

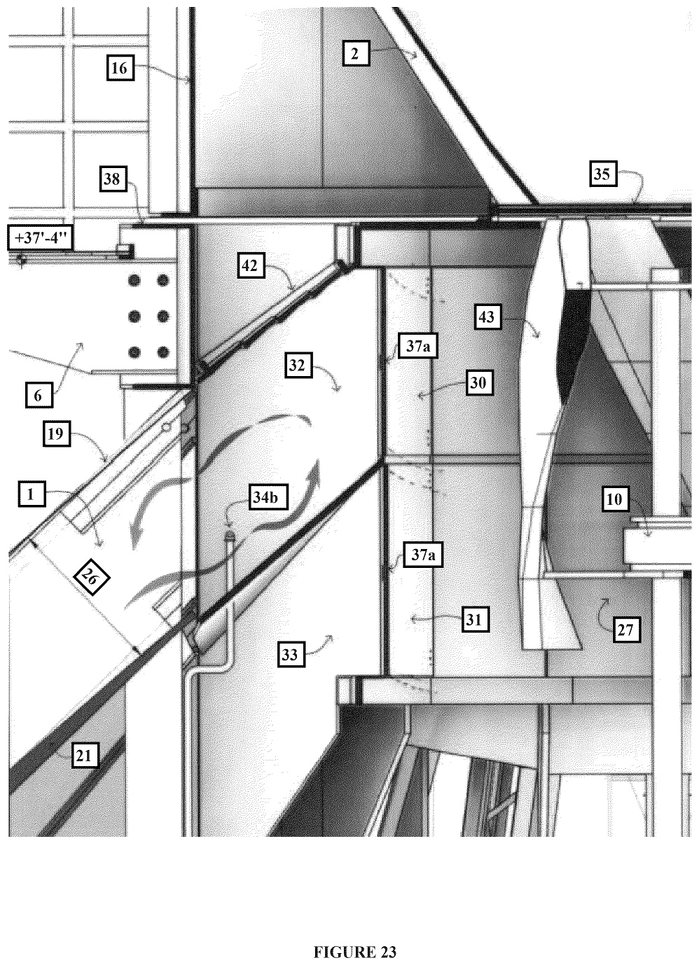

FIG. 23 illustrates a representative illustration of a schematic of an embodiment of the present invention providing another view from the side of the swirl chamber (27) and one of the chutes (1) leading up to it in the mode for nighttime shutdown of air movement in the greenhouse. It is a representation of focused view that show how closed inlets from a chute and the interior seal off the greenhouse of the present invention.

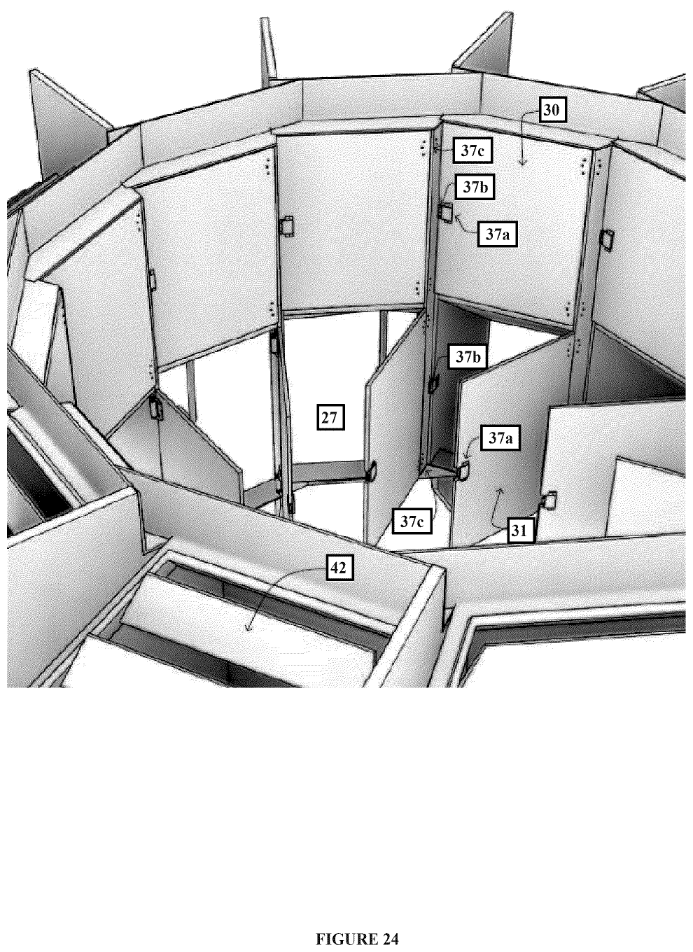

FIG. 24 illustrates a representative illustration of a schematic of an embodiment of the present invention providing monitoring systems to protect the turbine (10) and electrical equipment (13). It is a representation of a detailed view of closed chute vane dampers next to open interior vane dampers of the present invention.

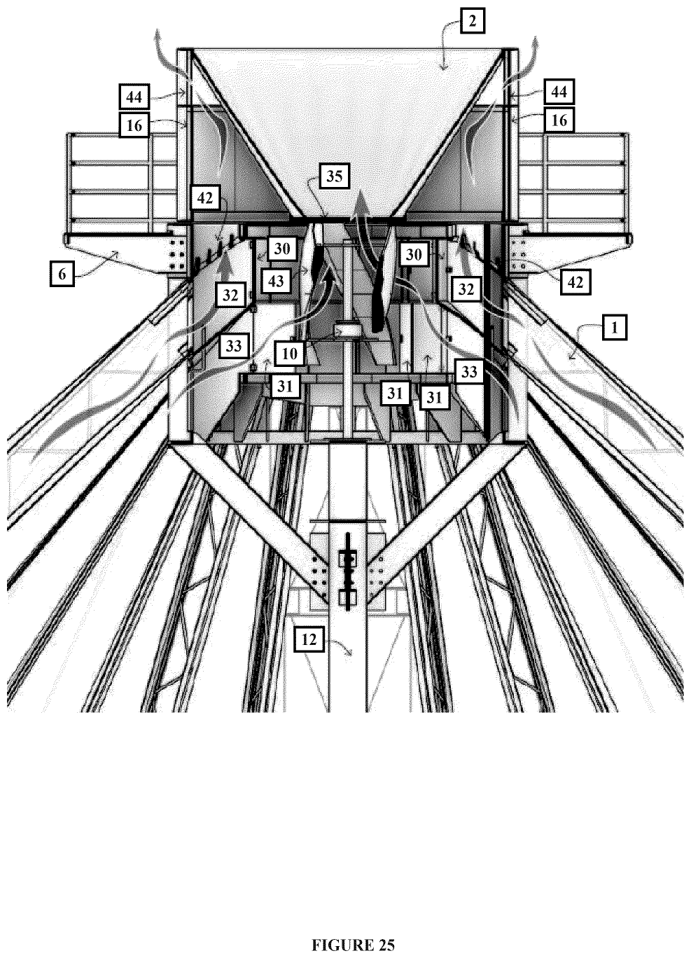

FIG. 25 illustrates a representative illustration of a schematic of an embodiment of the present invention providing a sectional view of the air flow during the emergency pressure relief event. It is a representation of sectional view of emergency pressure relief vents (42) and other such elements functioning showing air movement of the present invention.

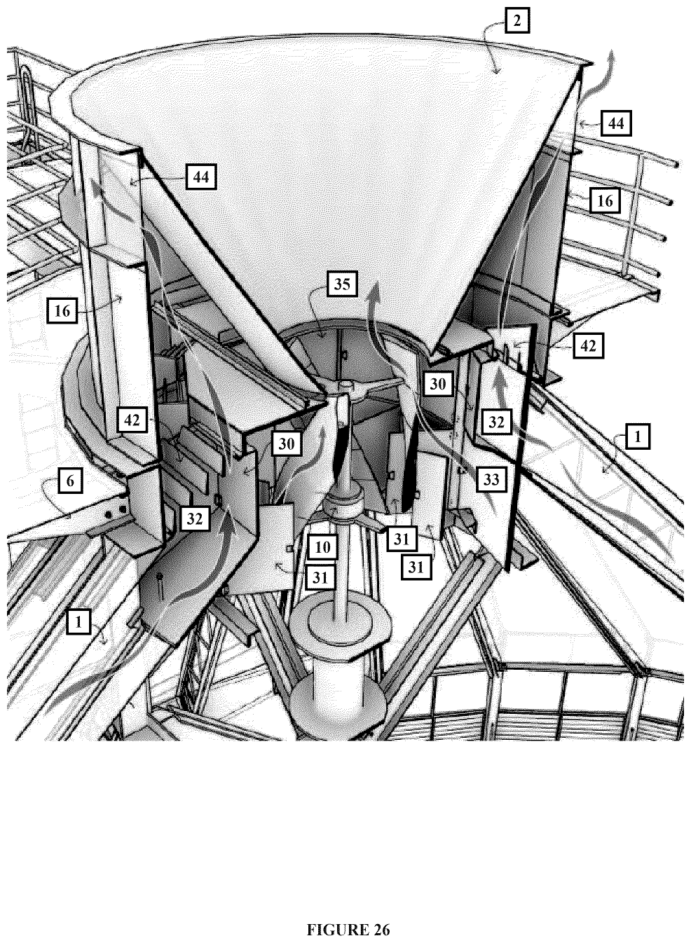

FIG. 26 illustrates a representative illustration of a schematic of an embodiment of the present invention providing a three-dimensional view showing another angle of what occurs when of the emergency evacuation system is activated. It is a representation of three-quarter view of emergency pressure relief vents (42) and other such elements functioning of the present invention.

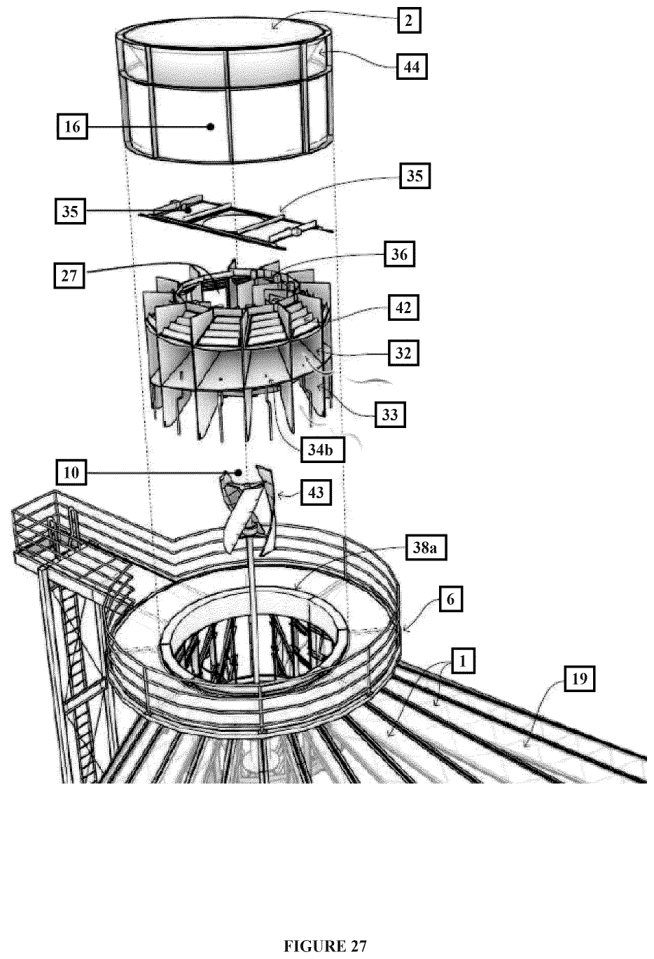

FIG. 27 illustrates a representative illustration of a schematic of an embodiment of the present invention providing a side view of the entire electric power production system and its control elements. It is a representation of direct exploded view of all of the components of the solar vortex power production system of the present invention.

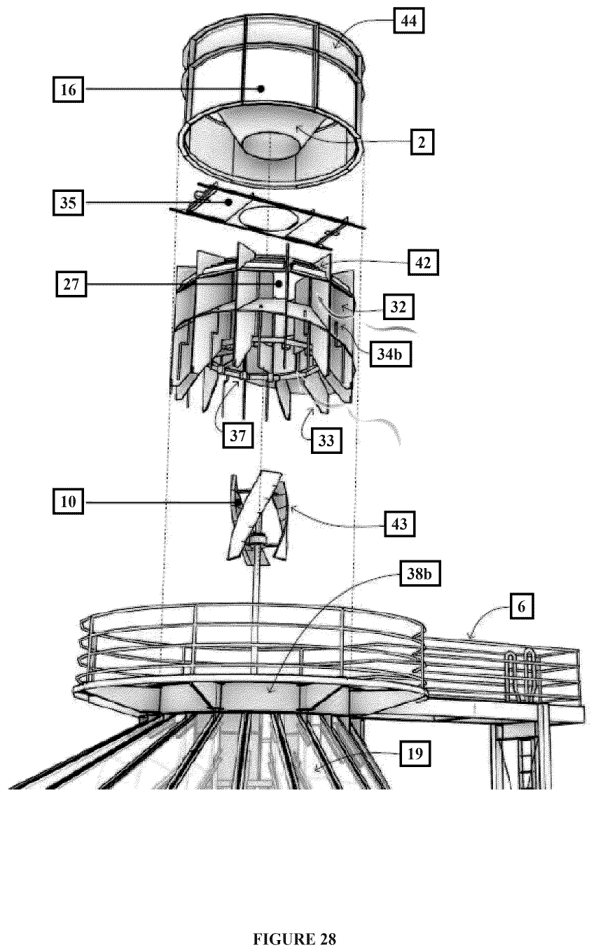

FIG. 28 illustrates a representative illustration of a schematic of an embodiment of the present invention providing a below view of the entire electric power production system and its control elements. It is a representation of bottom-up exploded view of all of the components of the solar vortex power production system of the present invention.

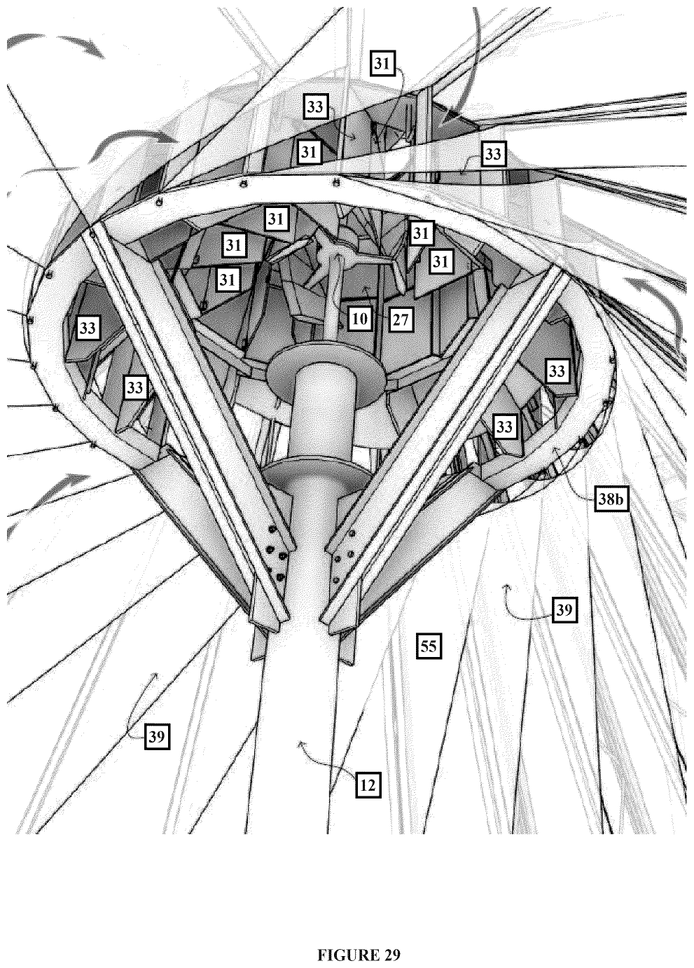

FIG. 29 illustrates a representative illustration of a schematic of an embodiment of the present invention providing the detail of how the interior warm air supply is controlled in the undercarriage of the interior greenhouse vanes (33) and swirl power system to complement the heat sources from the chutes (1) and increase electricity generation. It is a representation of underside view of sails bringing hot air up to lower vanes then into swirl chamber of the present invention.

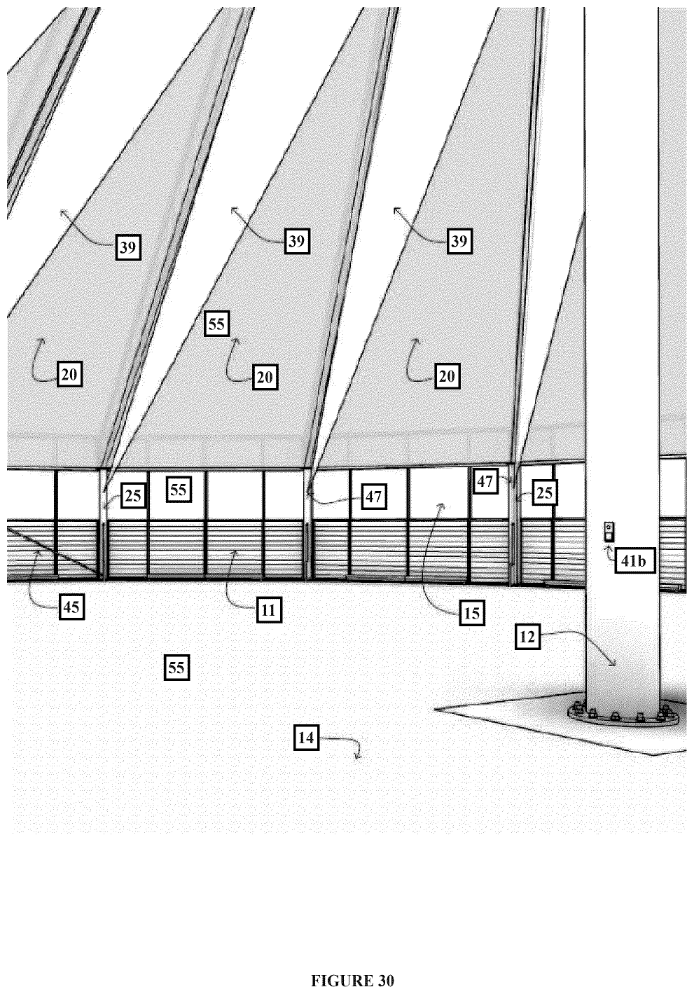

FIG. 30 illustrates a representative illustration of a schematic of an embodiment of the present invention providing the interior of the greenhouse (55) moving down into the inside of the greenhouse as viewed from the central support pole (12) to see the plurality of sails (39) that are stretched to attach to the plurality of columns (25) that support each of the corners of the greenhouse. It is a representation of interior view of pole and sails attached to sides of greenhouse under chutes of the present invention.

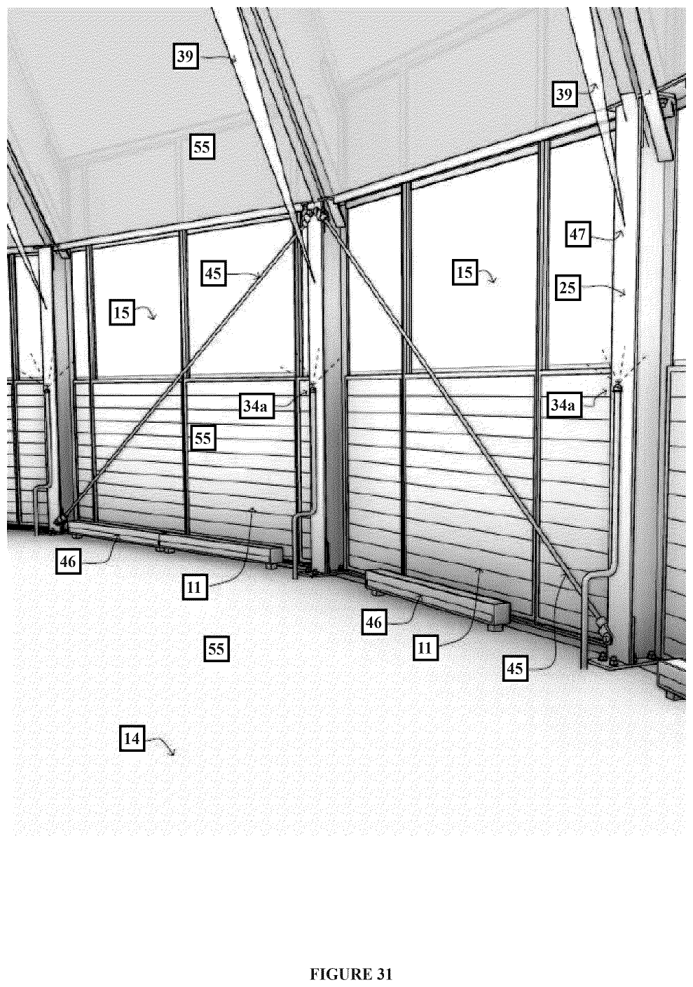

FIG. 31 illustrates a representative illustration of a schematic of an embodiment of the present invention providing the details of the interior heating, cooling and misting systems of the greenhouse. It is a representation of close-up view of ventilating shutters, radiators, sail attachments and misters of the present invention.

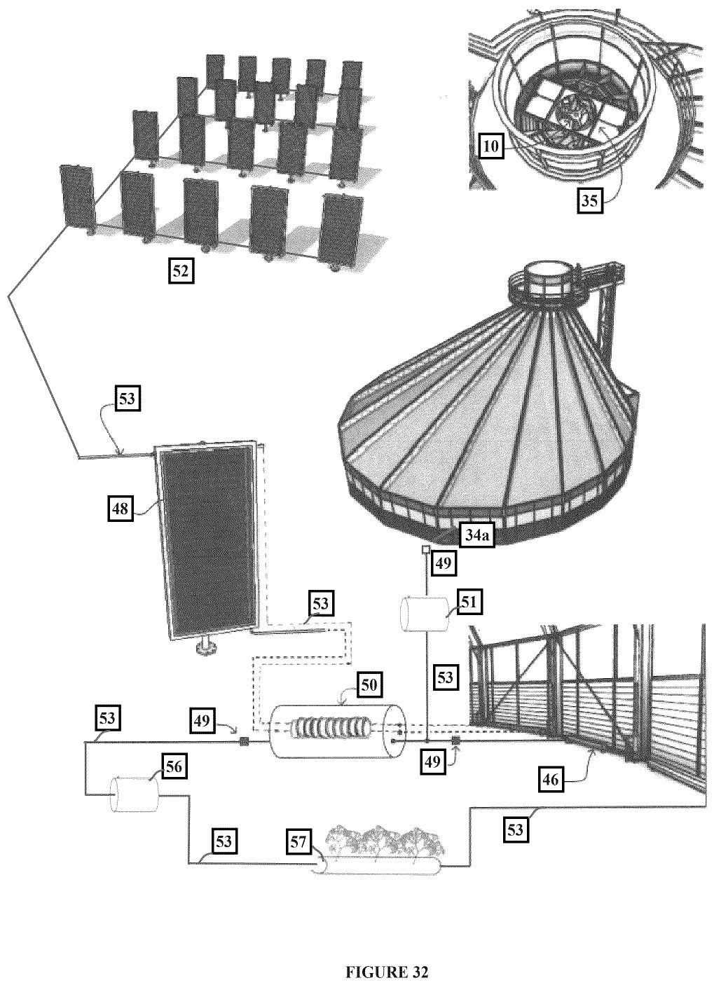

FIG. 32 illustrates a representative illustration of a schematic of an embodiment of the present invention providing a schematic of the solar generated hot water and antifreeze system. It is a representation of schematic view of antifreeze and water heating and delivery of the present invention.

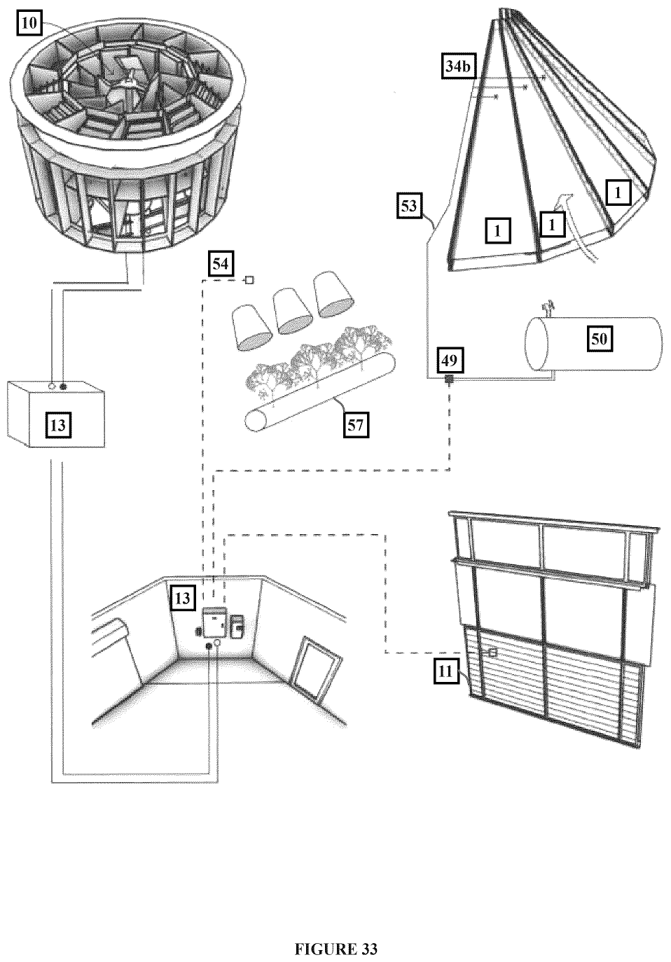

FIG. 33 illustrates a representative illustration of a schematic of an embodiment of the present invention providing a schematic showing that the electrical system of the present invention which is supplied exclusively from the turbine (10) that is located at the top of the clamshell greenhouse as disclosed herein. It is a representation of schematic of the electrical system inside the solar vortex clamshell greenhouse of the present invention.

### DETAILED DESCRIPTION OF THE INVENTION

Detailed embodiments of the present invention are disclosed herein. However, it is to be understood that the disclosed embodiments are merely exemplary of the present invention, which may be embodied in various systems. Therefore, specific details disclosed herein are not to be interpreted as limiting, but rather as a basis for teaching one skilled in the art to variously practice the present invention.

All illustrations of the drawings are to describe selected versions of the present invention and are not intended to limit the scope of the present invention.

Unless defined otherwise, all technical and scientific terms and any acronyms used herein have the same meanings as commonly understood by one of ordinary skill in the art in the field of the invention. Although any methods and materials similar or equivalent to those described herein can be used in the practice of the present invention, the exemplary methods, devices, and materials are described herein.

Although any methods and materials similar or equivalent to those described herein can be used in the practice of the present invention, the exemplary methods, devices, and materials are described herein. For the present disclosure, the following terms are defined below. Additional definitions are set forth throughout this disclosure.

As used herein, the terms “comprises,” “comprising,” “includes,” “including,” “has,” “having,” “contains”, “containing,” “characterized by,” or any other variation thereof, are intended to encompass a non-exclusive inclusion, subject to any limitation explicitly indicated otherwise, of the recited components. For example, a microbe, a microbial formulation, a pharmaceutical composition, and/or a method that “comprises” a list of elements (e.g., components, features, or steps) is not necessarily limited to only those elements (or components or steps), but may include other elements (or components or steps) not expressly listed or inherent to the microbe, microbial formulation, pharmaceutical composition and/or method. Reference throughout this specification to “one embodiment,” “an embodiment,” “a particular embodiment,” “a related embodiment,” “a certain embodiment,” “an additional embodiment,” or “a further embodiment” or combinations thereof means that a particular feature, structure or characteristic described in connection with the embodiment is included in at least one embodiment of the present invention. Thus, the appearances of the foregoing phrases in various places throughout this specification are not necessarily all referring to the same embodiment. Furthermore, the particular features, structures, or characteristics may be combined in any suitable manner in one or more embodiments.

As used herein, the transitional phrases “consists of” and “consisting of” exclude any element, step, or component not specified. For example, “consists of” or “consisting of” used in a claim would limit the claim to the components, materials or steps specifically recited in the claim except for impurities ordinarily associated therewith (i.e., impurities within a given component). When the phrase “consists of” or “consisting of” appears in a clause of the body of a claim, rather than immediately following the preamble, the phrase “consists of” or “consisting of” limits only the elements (or components or steps) set forth in that clause; other elements (or components) are not excluded from the claim as a whole.

When introducing elements of the present invention or the preferred embodiment(s) thereof, the articles “a”, “an”, “the”, and “said” are intended to mean that there is one or more of the elements. The terms “comprising”, “including”, and “having” are intended to be inclusive and mean that there may be additional elements other than the listed elements.

As used herein, the term “and/or” when used in a list of two or more items, means that any one of the listed items can be employed by itself or in combination with any one or more of the listed items. For example, the expression “A and/or B” is intended to mean either or both of A and B, i.e., A alone, B alone or A and B in combination. The expression “A, B and/or C” is intended to mean A alone, B alone, C alone, A and B in combination, A and C in combination, B and C in combination or A, B, and C in combination.

As used herein, the term “about” refers to a rough estimate of the number or amount of the quantity referred to and is in the vicinity of the actual number or figure immediately following said term, where the actual number or figure or amount could be slightly higher or lower.

As used herein, the term “chutes (1),” “plurality of chutes (1)” and “roof of the greenhouse” used interchangeably refers to an individual and a plurality of triangular chute assemblies arranged in a clamshell shape around a central support pole, and each chute is generally double paned, but may be triple paned with an optional intermediate layer, and each chute includes: top and bottom transparent UV-protected sheets when double-paned, intermediate black shade cloth for selective absorption of solar radiation, where frame supports may be made of aluminum, composite, or natural fiber materials, and with tilt angle adjustment so that each chute is substantially perpendicular to incoming solar rays at the greenhouse site's latitude. Furthermore, panes of the roof, and panes of the chutes, have been used interchangeably.

As used herein, the term “interior of the greenhouse (55)” refers to the entirety of inside of the greenhouse below the roof of the greenhouse formed by the plurality of chutes (1) to the base of the greenhouse formed by the gravel base (14) floor of the greenhouse and surrounded by the sides of the greenhouse formed by Lexan panels referred to as Lexan windows (15) on top sides (for allowing natural light to enter along all the sides of the greenhouse into the interior of the greenhouse (55) for the growth of the plants) and part of a plurality of shutters that form an air-cooling system, i.e., electric ventilation shutters (11) on bottom sides, and the interior of the greenhouse (55) is climate-controlled for growth of the plants.

As alluded to above, numerous attempts have been made to utilize solar updraft and artificially induced vortex-based systems for energy generation by harvesting the energy from the Sun. For example, KR100938538B1 describes a solar vortex chimney power plant employing vertical chimneys to drive turbines using solar-heated air guided into chimneys or cylindrical walls to form a vortex for turbine power generation. Similarly, U.S. Pat. No. 6,772,593B2 emphasizes cylindrical or conical towers with tangential airflow, and U.S. Pat. No. 7,086,823B2 suggests methods of stabilizing a vortex with guide vanes, and together they disclose variations of solar vortex or atmospheric vortex engines, wherein hot air rising through a chimney or cylindrical wall drives turbines to produce mechanical or electrical power. These inventions demonstrate feasibility but generally require large, costly vertical chimneys or towers, limiting scalability and practical deployment. Other existing prior art also teaches artificial vortex generation using tangential air admission at the base of a circular wall. These prior systems demonstrate the feasibility of vortex-driven energy conversion but suffer from efficiency limitations, structural complexity, reliance on tall chimneys, and instability caused by environmental conditions.

Prior art has also investigated tethered dust-devil style vortices using angled vanes within an enclosure, demonstrating controlled vortex formation but without a greenhouse or integrated farming application. Other research has disclosed the use of sloped triangular collectors to focus solar heating into a chimney. While successful in producing updraft, drag losses and construction complexity remained.

Accordingly, there remains a need for a solar energy system that (i) eliminates the inefficiencies associated with narrow chimney exhausts, (ii) integrates a greenhouse micro-climate for dual-use of energy and agriculture, (iii) incorporates hot water misting and antifreeze-based heat exchange for extended operation, and (iv) utilizes a uniquely configured clamshell design to maximize solar capture and airflow management. Also, there is an unmet need in the art for a low-cost, modular, dual-use vortex system that eliminates tall towers and costly concrete bases; uses lightweight prefabricated structures; provides agricultural benefits, i.e., plant cultivation, climate control, etc.; incorporates thermal storage and misting augmentation for continuous operation; and is scalable from community farms to commercial power stations.

The present inventors began by exploring conical or clamshell-shaped structures with deflectors to induce vortex formation to address the need in the art; however, in their initial conceptions, these systems still depended upon stack or chimney effects and lacked integration with greenhouse functions, advanced misting technologies, or optimized solar collection geometries. They have also theorized vortex engines using vanes and supplemental heating, but these designs remained primarily conceptual and lacked agricultural integration. The inventors also envisioned coupling vortex farms with hemp cultivation for tribal economies; however, it relied on expansive concrete collector bases and conventional turbine integration, making small-scale or modular deployment impractical.

The present invention addresses the need in the art by developing from the aforesaid initial conceptualizations, the present invention combines various aspects of these conceptualizations into a functional, comprehensive solar vortex clamshell greenhouse with a right-side-up funnel exhaust, multiple ultraviolet-protected chute assemblies, heavy-duty transparent sails, and integrated misting/heat-exchange systems to enhance vortex stability, power generation, and agricultural sustainability as disclosed herein below. The present invention further uniquely addresses the need by providing modular greenhouse integration, lightweight chute assemblies, dual-use farming integration with simplified clamshell assembly methods, and antifreeze-assisted misting for extended operation. It provides an advantageous solution to the need in the art by inducing and sustaining an artificially induced generation of a vortex similar to those occurring in nature, powered by heated air produced by harvesting the energy from the Sun, and combining the vortex-based energy and farming solution that avoids dependence on tall chimneys or concrete towers; employs modular, lightweight chute assemblies adaptable to different latitudes; integrates controlled misting systems using antifreeze-buffered heat exchangers; provides dual functionality as a greenhouse farm for food, hemp, or specialty crops; and supplements the more robust vortex from the chutes with a slower vortex from the interior of the greenhouse, providing a long-term stability using sail-guided corkscrew airflow in the inside or interior of the greenhouse and wide funnel on top of the greenhouse for vortex exhaust. The present invention thus fulfils these needs by merging renewable power generation by efficiently and economically harvesting a freely available and natural power of the Sun, with sustainable agriculture, particularly hydroponic plant cultivation in a scalable, low-cost clamshell greenhouse design.

The present invention provides a clamshell structure greenhouse with chute assemblies, which are transparent panels with black open-weave shade cloth as heat absorbers. The greenhouse chute assembly is configured at varying slopes to track solar incidence from morning to evening, matching the site latitude where the greenhouse is constructed. The clamshell dome is formed as a result of a plurality of chutes (1) interlocking to form a circular or semi-circular clamshell, maximizing solar gain throughout the day. The greenhouse has a central chamber surrounded by the clamshell-shaped roof made of a plurality of chutes (1) introduced above, and heated air rises into the central chamber, which is part of the interior of the greenhouse (55) fitted with a plurality of spiral transparent sails (39), imparting rotation and upwards motion to the heated and moistened air from the interior of the greenhouse to supplement the more rigorous vortex during the daytime fueled by the Sun's heat in the chutes (1). In the present invention, heated and moist air is funneled into a rotational updraft leading to an artificial vortex formation that rotates blades of a turbine (43) to generate electricity from an electric wind turbine (10), which exhausts through a right-side-up funnel geometry cone, which is wide at the top from where the vortex exhausts, and narrow at the bottom, where the vortex enters from the swirl chamber (27) hosting the turbine (10) within it, and such a functional design minimizes drag compared to the chimneys used for exhaust in the prior art. The turbine (10) in the swirl chamber (27) at the throat of the funnel for vortex exhaust is used to extract energy from the vortex and generate electricity, including the electricity used to run the greenhouse and for use in the disclosed system's energy needs. The combined energy generation and sustainable plant growth greenhouse system of the present invention comprises a misting system that has an antifreeze-buffered storage tank, which is referred to as a storage tank for antifreeze solution (50) that retains excess solar heat collected by a plurality of solar heat collectors (48), and the said storage tank (50) comprises a heat exchanger which is a coil (that warms water for mist injection) running around a smaller tank with the heated antifreeze solution, for exchange of heat from the heated antifreeze solution with clean, non-salty fresh water piped into the storage tank for antifreeze solution (50) from a storage tank for clean, non-salty fresh water (51) to supply heated and moist water that is misted into heated water vapor and piped into the chutes (1) of the greenhouse via chute misters (34b) located near the top end of the chutes (1) in the clamshell shaped roof of the greenhouse. The misting nozzles in the chute misters (34b) are located in the upper chute assemblies and entrain heated water vapor into the airflow of the solar-powered heated air inside these chutes (1), increasing buoyancy and sustaining the vortex at night or in cloudy conditions, while misters (34a) in the interior of the greenhouse (55) double as misters for plant irrigation. The present invention structurally and functionally integrates the power generation with the greenhouse function using the transparent chute surfaces that admit light for plant growth, circulating convection regulates temperature and humidity, both of which are monitored and regulated by a plurality of thermostats (41) and a humidistat, which is part of the thermostat (41) module on a central support pole (12) in the interior of the greenhouse (55). The present invention also provides a greenhouse assembly kit for modular construction and scalability with prefabricated chute assemblies that allow transportable, phased construction, and it has been prototyped for testing as being scalable from 1/10th of an acre test models to 30+ acre vortex farms in the future. It thus provides low-tech, off-the-shelf components that reduce costs compared to photovoltaics or tall wind turbines. Additionally, the system as disclosed in the present invention has tremendous additional positive environmental impact potential, where the rising vortices may stimulate cloud formation at altitude, potentially recycling rainfall onto the farm with a micro-climate formation and maintenance.

In some embodiments of the present invention, it comprises a solar vortex clamshell greenhouse, assembled from a plurality of triangular chute modules constructed from transparent UV-resistant plastic (top and bottom layers), a black open-weave shade cloth for selective heat absorption, lightweight frames, which have an orientation optimized to solar angles at the installation latitude, where an inclined orientation selected to be substantially perpendicular to the Sun's path at the installation latitude, thereby maximizing solar penetration and minimizing reflectivity. In this embodiment of the present invention, a minimum of eighteen chute assemblies form a circular or near-circular, clamshell shaped enclosure around a central support column, defining both the greenhouse enclosure and solar collector field. The eighteen chutes are fitted together to form a substantially circular path spanning approximately 270 degrees around a central support pole, and collectively, these chutes serve both as the greenhouse roof and as solar air-heating elements.

The present invention has a structural and functional integration that achieves various advantageous functionalities: (i) vortex formation and exhaust funnel: heated air rises through the chutes into a central chamber into a robust vortex fueled by the heat from the Sun and the heated water vapor entering through misting systems providing air pressure to the vortex that then rotates the electric wind turbine to generate electricity. The air exits through a wide-topped right-side-up funnel, avoiding the drag and instability associated with chimney-style exhausts. A swirl turbine assembly is mounted above the funnel to harvest rotational energy. Unlike prior art, the wide exhaust permits controlled expansion of the vortex, increasing mass throughput and reducing turbulence losses. (ii) Misting and heat exchange system: The present invention integrates a misting system that injects hot water vapor within the upper third of each chute. This misting adds enthalpy, humidity, and momentum to the rising air column, increasing vortex strength. The water supply is heated through an antifreeze-buffered solar storage system, consisting of: an insulated tank containing antifreeze solution, a heat-exchanger coil for heat exchange between water for misting in the chutes and solar-heated antifreeze solution, and solar thermal inputs from chute assemblies. This ensures sustained operation during cloudy days or at night, enabling extended agricultural use. (iii) Ventilation and control systems: Motorized sliding doors at the apex of the greenhouse regulate airflow and internal greenhouse temperature. Side vents and relief channels allow excess pressure release during high solar flux conditions, preventing structural strain. Airflow patterns are further stabilized by adjustable sail arrays, which can be tuned for seasonal wind conditions. (iv) Agricultural integration: The clamshell structure doubles as a greenhouse farm, suitable for growing hemp, specialty crops, or food plants. Its transparent chutes admit sunlight while diffusing excessive glare, and its convective circulation prevents stagnation. The system's design is especially beneficial in arid lands where both renewable power and agricultural modernization are needed. For instance, hemp cultivation can provide significant revenue streams, while vortex-driven power supports irrigation, grow-lighting, and processing equipment. (v) Scalability and modular deployment: The present invention may be deployed in scales ranging from small (1-5 acres) modular clamshells for community farming, to larger (30+ acre) installations integrated with wind turbines, batteries, and crop processing plants. Unlike monolithic concrete towers, the chute assemblies are transportable and rapidly erectable, reducing capital cost and permitting phased construction.

In the present invention, the heated air generated within the clamshell greenhouse rises and is guided by a set of transparent heavy-duty chutes arranged in a corkscrew-like fashion. The chutes redirect the rising warm air toward a central orifice at the apex of the structure. Unlike prior art systems employing narrow chimneys, the orifice is coupled to a funnel exhaust, oriented right-side-up (wide at the top). This arrangement reduces drag on the vortex, enabling stable upward spiraling of air and efficient energy transfer to a turbine located within a swirl chamber above the central pole. To enhance air velocity and vortex sustainability, the invention incorporates hot air and hot water mist injection. A plurality of misting nozzles is positioned within the upper one-third of each chute, ensuring that injected hot water vapor is entrained into the airflow without accumulating inside the chute. The mist increases air mass, humidity, and enthalpy, providing more energy to the turbine than dry air alone. The hot water used for misting is generated through a heat exchanger system wherein a coil of water tubing is immersed in a storage tank filled with an antifreeze solution. The antifreeze solution is heated by solar gain and circulates to maintain both greenhouse temperature regulation and misting readiness. This configuration ensures reliable operation during cloudy conditions and into the evening hours. At the clamshell's apex, the central orifice is equipped with motorized sliding doors to regulate airflow and internal temperature. In addition, pressure relief vents are provided to divert excess airflow when the orifice is partially closed, maintaining system stability and protecting structural integrity. Additionally, unlike traditional solar vortex systems, the present invention doubles as a self-enclosed greenhouse farm. The transparent chute assemblies allow sufficient solar transmission for plant growth while moderating temperature extremes. The circulation of warm, moist air establishes a controlled micro-climate, enabling year-round agricultural production in addition to renewable energy generation.

In the present invention, for vortex formation, heated air in the form of a very vigorous spinning vortex from within the chute assemblies rises into a central swirl chamber. A set of corkscrew-arranged transparent sails redirects the upward flow from the interior of the greenhouse of additional heated and moistened air into a rotational path as a supplementary source of a relatively slower-moving vortex that adds to the more vigorous spinning vortex from the chutes. The heated and moist air forming the vortex exits through a funnel-shaped exhaust, oriented right-side-up (wide at the top, narrow at the bottom). This geometry reduces turbulence, lowers drag, and promotes stable vortex expansion compared to traditional chimney-based systems.

In the present invention, for energy harvesting, a swirl turbine is positioned at the funnel exit. As the vortex accelerates upward, the turbine converts rotational energy into mechanical power, which is then converted to electricity by a generator.

In the present invention, misting and heat exchange are employed to sustain operation, especially during low-sun periods. A misting system injects hot water vapor into the airflow. The system generally comprises: misting nozzles located in the upper third of each chute, a hot water loop heated by an antifreeze-buffered storage tank, heat exchangers that capture and store excess solar heat, geothermal heat, or waste heat. This design provides continuous enthalpy input, enabling operation beyond direct solar hours.

In the present invention, at the central orifice, motorized sliding doors regulate airflow rate and greenhouse temperature. Relief vents allow excess pressure discharge when airflow is restricted.

In the present invention, the clamshell doubles as a greenhouse enclosure. The transparent chute modules admit sufficient light for plant photosynthesis, while the convection-driven circulation prevents humidity buildup. The system is particularly suited for hemp cultivation, as outlined in tribal economic development projects, but may also be applied to vegetables, grains, or specialty crops.

Importantly, it is the chutes that provide the majority of the hot, rising, moistened or humidified air pressure that drives the vortex, since their surfaces or panes receive the greatest amount of direct sunlight through most of the day, owing to the unique clamshell design aimed to have at least one of the chutes always in the path of direct sunlight. In contrast, the greenhouse interior functions more like a thermal and moisture reservoir, maintaining a lower but steadier level of heat and pressure that supports a slow, sustained vortex during the later hours of the day. The most vigorous spinning of the vortex, which powers the turbine, occurs during the central part of the day when the chutes are most active. Meanwhile, the greenhouse's stored heat becomes particularly valuable during cloudy periods, contributing to some power generation, and on cold days, helping to maintain the thermal conditions required for crop growth. To clarify, the highest air pressure driving the vortex originates primarily from the chutes, with the greenhouse interior serving a secondary, sustaining role.

In the present invention, the modular chute system supports scalable deployments: small-scale installations (˜1 to 5 acres) for local food and energy needs. Mid-scale farms (˜10 to 30 acres) integrating crop production with local power generation. Large-scale vortex power farms (˜30+ acres) for commercial electricity production and agricultural export. Because the chute assemblies are lightweight and transportable, installations can be constructed in phases, reducing upfront capital costs compared to concrete solar chimney projects.

The present invention thus meets the unmet needs in the art by providing a system that combines vortex power generation with greenhouse farming in a dual-use design; eliminates the need for tall towers and costly reinforced bases; sustains operation using thermal storage and mist injection; employs modular construction, enabling deployment from prototypes to commercial scale; and provides additional environmental benefits, including cloud formation and potential rainfall induction.

In one embodiment of the present invention, it provides a solar vortex clamshell greenhouse system comprising an array of triangular chute assemblies forming a dome-like clamshell. Solar-heated air rises through the chutes into a central swirl chamber. The rotating air exits through a wide-topped funnel, driving a turbine to generate power. In another embodiment of the present invention, the system includes a misting augmentation system coupled to an antifreeze-buffered storage tank, ensuring sustained vortex operation during cloudy or nighttime conditions. In another embodiment of the present invention, it provides a structure that doubles as a greenhouse enclosure, enabling crop production alongside power generation. The modular design supports community-scale farms, commercial vortex power stations, and prototype testing facilities.

In an embodiment of the present invention, it provides a plurality of chute assemblies that comprises: a transparent top and bottom layer made of UV-resistant sheeting; a black open-weave cloth absorber capturing 10% to 90% of solar energy; adjustable slope and angle, oriented substantially perpendicular to solar incidence at installation latitude; a triangular geometry for efficient modular assembly. When heated by sunlight, air beneath the chute rises into the central swirl chamber.

In an embodiment of the present invention, it provides that vortex exits through a funnel exhaust with a wide upper opening and narrow lower opening, reducing turbulence and drag compared to chimney designs. A swirl turbine positioned at the throat of the funnel extracts mechanical energy, which is converted to electricity.

In an embodiment of the present invention, it provides a misting and thermal storage system where an antifreeze-buffered storage tank retains solar heat collected during the day, a heat exchanger coil transfers stored heat to water; misting nozzles inject vapor into the upper chute assemblies, increasing buoyancy and sustaining the vortex beyond daylight, and dual-purpose misting also provides crop irrigation within the greenhouse.

In an embodiment of the present invention, it provides a greenhouse and energy generation system, where the transparent clamshell admits sufficient light for photosynthesis, rising air circulation inside the greenhouse helps in moderating humidity and temperature, and it is suitable for growing plants, especially crops.

In an embodiment of the present invention, it provides that the strong vertical convection column generated may extend into the lower atmosphere, stimulating cloud nucleation and potentially increasing localized rainfall, recycling water over the greenhouse farm.

In an embodiment of the present invention, it provides prefabricated, transportable chute assemblies allow phased and modular deployment.

The present invention discloses and demonstrates feasibility through 1/10th of an acre prototype designs for validating chute geometry, airflow, and funnel vs. chimney comparisons, where computational simulations showing reduced drag in wide-topped funnels, and scaled test models are being tested to evaluate vortex initiation thresholds and crop-lighting effects.

The present invention discloses an overall general structure of a clamshell shaped greenhouse with a dual-use/dual function solar-powered vortex-based energy generator and climate-controlled greenhouse comprising a clamshell-shaped roof formed by paired trapezoidal chutes (1a to 1l) repeated on either side of a central support pole (12) supported by a plurality of beams (3a to 3l) also repeated around the central support pole (12) for a total of 12 chutes and beams (refer to FIG. 11, panel A, i.e., FIG. 11A). When the 24 beams (3a to 3l) on left and right are attached together with their chutes (1a to 1l) on left and right side to the central support pole (12), the chutes (1a to 1l) are named similarly on the left side of the roof from the central support pole (12) same as on the right side of the roof from the central support pole (12). Each of the chutes (1d to 1l) on left and right blows into a plurality of chute vent (28) that connects to chute vanes (32) at the swirl chamber (27) in the top-center of the greenhouse. Chutes (1a to 1l) vary in length and bottom width according to their position, as shown in Table 1 below. The chutes (1) direct hot air upward into vents (28, 29) leading to a swirl chamber (27) where an electric wind turbine (10) is positioned. FIG. 11A shows the arrangement of the total group of beams (3a to 3l) and chutes (1a to 1l) with a top-down view. FIG. 11, panel B, i.e., FIG. 11B shows the trapezoidal shape of one of the chutes (1) of the plurality of chutes (1) on the top of the greenhouse forming the roof of the greenhouse, with top width of 17.62″, and varying bottom widths of different chutes from 1a to 1l.

TABLE 1
Dimensions of Beams and Chutes Forming the Roof of the Greenhouse

| | | | | | Width - | Width - | | Volume |
|---|---|---|---|---|---|---|---|---|
| Chute | Beam | Length | Beam | Length | Top | Bot. | Height | (Cubic |
| Pair | (L) | (inches) | (R) | (inches) | (Inches) | (Inches) | (inches) | Feet) |
| 1a | 3a | 347.00 | 3a | 347.25 | 17.62 | 58.75 | 24.0 | 184.1 |
| 1b | 3b | 347.25 | 3b | 354.50 | 17.62 | 62.50 | 24.0 | 196.3 |
| 1c | 3c | 354.50 | 3c | 363.25 | 17.62 | 67.25 | 24.0 | 213.0 |
| 1d | 3d | 363.25 | 3d | 381.00 | 17.62 | 78.00 | 24.0 | 250.8 |
| 1e | 3e | 381.00 | 3e | 408.75 | 17.62 | 93.00 | 24.0 | 310.6 |
| 1f | 3f | 408.75 | 3f | 446.75 | 17.62 | 109.75 | 24.0 | 390.5 |
| 1g | 3g | 446.75 | 3g | 493.00 | 17.62 | 125.50 | 24.0 | 484.3 |
| 1h | 3h | 493.00 | 3h | 543.75 | 17.62 | 141.00 | 24.0 | 592.7 |
| 1i | 3i | 543.75 | 3i | 595.25 | 17.62 | 155.00 | 24.0 | 707.2 |
| 1j | 3j | 595.25 | 3j | 642.00 | 17.62 | 166.25 | 24.0 | 814.0 |
| 1k | 3k | 642.00 | 3k | 668.12 | 17.62 | 171.00 | 24.0 | 871.9 |
| 1l | 3l | 668.12 | 3l | 681.75 | 17.62 | 175.00 | 24.0 | 910.2 |

In Table 1, the information on all of the measurements of beams (3a to 3l) and chutes (1a to 1l) for a 1/10th of an acre pilot greenhouse structure is laid out in complete detail. FIGS. 11A and 11B provide that: (i) all chutes (1a to 1l) are 24″ high, which is also the depth of the beams; (ii) the width at the top of all chutes is 17.62″ (based on the radius of 11′-2″ diameter); (iii) the width at the bottom of each chute varies; (iv) the length of each chute varies, corresponding to the length of each flanking beam; (v) chutes are in pairs of identical size, for a total of 24 chutes, i.e., 1a to 1lon the left and right sides of the from the central support pole (12); and (vi) six of the chutes (1a, 1b, and 1c) in pairs on left and right sides of the central support pole (12) are inactive to overcome potential siphon effect as explained later in the Examples.

The present invention further discloses chutes for heat collection where each of the chutes (1) includes double-pane transparent covers (19, 20), reflective film (22), and a heat-absorbing cloth screen (21), which is black with 10% to 90% absorption values, all made from UV-protective material to inhibit degradation. The chutes (1) concentrate solar-heated air, increasing air pressure per Pascal's law, accelerating flow toward the turbine. Optional Mylar film (36), a third pane, may provide additional insulation for colder climates.

The present invention further discloses a vortex and turbine assembly where curved vanes (32, 33) guide hot air in a counterclockwise direction (when the greenhouse is located in the Northern Hemisphere of the Earth) or clockwise (when the greenhouse is located in the Southern Hemisphere of the Earth), forming a vortex in the swirl chamber (27). Dampers (30, 31) with latch-strike mechanisms (37a, 37b, 37c) regulate airflow, equalize pressure, and prevent backflow. An electric wind turbine (10) with blades (43) converts the kinetic energy into electricity, which is stored in commercial batteries (13), part of a plurality of electrical equipment in an equipment building (8).

The present invention further discloses a cone (2) and stack (16) assembly for stabilization of the vortex, where a metal stack (16) supports a right-side-up cone (2) that aligns with the vortex. This configuration minimizes drag, stabilizes the vortex, and directs airflow vertically, reducing the risk of lateral disruption

The present invention further discloses climate control systems of regulating temperature and humidity in (and around) the greenhouse, where thermostatically controlled electric ventilation shutters (11), a plurality of misters (34), and a plurality of radiators (48) regulate interior temperature and humidity. A plurality of anemometers (40), at least one, located outside the greenhouse, near the top on the railing of a catwalk (6) around the top of the greenhouse, and a plurality of thermostats (41), located outside and inside the greenhouse, automate closure of orifice doors via an orifice closure device (35) above the swirl chamber (27) and a plurality of dampers (23, 30, 31) during extreme conditions. Emergency pressure relief shutters (42) vent excessive air pressure.

The present invention further discloses a means for agricultural and plant cultivation integration in the greenhouse, where the interior of the greenhouse (55) supports hydroponic plant cultivation on a gravel base (14), with supplemental grow lighting (54). Transparent Lexan side panels (15) admit additional light. Radiators (43) inside the interior of the greenhouse (55) heated indirectly by a plurality of solar heat collectors (48) circulate antifreeze solution via a plurality of pumps (49) and at least one storage tank for antifreeze solution (50). At the same time the plurality of pumps (49) is also utilized to supply water to the radiators, where cool clean, non-salty fresh water is supplied from at least one storage tank for clean, non-salty fresh water (51) to a plurality of misters (34) referred to as interior of the greenhouse misters (34a) for plant growth and climate maintenance, and where heated clean, non-salty fresh water after heat exchange in the large tank of the storage tank for antifreeze solution (50), which is a composite tank with a large outer tank and a smaller tank within the larger tank surrounded by a heat exchanger coil to transfer heat from the heated antifreeze solution in the aforesaid smaller tank to the water in the large tank, which is in turn coming in from the storage tank for clean, non-salty fresh water (51) is heated, and the heated water is supplied to the misters (34) in the chutes (1) referred to as chute misters (34b) to provide warm water vapor to generate heated and moist air for the vortex airflow from the chutes (1) for the turbine (10) in the swirl chamber (27).

The present invention further discloses kits for greenhouse assembly for construction on site, providing modularity to the system as disclosed, where a plurality of beams, a plurality of chutes, and other required structural elements are pre-manufactured, numbered, and shipped in standard containers for rapid assembly. Footings, which are a plurality of concrete piers (5) anchor the structure securely against wind loads.

The present invention further discloses an energy production and storage system, where the generated electricity from the turbine (10) is inverted and stored in grid-scale batteries, part of a plurality of electrical equipment (13) in the equipment building (8). Surplus energy can be distributed externally. The hybrid design integrates food production, energy generation, and water efficiency into a single economic unit.

In an embodiment of the present invention, it provides a solar vortex, clamshell-shaped, energy conversion, and plant growing dual-purpose greenhouse, comprising: a clamshell-shaped roof formed of a plurality of multi-paned, paired trapezoidal chutes (1) around a central chamber, the chutes (1) altogether assembled into a clamshell configuration, each of the chutes (1) including transparent outer covers on top and bottom of the chutes (1) as top and bottom layers referred to as panes, a reflective film (22), and a heat-absorbing material screen (21) in between the top and bottom outer covers as intermediate layers, configured to heat air inside the cavity formed between the transparent outer covers on top and bottom of the chutes (1) by exposure to the Sun and direct the heated air upward inside the greenhouse; a plurality of beams supporting the top and bottom of the chutes (1) and forming the sides of the chutes (1), with the top rails or joists of the beams (3) holding the sides and edges of the chutes (1) forming the roof of the greenhouse, by standard joists for roof support; a plurality of concrete piers (5) as strong footings supporting the greenhouse base, a plurality of columns (25), and keeping the greenhouse structure solid under extreme wind conditions; a plurality of vanes configured to impart a rotational direction to the heated air, including upper vanes referred to as chute vanes (32), and lower vanes referred to as interior greenhouse vanes (33), arranged around a swirl chamber (27) at the top of the greenhouse, configured to guide the heated air into a vortex of pressurized heated airflow referred to as the vortex; a plurality of vents, including upper vents referred to as chute vents (28), and lower vents referred to as interior greenhouse vents (29), to pour the heated air into the swirl chamber (27); an electric wind turbine (10) with blades of the turbine (43) positioned within the swirl chamber (27) rotated by the vortex, and operable to convert kinetic energy of the vortex formed by the heated air pouring into the swirl chamber (27) from the chutes (1) and the interior of the greenhouse (55) into electricity; a stack (16) and cone (2) assembly at the top of the greenhouse, positioned above the swirl chamber (27) to stabilize and vertically guide the vortex upwards to exhaust out of an orifice located above the swirl chamber (27) at the top of the greenhouse; a plurality of shutters that form an air-cooling system, including electric ventilation shutters (11) and emergency pressure relief shutters (42); a plurality of dampers including an operable damper door (23), upper dampers for chute vanes (32) referred to as chute dampers (30), and lower dampers for interior greenhouse vanes (33) referred to as interior greenhouse dampers (31); at least one orifice door system referred to as an orifice closure device (35); a plurality of misters (34); a plurality of actuators (24) with a photocell sensor on top of each of the actuators; a plurality of anemometers (40); a plurality of thermostats (41); a plurality of radiators (46); a catwalk (6) around the top of the greenhouse with a ladder (7) to reach the catwalk (6) for easy access to the interior of the swirl chamber (27) and vortex-producing equipment; an equipment, airlock control, and maintenance building referred to as equipment building (8) with a plurality of electrical equipment (13) inside it; a central mono pole support for the roof of the greenhouse, referred to as a central support pole (12); a plurality of sails (39) positioned within the central chamber to impart rotational motion to the heated air rising from the interior of the greenhouse (55) and guiding the heated air up to the interior greenhouse vanes (33); at least one structural ring (38) consisting of an upper structural ring (38a) and a lower structural ring (38b); a perforated metal panel (44) at the top of the stack (16) that allows the heated air to flow from the emergency pressure relief shutters (42), along the outside of the cone (2), and then out of the perforated metal panel (44) at the top of the stack (16); an attachment (47) of the plurality of sails (39) to the plurality of columns (25) at each of the corners of the greenhouse; a plurality of solar heat collectors (48); a plurality of pumps (49); at least one storage tank for antifreeze solution (50); at least one storage tank for clean, non-salty fresh water (51); at least one storage tank for nutrient-rich water (56); a field of an array of solar heat collectors (52); a network of piping systems (53); a plurality of diagonal braces (45) attached to the angles of the sides of the greenhouse, to help keep a plurality of columns (25) vertical and sides square; and a climate-controlled interior of the greenhouse (55) configured for hydroponic cultivation of plants beneath the chutes (1) forming the roof of the greenhouse, with a gravel base (14) floor of the greenhouse and Lexan panels referred to as Lexan windows (15) for allowing natural light to enter along all the sides of the greenhouse into the interior of the greenhouse (55) for the growth of the plants, wherein the plurality of multi-paned, paired trapezoidal chutes (1) comprises triangular modules arranged in a substantially circular array, and each of the chutes (1) is wider at the bottom than at the top to accelerate airflow upward inside the chutes (1), and is at least double-paned, meaning it has two panes, wherein the clamshell-shaped geometry of the roof of the greenhouse formed by the plurality of multi-paned, paired trapezoidal chutes (1) arranged radially around a central axis comprises a convex outer surface and a concave inner surface configured to focus solar radiation and guide airflow toward the swirl chamber (27), wherein the clamshell-shaped geometry of the roof of the greenhouse induces spiral flow vectors converging toward a central axis, wherein the plurality of beams has each of the beams as a standard-type beam with webbing in its center and top rails or joists of the beams (3) with ends that are bolted to a central structural ring (38) that surrounds the turbine (10) at the top of the roof, and bottom rails or joists of the beams (18) with ends that are bolted to the plurality of columns (25) that form the edges of the multiple sides of the building, wherein the beams are comprised of the top rails or joists of the beams (3), the bottom rails or joists of the beams (18), a webbing made of metal in the center of the beams (9) for Lexan sheathing that supports the top rails or joists of the beams (3), the bottom rails or joists of the beams (18), sheets of Lexan plastic panels (17) that seal the central webbing area encasing both sides of the webbing inside the beams, wherein the plurality of beams is structured such that in the Northern Hemisphere, the two centermost, longest beams face directly South to match the Sun's highest location in the sky in that hemisphere such the Sun shines directly inside them during the longest day of the summer, and in the Southern Hemisphere, the two centermost, longest beams face directly North to match the Sun's highest location in the sky in that hemisphere such the Sun shines directly inside them during the longest day of the Winter, while the remaining beams are mounted at angles consecutively higher on both the West and East sides such that the final beams at the end of each side are more elevated than the centermost chutes (1) forming the roof of the greenhouse, wherein the central support pole (12) placement inside the greenhouse is structured such that it lays the plurality of beams and the plurality of multi-paned, paired trapezoidal chutes (1) back to internally transmit more Solar energy throughout the year when the position of the Sun varies in height, wherein the transparent outer covers in the chutes (1) provide shape to the roof of the greenhouse for visible light capture, and heating of air in the greenhouse, and the two panes heat the ambient air inside the double-paned chutes (1) to generate pressurized heated airflow, the ambient air is the air that entered from a lower intake opening of the chutes (4) at each of the chutes (1), wherein the two panes in the double-paned chutes (1) include a top plastic, UV-resistant, and transparent sheet covering for the roof of the greenhouse, referred to as upper pane (19) of the chutes (1), and a bottom plastic and transparent sheet covering of the roof for the greenhouse, referred to as lower pane (20) of the chutes (1), wherein the upper pane (19) of the chutes (1) covers the clamshell configuration of the greenhouse in its entirety as the top pane of the roof of the greenhouse, wherein the plurality of multi-paned, paired trapezoidal chutes (1) forming the roof of the greenhouse has each of the double-paned chutes (1) between the plurality of beams with a trapezoidal passage, the lower intake opening of the chutes (4), and one of the chute vanes (32) at the top of each of the chutes (1), wherein the trapezoidal passage which forms an air chamber (26) by the sheets of Lexan plastic panels (17) that seal with the use of silicon caulk the central webbing area encasing both sides of the webbing inside the beams, the upper pane (19) of the chutes (1) and the lower pane (20) of the chutes (1) forming the roof of the greenhouse and the chute dampers (30) sealing the top of the chutes (1), and operable damper door (23) sealing the bottom of the chutes (1) and altogether the air chamber (26) so formed is completely sealed to move the heated air inside the chutes (1), wherein the chutes (1), altogether assembled into a clamshell configuration, are oriented at an angle substantially perpendicular to incoming solar rays from the Sun at the latitude of installation of the greenhouse, meaning the latitude where the greenhouse is located on the Earth, wherein the chute vents (28) pour the heated air coming from the chutes (1) into the chute vanes (32) that surround the swirl chamber (27), and the interior greenhouse vents (29) pour the heated air coming from the interior of the greenhouse (55) into the interior greenhouse vanes (33) that surround the swirl chamber (27), wherein the swirl chamber (27) has the chute vents (28), the chute vanes (32), the interior greenhouse vents (29), and the interior greenhouse vanes (33) are angled counterclockwise when the greenhouse is located in the Northern Hemisphere of the Earth and clockwise when the greenhouse is located in the Southern Hemisphere of the Earth to take advantage of the Coriolis forces which tend to spin a vortex in a counterclockwise direction in the Northern Hemisphere and spin a vortex in a counterclockwise direction in the Southern Hemisphere, wherein the vortex is produced from the heated air partly produced in the chutes (1) by heating ambient air entering the chutes (1) from lower intake openings (4) for the chutes (1) are formulated to resist ultraviolet light from the Sun, so they do not break down from exposure to the Sun, wherein the chutes (1) produce an extra capacity hot air pressure system that rotates the blades of the turbine (43) that drives electrical energy production by the turbine (10) at the top of the clamshell, wherein the stack (16) and cone (2) assembly allow the vortex to pass directly in the center of the turbine (10) oriented towards the top of the greenhouse, protects against drag, keeps the vortex vertical, and protects it from side winds, wherein the electrical equipment (13) inside the equipment building (8) thermostatically controls the plurality of shutters, the plurality of dampers, and the orifice door system to regulate airflow and temperature in the greenhouse, wherein the electric wind turbine (10) is positioned below the cone (2) in an assembly that allows the vortex to exhaust out of the greenhouse as its rotational airflow is converted into electricity by rotating the blades of the turbine (43), wherein the turbine (10) generates electricity which is stored in grid-scale batteries, which are part of the plurality of electrical equipment (13) inside the equipment building (8), and powers both greenhouse operations and external systems, wherein the emergency pressure relief shutters (42) are positioned adjacent to but outside the swirl chamber (27), configured to vent excess air pressure in response to the turbine (10) over-revving, causing electrical problems, or destructive wind conditions, thereby protecting the greenhouse and maintaining plant-sustaining temperatures inside the greenhouse, wherein the plurality of columns (25) supports the corners of each of the sides of the greenhouse and the bottom edges of the beams (3), wherein the orifice closure device (35) is positioned above the swirl chamber to shut off upward airflow in response to environmental conditions selectively, wherein the plurality of dampers has a spring and latch system (37) for each of the dampers to seal the dampers, the spring and latch system (37) comprising a snap latch (37a), an electric striker plate (37b), and a spring-loaded adjustable hinge (37c), and the spring and latch system is configured to regulate the opening and closing of each of the dampers based on and in response to air pressure and temperature actuated by signals from the plurality of actuators (24), the plurality of anemometers (40), and the plurality of thermostats (41), wherein the plurality of thermostats (41) is calibrated to maintain interior temperatures inside the interior of the greenhouse (55) between 45° F. and 85° F. for optimal plant growth, wherein the plurality of anemometers (40) is situated at the top of the greenhouse at the handrails of the catwalk (6) and sends a signal to close the orifice closure device (35) if the wind outside is above a destructive speed that makes the vortex dangerous for buildings around the greenhouse, wherein the sides undergo structural expansion and contraction due to temperature changes, as part of the structure is heated by the Sun while another part remains in shade, wherein the central support pole (12) has four angular supports to hold up the structural ring (38), wherein the central support pole (12) supports the internal structure inside the greenhouse, including the interior greenhouse vanes (33), the turbine (10), the cone (2), and the stack (16) to hold them in place with angled supports holding a lower structural ring (38b), wherein the upper structural ring (38a) is attached to the catwalk (6) and is situated just above the blades of the turbine (43), and the orifice closure device (35) is supported and encircled by the upper structural ring (38a), wherein the plurality of sails (39) comprises transparent sheets arranged in a corkscrew configuration and encircle the interior of the greenhouse (55) to impart rotational motion to the heated air from the interior of the greenhouse (55), wherein the plurality of sails (39) is shaped into long trough-shaped structures that capture the rising heated air and nudge it into a slow-moving vortex that then rises into the interior greenhouse vanes (33) to spin the interior air more quickly, until that air from the interior of the greenhouse (55) is sucked into the faster-moving air from the chutes (1) flowing to the swirl chamber (27) and this additional internal air from the interior of the greenhouse (55) supplements the faster-moving air from the chutes (1), wherein the greenhouse with the clamshell-shaped roof maintains the temperature inside the greenhouse for the plants growing in the interior of the greenhouse (55), and for the heated air inside the greenhouse, in part by sending the heated air up and out of the greenhouse to exhaust out of the greenhouse via the cone (2), wherein the greenhouse with the clamshell-shaped roof maximizes the exposure to the Sun without burning the plants growing inside the interior of the greenhouse (55), via various mechanisms including through absorption of the Sun's heat onto the gravel base (14) floor of the greenhouse, having large shuttered openings via the electric ventilation shutters (11) to allow in ambient air to the greenhouse, wherein the plurality of anemometers (40), which are wind speed sensors located on top of the greenhouse, the plurality of thermostats (41), which are temperature sensors located at different locations on top of and inside the greenhouse, and the plurality of actuators (24) with photocell sensors, regulate opening and closing of the plurality of dampers including the operable damper door (23), the chute dampers (30), and the interior greenhouse dampers (31), and opening and closing of the plurality of shutters including the electric ventilation shutters (11) and the emergency pressure relief shutters (42), wherein the plurality of shutters, including the electric ventilation shutters (11) and the emergency pressure relief shutters (42), are remote-controlled and powered interconnected for greenhouse ventilation for air cooling and pressure relief, wherein the equipment building (8) is sealed with a pressure seal damper to maintain an airlock when the temperature outside is low, as sensed by the plurality of thermostats (41), or when the winds are high, as sensed by the plurality of anemometers (40) and holds the electrical equipment (13) including a heavy-duty, high-capacity battery and an electrical inverter like that used for the electrical grid to take the alternating current electricity from the turbine (10) and turn that alternating current electricity into the direct current electricity used by the battery, wherein the ladder (7) is located above the equipment building (8) that rises to the catwalk (6) that provides easy access to the interior of the vortex-producing equipment inside the swirl chamber (27), wherein the electric ventilation shutters (11) located along the sides of the greenhouse are thermostatically controlled by signals from the plurality of thermostats (41) to open when the temperature in the interior of the greenhouse (55) is above a set temperature and close when the temperature in the interior of the greenhouse (55) is below the set temperature, wherein the electric ventilation shutters (11), the emergency pressure relief shutters (42), the orifice closure device (35), the stack (16) and cone (2) assembly, the lower intake openings (4), any other inlets of air into the greenhouse, and any other exhaust vents of air to the outside from inside the greenhouse are fitted with fine mesh screening to keep out dust and parasites that can affect the plants growing inside the greenhouse, wherein the plurality of dampers are employed to specially angled to control the plurality of vents to self-adjust their pressure output such that air from all of the vents is maximized and equalized at the same time to avoid a situation where the air that goes into the swirl chamber (27) from those vents with maximum airflow end up leaking into the low airflow vents which are vents that do not produce much heated airflow upward, and the low airflow vents siphon off the air from the surrounding chutes (1), reducing the power of air that goes to the swirl chamber (27) and then the vortex inside the swirl chamber (27), wherein the orifice closure device (35) in the center of the roof above the swirl chamber (27) is used to seal the heated air inside the greenhouse during cold nights, wherein the plurality of pumps (49) comprises pumps (49) carrying various liquids from one place to an+96+ other in and around the greenhouse, with each pump (49) having a rotary pump for a liquid and an electric motor for driving the pump (49), wherein the liquid is selected from a group consisting of antifreeze solution; cool clean, non-salty fresh water; hot clean, non-salty fresh water; and nutrient-rich water, wherein the plurality of pumps (49) are powered by the turbine (10) at the top of the greenhouse, wherein the network of piping systems (53) moves the various liquids from one place to another in and around the greenhouse, pumped by the plurality of pumps (49), wherein the interior of the greenhouse (55) further comprises a plurality of hydroponic systems (57), and a plant growth lighting system (54) to support year-round plant cultivation and growth, and wherein the solar heat collectors (48) are an array of simple black corrugated metal panels that use surface of the corrugated metal panels to transfer the heat from the Sun to the antifreeze solution running over it to result in heated antifreeze solution and capture the heated antifreeze solution and transfer it to the next solar heat collector in the plurality of the solar heat collectors (48).

In another embodiment of the greenhouse of the present invention as disclosed herein, wherein the chutes (1) are dimensioned and the roof is oriented according to latitude-specific angles to maximize exposure to the Sun, wherein the latitude-specific angles are based upon the latitude of the location of the greenhouse on Earth, wherein the latitude is the angle at which the greenhouse is situated on the Earth away from the Equator.

In another embodiment of the greenhouse of the present invention as disclosed herein, wherein the reflective film (22) comprises ultraviolet and infrared reflective, transparent Mylar film that reflects the ultraviolet and infrared light from the Sun up into the chutes (1) in the enclosure formed between the upper pane (19) and the lower pane (20) of the chutes (1), and the heat-absorbing material screen (21) comprises a removable cloth screen with adjustable absorption which is a high-temperature, removable cloth weave material that reduces loss of heat coming into the chutes (1) from the upper pane (19) by absorption from the Sun and to keep the heat within the chutes (1) of the greenhouse, wherein the heat-absorbing material screen (21) is attached on top of the reflective film (22), the reflective film (22) is attached on top of the lower pane (20) of the chutes (1) as viewed from the bottom of the roof of the greenhouse, and the upper pane (19), the lower pane (20), the heat-absorbing material screen (21), and the reflective film (22) in the chutes maximize energy capture from the Sun.

In another embodiment of the greenhouse of the present invention as disclosed herein, wherein the cone (2) has a wide upper opening and a narrow lower opening as a right-side-up cone as a funnel for exhausting the vortex oriented upwards and is configured to reduce drag on the vortex compared to an inverted cone, and the cone (2) is supported and held upright by the stack (16), which is a cylindrical structure just above the turbine (10) situated inside the swirl chamber (27).

In another embodiment of the greenhouse of the present invention, as disclosed herein, wherein the plurality of misters (34) comprising misting nozzles and pipes comprise misters for the interior of the greenhouse (34a) that inject moisture formed by spraying a fine mist of water vapor into the heated air rising and pouring upwards from the interior of the greenhouse (55) through the interior greenhouse vents (29) to provide a saturated air environment to maximize plant growth inside the greenhouse (55) and to maintain the temperature inside the greenhouse by using the water vapor coming into the greenhouse by the misters for the interior of the greenhouse (34a) to cool down the heated air inside the interior of the greenhouse (55), and misters for the chutes (34b) that inject moisture formed by spraying a fine mist of heated water vapor into the heated air rising and pouring upwards from the each of the chutes (1) towards the turbine (10) through the chute vents (28) to increase the heated air pressure of the heated air flowing in the swirl chamber (27) to striking the blades of the turbine (43) forming a vortex to engulf and rotate the blades of the turbine (43) to enhance vortex strength and produce electricity more efficiently, wherein the misters for the interior of the greenhouse (34a) have switchable valves regulating the pipes of the misters for the interior of the greenhouse (34a) and the misters for the interior of the greenhouse (34a) are turned on by the switchable valves that open when the heat in the interior of the greenhouse (55) hits above a first minimum set temperature, and wherein the misters for the chutes (34b) have switchable valves regulating the pipes of the misters for the chutes (34b) and the misters for the chutes (34b) are turned on by the switchable valves that open when the heat in the chutes (1) hits below a second minimum set temperature.

In another embodiment of the greenhouse of the present invention as disclosed herein, wherein the plurality of pumps (49) comprises pumps (49) carrying various liquids from one place to another in and around the greenhouse, with each pump (49) having a rotary pump for a liquid and an electric motor for driving the pump (49), wherein the liquid is selected from a group consisting of antifreeze solution; cool clean, non-salty fresh water; hot clean, non-salty fresh water; and nutrient-rich water, and wherein the plurality of pumps (49) are selected from a group of pumps (49) including pumps (49) to push the antifreeze solution from the solar heat collectors (48) to one of the at least one storage tank for antifreeze solution (50) and then on to the plurality of radiators (46) in the greenhouse for heating the interior of the greenhouse (55); pumps (49) which are hydroponic pumps to push and pump cool clean, non-salty water from the storage tank for clean, non-salty fresh water (51) into the greenhouse via misters for the interior of the greenhouse (34a) located inside the interior of the greenhouse (55); pumps (49) which are hydroponic pumps to push and pump heated clean, non-salty water into the greenhouse via misters for the chutes (34b) located inside the chutes (1); and pumps (49) to push nutrient-rich water from the storage tanks for nutrient-rich water (56) to the interior of the greenhouse (55) for the hydroponic cultivation of plants, wherein the plurality of pumps (49) are powered by the turbine (10) at the top of the greenhouse.

In another embodiment of the greenhouse of the present invention as disclosed herein, wherein the network of piping systems (53) moves the various liquids from one place to another in and around the greenhouse, pumped by the plurality of pumps (49), and wherein the network of piping systems (53) comprises piping systems (53) selected from a group consisting of piping systems (53) that connects all of the solar heat collectors (48) to the storage tank for antifreeze solution (50) and supplies heated antifreeze solution to the plurality of radiators (46) encircling the lower walls of the interior of the greenhouse (55) and provides heat by circulating heated antifreeze solution through the solar heat collectors (48) to the storage tank for antifreeze (50); piping systems (53) that connect the storage tank for cool clean, non-salty fresh water (51) to the interior of the greenhouse (55) to supply the clean, non-salty fresh water to the plurality of misters (34) throughout the greenhouse; piping systems (53) that connect the large tank inside the storage tank for antifreeze solution (50) which is supplied with the clean, non-salty fresh water from the storage tank for clean, non-salty fresh water (51) to be heated by heat exchange inside the storage tank for antifreeze solution (50) and the heated water is then supplied to the misters for the chutes (34b) in the chutes (1); piping systems (53) that connect the storage tanks for nutrient-rich water (56) to the interior of the greenhouse (55) for the hydroponic cultivation of plants.

In another embodiment of the greenhouse of the present invention as disclosed herein, wherein the storage tank for antifreeze solution (50) is a composite of two tanks, a large insulated tank that has a large copper coil inside it wrapped around a second, smaller tank that holds the antifreeze solution with a capacity to fill the plurality of radiators (46) encircling the lower walls of the interior of the greenhouse (55), the plurality of solar heat collectors (48), and the network of piping systems (53) connecting the solar heat collectors (48) located outside the greenhouse to the plurality of radiators (46) inside the interior of the greenhouse (55), wherein the large copper coil wrapped around the smaller tank inside the large insulated tank within the storage tank for antifreeze solution (50) acts as a heat exchanger, while the larger tank acts as an antifreeze-buffered thermal storage tank for supplying heated water to the misters for the chutes (34b) supplying heated water in the chutes (1), and wherein the antifreeze solution is pumped back through the small tank within the storage tank for antifreeze solution (50) on to the field of an array of solar heat collectors (52) until the small tank reaches a set temperature to maintain the cycle of antifreeze heating.

In another embodiment of the greenhouse of the present invention, as disclosed herein, wherein the plurality of dampers and actuators (24) are operatively coupled to the chutes (1) and swirl chamber (27), said plurality of dampers being automatically controlled by thermostats (41) and anemometers (40) to regulate airflow into and out of the greenhouse.

In an embodiment of the present invention, it provides a combined power-generation and plant-growing system, comprising: a solar vortex, clamshell-shaped, energy conversion, and plant growing dual-purpose greenhouse enclosure having a clamshell-shaped roof with a solar-energy and heat collecting plurality of multi-paned, paired trapezoidal chutes (1) arranged in a clamshell shape around a central chamber supported by a plurality of beams for roof support, a plurality of concrete piers (5) to support the base of the greenhouse, a central support pole (12) that provides support for the roof of the greenhouse; a hydroponic plant growth system comprising a plurality of hydroponic systems (57) disposed inside the enclosure in the central chamber in the interior of the greenhouse (55); a vortex airflow generating system comprising a plurality of vanes, including chute vanes (32) and a interior greenhouse vanes (33) arranged around a swirl chamber (27) located at the top of the greenhouse and configured to guide heated air into a vortex of pressurized heated airflow referred to as the vortex, a plurality of vents, including chute vents (28) and interior greenhouse vents (29), and chute dampers (30) and interior greenhouse dampers (33), and a plurality of sails (39); an electric wind turbine (10) positioned in the swirl chamber (27) to generate electrical energy from the vortex airflow; a temperature regulation system comprising a plurality of solar heat collectors (48), at least one storage tank for antifreeze solution (50), at least one storage tank for clean, non-salty fresh water (51), a field of an array of solar heat collectors (52), a network of piping systems (53), a plurality of pumps (49), a plurality of radiators (46), electric ventilation shutters (11), an emergency pressure relief shutters (42), a plurality of thermostats (41), a plurality of actuators (24) with a photocell sensor on top, a plurality of misters (34), an orifice closure device (35), an operable damper door (23), chute dampers (30), interior greenhouse dampers (31), a spring and latch system (37), and a stack (16) and cone (2) assembly at the top of the greenhouse, configured to regulate greenhouse temperature by circulating antifreeze and water; a control system inside an equipment building (8) with a plurality of electrical equipment (13) inside it, integrating power output from the electric wind turbine (10), climate control sensors including the plurality of thermostats (41), the plurality of actuators (24) with a photocell sensor on top, an a plurality of anemometers (40), the plurality of radiators (46), a plurality of solar heat collectors (48), a plurality of pumps (49), at least one storage tank for antifreeze solution (50), the at least one storage tank for clean, non-salty fresh water (51), the field of an array of solar heat collectors (52), the network of piping systems (53); and an irrigation system made of the plurality of hydroponic systems (57), a plant growth lighting system (54) inside a climate-controlled interior of the greenhouse (55) configured for hydroponic cultivation of plants beneath the chutes (1) forming the roof of the greenhouse, piping systems (53) that connect the storage tank for clean, non-salty fresh water (51) to the interior of the greenhouse (55) to supply the clean, non-salty fresh water to the plurality of misters (34) throughout the greenhouse, at least one storage tank for nutrient-rich water (56), and a plurality of hydroponic systems (57), wherein the clamshell-shaped geometry of the roof of the greenhouse formed by the plurality of multi-paned, paired trapezoidal chutes (1) arranged radially around a central axis comprises a convex outer surface and a concave inner surface configured to focus solar radiation and guide airflow toward the swirl chamber (27), wherein the clamshell-shaped geometry of the roof of the greenhouse induces spiral flow vectors converging toward a central axis, wherein the solar vortex, clamshell-shaped, energy conversion, and plant growing dual-purpose greenhouse further comprises the plurality of multi-paned, paired trapezoidal chutes (1) around a central chamber, the chutes (1) altogether assembled into the clamshell configuration, each of the chutes (1) including transparent outer covers on top and bottom of the chutes (1) as top and bottom layers referred to as panes, a reflective film (22), and a heat-absorbing material screen (21) in between the top and bottom outer covers as intermediate layers, configured to heat air inside the cavity formed between the transparent outer covers on top and bottom of the chutes (1) by exposure to the Sun and direct the heated air upward inside the greenhouse, the plurality of beams supporting the top and bottom of the chutes (1) and forming the sides of the chutes (1), with the top rails or joists of the beams (3) of the plurality of beams holding the sides and edges of the chutes (1) forming the roof of the greenhouse, by standard joists for roof support, the plurality of concrete piers (5) as strong footings supporting the greenhouse base, a plurality of columns (25), and keeping the greenhouse structure solid under extreme wind conditions, the plurality of vanes configured to impart a rotational direction to the heated air, including upper vanes referred to as the chute vanes (32), and lower vanes referred to as the interior greenhouse vanes (33), arranged around the swirl chamber (27) at the top of the greenhouse, configured to guide the heated air into a vortex of pressurized heated airflow referred to as the vortex, the plurality of vents, including upper vents referred to as the chute vents (28), and lower vents referred to as the interior greenhouse vents (29), to pour the heated air into the swirl chamber (27), the electric wind turbine (10) with blades of the turbine (43) positioned within the swirl chamber (27) rotated by the vortex, and operable to convert kinetic energy of the vortex formed by the heated air pouring into the swirl chamber (27) from the chutes (1) and the interior of the greenhouse (55) into electricity, the stack (16) and cone (2) assembly at the top of the greenhouse, positioned above the swirl chamber (27) to stabilize and vertically guide the vortex upwards to exhaust out of an orifice located above the swirl chamber (27) at the top of the greenhouse, a plurality of shutters that form an air-cooling system, including the electric ventilation shutters (11) and the emergency pressure relief shutters (42), the plurality of dampers including the operable damper door (23), upper dampers for the chute vanes (32) referred to as the chute dampers (30), and lower dampers for the interior greenhouse vanes (33) referred to as the interior greenhouse dampers (31), a catwalk (6) around the top of the greenhouse with a ladder (7) to reach the catwalk (6) for easy access to the interior of the swirl chamber (27) and the vortex-producing equipment, a central mono pole support for the roof of the greenhouse, referred to as the central support pole (12), the plurality of sails (39) positioned within the central chamber to impart rotational motion to the heated air rising from the interior of the greenhouse (55) and guiding the heated air up to the interior greenhouse vanes (33), at least one structural ring (38) consisting of an upper structural ring (38a) and a lower structural ring (38b), a perforated metal panel (44) at the top of the stack (16) that allows the heated air to flow from the emergency pressure relief shutters (42), along the outside of the cone (2), and then out of the perforated metal panel (44) at the top of the stack (16), an attachment (47) of the plurality of sails (39) to a plurality of columns (25) at each of the corners of the greenhouse, a plurality of diagonal braces (45) attached to the angles of the sides of the greenhouse, to help keep a plurality of columns (25) vertical and sides square, and a climate-controlled interior of the greenhouse (55) configured for hydroponic cultivation of plants beneath the chutes (1) forming the roof of the greenhouse, with a gravel base (14) floor of the greenhouse and Lexan panels referred to as Lexan windows (15) for allowing natural light to enter along all the sides of the greenhouse into the interior of the greenhouse (55) for the growth of the plants, wherein the plurality of multi-paned, paired trapezoidal chutes (1) comprises triangular modules arranged in a substantially circular array, and each of the chutes (1) is wider at the bottom than at the top to accelerate airflow upward inside the chutes (1), and is at least double-paned, meaning it has two panes, wherein the plurality of beams has each of the beams as a standard-type beam with webbing in its center and top rails or joists of the beams (3) with ends that are bolted to the central structural ring (38) that surrounds the turbine (10) at the top of the roof, and the bottom rails or joists of the beams (18) with ends that are bolted to the plurality of columns (25) that form the edges of the multiple sides of the building, wherein the beams are comprised of the top rails or joists of the beams (3), the bottom rails or joists of the beams (18), a webbing made of metal in the center of the beams (9) for Lexan sheathing that supports the top rails or joists of the beams (3), the bottom rails or joists of the beams (18), sheets of Lexan plastic panels (17) that seal the central webbing area encasing both sides of the webbing inside the beams, wherein the plurality of beams is structured such that in the Northern Hemisphere, the two centermost, longest beams face directly South to match the Sun's highest location in the sky in that hemisphere such the Sun shines directly inside them during the longest day of the summer, and in the Southern Hemisphere, the two centermost, longest beams face directly North to match the Sun's highest location in the sky in that hemisphere such the Sun shines directly inside them during the longest day of the Winter, while the remaining beams are mounted at angles consecutively higher on both the West and East sides such that the final beams at the end of each side are more elevated than the centermost chutes (1) forming the roof of the greenhouse, wherein the central support pole (12) placement inside the greenhouse is structured such that it lays the plurality of beams and the plurality of multi-paned, paired trapezoidal chutes (1) back to internally transmit more Solar energy throughout the year when the position of the Sun varies in height, wherein the transparent outer covers in the chutes (1) provide shape to the roof of the greenhouse for visible light capture, and heating of air in the greenhouse, and the two panes heat the ambient air inside the double-paned chutes (1) to generate pressurized heated airflow, the ambient air is the air that entered from a lower intake opening of the chutes (4) at each of the chutes (1), wherein the two panes in the double-paned chutes (1) include a top plastic, UV-resistant, and transparent sheet covering for the roof of the greenhouse, referred to as upper pane (19) of the chutes (1), and a bottom plastic and transparent sheet covering of the roof for the greenhouse, referred to as lower pane (20) of the chutes (1), wherein the upper pane (19) of the chutes (1) covers the clamshell configuration of the greenhouse in its entirety as the top pane of the roof of the greenhouse, wherein the plurality of multi-paned, paired trapezoidal chutes (1) forming the roof of the greenhouse has each of the double-paned chutes (1) between the plurality of beams with a trapezoidal passage, the lower intake opening of the chutes (4), and one of the chute vanes (32) at the top of each of the chutes (1), wherein the trapezoidal passage which forms an air chamber (26) by the sheets of Lexan plastic panels (17) that seal with the use of silicon caulk the central webbing area encasing both sides of the webbing inside the beams, the upper pane (19) of the chutes (1) and the lower pane (20) of the chutes (1) forming the roof of the greenhouse and the chute dampers (30) sealing the top of the chutes (1), and operable damper door (23) sealing the bottom of the chutes (1) and altogether the air chamber (26) so formed is completely sealed to move the heated air inside the chutes (1), wherein the chutes (1), altogether assembled into a clamshell configuration, are oriented at an angle substantially perpendicular to incoming solar rays from the Sun at the latitude of installation of the greenhouse, meaning the latitude where the greenhouse is located on the Earth, wherein the chute vents (28) pour the heated air coming from the chutes (1) into the chute vanes (32) that surround the swirl chamber (27), and the interior greenhouse vents (29) pour the heated air coming from the interior of the greenhouse (55) into the interior greenhouse vanes (33) that surround the swirl chamber (27), wherein the swirl chamber (27) has the chute vents (28), the chute vanes (32), the interior greenhouse vents (29), and the interior greenhouse vanes (33) are angled counterclockwise when the greenhouse is located in the Northern Hemisphere of the Earth and clockwise when the greenhouse is located in the Southern Hemisphere of the Earth to take advantage of the Coriolis forces which tend to spin a vortex in a counterclockwise direction in the Northern Hemisphere and spin a vortex in a counterclockwise direction in the Southern Hemisphere, wherein the vortex is produced from the heated air partly produced in the chutes (1) by heating ambient air entering the chutes (1) from lower intake openings (4) for the chutes (1) are formulated to resist ultraviolet light from the Sun, so they do not break down from exposure to the Sun, wherein the chutes (1) produce an extra capacity hot air pressure system that rotates the blades of the turbine (43) that drives electrical energy production by the turbine (10) at the top of the clamshell, wherein the stack (16) and cone (2) assembly allow the vortex to pass directly in the center of the turbine (10) oriented towards the top of the greenhouse, protects against drag, keeps the vortex vertical, and protects it from side winds, wherein the electrical equipment (13) inside the equipment building (8) thermostatically controls the plurality of shutters, the plurality of dampers, and the orifice door system to regulate airflow and temperature in the greenhouse, wherein the electric wind turbine (10) is positioned below the cone (2) in an assembly that allows the vortex to exhaust out of the greenhouse as its rotational airflow is converted into electricity by rotating the blades of the turbine (43), wherein the turbine (10) generates electricity which is stored in grid-scale batteries, which are part of the plurality of electrical equipment (13) inside the equipment building (8), and powers both greenhouse operations and external systems, wherein the emergency pressure relief shutters (42) are positioned adjacent to but outside the swirl chamber (27), configured to vent excess air pressure in response to the turbine (10) over-revving, causing electrical problems, or destructive wind conditions, thereby protecting the greenhouse and maintaining plant-sustaining temperatures inside the greenhouse, wherein the plurality of columns (25) supports the corners of each of the sides of the greenhouse and the bottom edges of the beams (3), wherein the orifice closure device (35) is positioned above the swirl chamber to shut off upward airflow in response to environmental conditions selectively, wherein the plurality of dampers has a spring and latch system (37) for each of the dampers to seal the dampers, the spring and latch system (37) comprising a snap latch (37a), an electric striker plate (37b), and a spring-loaded adjustable hinge (37c), and the spring and latch system is configured to regulate the opening and closing of each of the dampers based on and in response to air pressure and temperature actuated by signals from the plurality of actuators (24), the plurality of anemometers (40), and the plurality of thermostats (41), wherein the plurality of thermostats (41) is calibrated to maintain interior temperatures inside the interior of the greenhouse (55) between 45° F. and 85° F. for optimal plant growth, wherein the plurality of anemometers (40) is situated at the top of the greenhouse at the handrails of the catwalk (6) and sends a signal to close the orifice closure device (35) if the wind outside is above a destructive speed that makes the vortex dangerous for buildings around the greenhouse, wherein the sides undergo structural expansion and contraction due to temperature changes, as part of the structure is heated by the Sun while another part remains in shade, wherein the central support pole (12) has four angular supports to hold up the structural ring (38), wherein the central support pole (12) supports the internal structure inside the greenhouse, including the interior greenhouse vanes (33), the turbine (10), the cone (2), and the stack (16) to hold them in place with angled supports holding a lower structural ring (38b), wherein the upper structural ring (38a) is attached to the catwalk (6) and is situated just above the blades of the turbine (43), and the orifice closure device (35) is supported and encircled by the upper structural ring (38a), wherein the plurality of sails (39) comprises transparent sheets arranged in a corkscrew configuration and encircle the interior of the greenhouse (55) to impart rotational motion to the heated air from the interior of the greenhouse (55), wherein the plurality of sails (39) is shaped into long trough-shaped structures that capture the rising heated air and nudge it into a slow-moving vortex that then rises into the interior greenhouse vanes (33) to spin the interior air more quickly, until that air is sucked into the faster-moving air flowing to the swirl chamber (27) from the chutes (1), wherein the greenhouse with the clamshell-shaped roof maintains the temperature inside the greenhouse for the plants growing in the interior of the greenhouse (55), and for the heated air inside the greenhouse, in part by sending the heated air up and out of the greenhouse to exhaust out of the greenhouse via the cone (2), wherein the greenhouse with the clamshell-shaped roof maximizes the exposure to the Sun without burning the plants growing inside the interior of the greenhouse (55), via various mechanisms including through absorption of the Sun's heat onto the gravel base (14) floor of the greenhouse, having large shuttered openings via the electric ventilation shutters (11) to allow in ambient air to the greenhouse, wherein the plurality of anemometers (40), which are wind speed sensors located on top of the greenhouse, the plurality of thermostats (41), which are temperature sensors located at different locations on top of and inside the greenhouse, and the plurality of actuators (24) with photocell sensors, regulate opening and closing of the plurality of dampers including the operable damper door (23), the chute dampers (30), and the interior greenhouse dampers (31), and opening and closing of the plurality of shutters including the electric ventilation shutters (11) and the emergency pressure relief shutters (42), wherein the plurality of shutters, including the electric ventilation shutters (11) and the emergency pressure relief shutters (42), are remote-controlled and powered interconnected for greenhouse ventilation for air cooling and pressure relief, wherein the equipment building (8) is sealed with a pressure seal damper to maintain an airlock when the temperature outside is low, as sensed by the plurality of thermostats (41), or when the winds are high, as sensed by the plurality of anemometers (40) and holds the electrical equipment (13) including a heavy-duty, high-capacity battery and an electrical inverter like that used for the electrical grid to take the alternating current electricity from the turbine (10) and turn that alternating current electricity into the direct current electricity used by the battery, wherein the ladder (7) is located above the equipment building (8) that rises to the catwalk (6) that provides easy access to the interior of the vortex-producing equipment inside the swirl chamber (27), wherein the electric ventilation shutters (11) located along the sides of the greenhouse are thermostatically controlled by signals from the plurality of thermostats (41) to open when the temperature in the interior of the greenhouse (55) is above a set temperature and close when the temperature in the interior of the greenhouse (55) is below the set temperature, wherein the electric ventilation shutters (11), the emergency pressure relief shutters (42), the orifice closure device (35), the stack (16) and cone (2) assembly, the lower intake openings (4), any other inlets of air into the greenhouse, and any other exhaust vents of air to the outside from inside the greenhouse are fitted with fine mesh screening to keep out dust and parasites that can affect the plants growing inside the greenhouse, wherein the plurality of dampers are employed to specially angled to control the plurality of vents to self-adjust their pressure output such that air from all of the vents is maximized and equalized at the same time to avoid a situation where the air that goes into the swirl chamber (27) from those vents with maximum airflow end up leaking into the low airflow vents which are vents that do not produce much heated airflow upward, and the low airflow vents siphon off the air from the surrounding chutes (1), reducing the power of air that goes to the swirl chamber (27) and then the vortex inside the swirl chamber (27), wherein the orifice closure device (35) in the center of the roof above the swirl chamber (27) is used to seal the heated air inside the greenhouse during cold nights, wherein the plurality of pumps (49) comprises pumps (49) carrying various liquids from one place to another in and around the greenhouse, with each pump (49) having a rotary pump for a liquid and an electric motor for driving the pump (49), wherein the liquid is selected from a group consisting of antifreeze solution; cool clean, non-salty fresh water; hot clean, non-salty fresh water; and nutrient-rich water, wherein the plurality of pumps (49) are powered by the turbine (10) at the top of the greenhouse, wherein the network of piping systems (53) moves the various liquids from one place to another in and around the greenhouse, pumped by the plurality of pumps (49), wherein the solar heat collectors (48) comprise an array of corrugated solar absorbers circulating antifreeze fluid to the radiators (43) along interior walls of the interior of the greenhouse (55), wherein the array of corrugated solar absorbers use surface of the corrugated metal panels to transfer the heat from the Sun to the antifreeze solution running over it to result in heated antifreeze solution and capture the heated antifreeze solution and transfer it to the next solar heat collector in the plurality of the solar heat collectors (48), wherein the hydroponic system is configured to operate without soil using nutrient-rich water circulated through the storage tank for nutrient-rich water (56) by a plurality of pumps (49) powered by the turbine (10) to support year-round plant cultivation and growth inside the interior of the greenhouse (55), wherein the plurality of sails (39) suspended below the roof of the greenhouse and arranged to guide rising heated air from the interior of the greenhouse (55) into the interior greenhouse vanes (33), wherein the plant growth lighting system (54) provides supplemental grow lighting that is powered by the electricity generated by the electric wind turbine (10) to extend plant growing hours inside the greenhouse, and it is supplemental to the natural light from the Lexan windows (15) during the daytime, wherein the combined power-generation and plant-growing system simultaneously produces electricity and cultivates crops using only solar energy and water inputs, and wherein the combined power-generation and plant-growing system is particularly suitable for low-water areas, including areas undergoing desertification, and areas that are deserts.

In another embodiment of the greenhouse of the present invention, as disclosed herein, wherein the chutes (1) are dimensioned and the roof is oriented according to latitude-specific angles to maximize exposure to the Sun, wherein the latitude-specific angles are based upon the latitude of the location of the greenhouse on Earth, wherein the latitude is the angle at which the greenhouse is situated on the Earth away from the Equator.

In another embodiment of the greenhouse of the present invention, as disclosed herein, wherein the reflective film (22) comprises ultraviolet and infrared reflective, transparent Mylar film that reflects the ultraviolet and infrared light from the Sun up into the chutes (1) in the enclosure formed between the upper pane (19) and the lower pane (20) of the chutes (1), and the heat-absorbing material screen (21) comprises a removable cloth screen with adjustable absorption which is a high-temperature, removable cloth weave material that reduces loss of heat coming into the chutes (1) from the upper pane (19) by absorption from the Sun and to keep the heat within the chutes (1) of the greenhouse, wherein the heat-absorbing material screen (21) is attached on top of the reflective film (22), the reflective film (22) is attached on top of the lower pane (20) of the chutes (1) as viewed from the bottom of the roof of the greenhouse, and the upper pane (19), the lower pane (20), the heat-absorbing material screen (21), and the reflective film (22) in the chutes maximize energy capture from the Sun.

In another embodiment of the greenhouse of the present invention, as disclosed herein, wherein the cone (2) has a wide upper opening and a narrow lower opening as a right-side-up cone as a funnel for exhausting the vortex oriented upwards and is configured to reduce drag on the vortex compared to an inverted cone, and the cone (2) is supported and held upright by the stack (16), which is a cylindrical structure just above the turbine (10) situated inside the swirl chamber (27).

In another embodiment of the greenhouse of the present invention, as disclosed herein, wherein the plurality of misters (34) comprising misting nozzles and pipes comprise misters for the interior of the greenhouse (34a) that inject moisture formed by spraying a fine mist of water vapor into the heated air rising and pouring upwards from the interior of the greenhouse (55) through the interior greenhouse vents (29) to provide a saturated air environment to maximize plant growth inside the greenhouse (55) and to maintain the temperature inside the greenhouse by using the water vapor coming into the greenhouse by the misters for the interior of the greenhouse (34a) to cool down the heated air inside the interior of the greenhouse (55), and misters for the chutes (34b) that inject moisture formed by spraying a fine mist of heated water vapor into the heated air rising and pouring upwards from the each of the chutes (1) towards the turbine (10) through the chute vents (28) to increase the heated air pressure of the heated air flowing in the swirl chamber (27) to striking the blades of the turbine (43) forming a vortex to engulf and rotate the blades of the turbine (43) to enhance vortex strength and produce electricity more efficiently, wherein the misters for the interior of the greenhouse (34a) have switchable valves regulating the pipes of the misters for the interior of the greenhouse (34a) and the misters for the interior of the greenhouse (34a) are turned on by the switchable valves that open when the heat in the interior of the greenhouse (55) hits above a first minimum set temperature, and wherein the misters for the chutes (34b) have switchable valves regulating the pipes of the misters for the chutes (34b) and the misters for the chutes (34b) are turned on by the switchable valves that open when the heat in the chutes (1) hits below a second minimum set temperature.

In another embodiment of the greenhouse of the present invention, as disclosed herein, wherein the plurality of pumps (49) comprises pumps (49) carrying various liquids from one place to another in and around the greenhouse, with each pump (49) having a rotary pump for a liquid and an electric motor for driving the pump (49), wherein the liquid is selected from a group consisting of antifreeze solution; cool clean, non-salty fresh water; hot clean, non-salty fresh water; and nutrient-rich water, and wherein the plurality of pumps (49) are selected from a group of pumps (49) including pumps (49) to push the antifreeze solution from the solar heat collectors (48) to one of the at least one storage tank for antifreeze solution (50) and then on to the plurality of radiators (46) in the greenhouse for heating the interior of the greenhouse (55); pumps (49) which are hydroponic pumps to push and pump cool clean, non-salty water from the storage tank for clean, non-salty fresh water (51) into the greenhouse via misters for the interior of the greenhouse (34a) located inside the interior of the greenhouse (55); pumps (49) which are hydroponic pumps to push and pump heated clean, non-salty water into the greenhouse via misters for the chutes (34b) located inside the chutes (1); and pumps (49) to push nutrient-rich water from the storage tanks for nutrient-rich water (56) to the interior of the greenhouse (55) for the hydroponic cultivation of plants, wherein the plurality of pumps (49) are powered by the turbine (10) at the top of the greenhouse.

In another embodiment of the greenhouse of the present invention as disclosed herein, wherein the network of piping systems (53) moves the various liquids from one place to another in and around the greenhouse, pumped by the plurality of pumps (49), and wherein the network of piping systems (53) comprises piping systems (53) selected from a group consisting of piping systems (53) that connects all of the solar heat collectors (48) to the storage tank for antifreeze solution (50) and supplies heated antifreeze solution to the plurality of radiators (46) encircling the lower walls of the interior of the greenhouse (55) and provides heat by circulating heated antifreeze solution through the solar heat collectors (48) to the storage tank for antifreeze (50); piping systems (53) that connect the storage tank for cool clean, non-salty fresh water (51) to the interior of the greenhouse (55) to supply the clean, non-salty fresh water to the plurality of misters (34) throughout the greenhouse; piping systems (53) that connect the large tank inside the storage tank for antifreeze solution (50) which is supplied with the clean, non-salty fresh water from the storage tank for clean, non-salty fresh water (51) to be heated by heat exchange inside the storage tank for antifreeze solution (50) and the heated water is then supplied to the misters for the chutes (34b) in the chutes (1); piping systems (53) that connect the storage tanks for nutrient-rich water (56) to the interior of the greenhouse (55) for the hydroponic cultivation of plants.

In another embodiment of the system of the present invention as disclosed herein, wherein the storage tank for antifreeze solution (50) is a composite of two tanks, a large insulated tank that has a large copper coil inside it wrapped around a second, smaller tank that holds the antifreeze solution with a capacity to fill the plurality of radiators (46) encircling the lower walls of the interior of the greenhouse (55), the plurality of solar heat collectors (48), and the network of piping systems (53) connecting the solar heat collectors (48) located outside the greenhouse to the plurality of radiators (46) inside the interior of the greenhouse (55), wherein the large copper coil wrapped around the smaller tank inside the large insulated tank within the storage tank for antifreeze solution (50) acts as a heat exchanger, while the larger tank acts as an antifreeze-buffered thermal storage tank for supplying heated water to the misters for the chutes (34b) supplying heated water in the chutes (1), and wherein the antifreeze solution is pumped back through the small tank within the storage tank for antifreeze solution (50) on to the field of an array of solar heat collectors (52) until the small tank reaches a set temperature to maintain the cycle of antifreeze heating.

In another embodiment of the system of the present invention as disclosed herein, wherein the plurality of dampers and actuators (24) are operatively coupled to the chutes (1) and swirl chamber (27), said plurality of dampers being automatically controlled by thermostats (41) and anemometers (40) to regulate airflow into and out of the greenhouse, and wherein the heated airflow circulation within the greenhouse moderates temperature and prevents humidity buildup.

In an embodiment of the present invention, it provides a method of generating electricity while cultivating plants within a solar vortex greenhouse, the method comprising the steps of: orienting a clamshell-shaped roof comprising a plurality of multi-paned, paired trapezoidal chutes (1) around a central chamber toward the Equator at a slope angle based on the latitude of installation of the greenhouse and transmitting solar radiation through the chutes (1); admitting ambient air into the chutes (1) through a lower intake opening of the chutes (4) at each of the chutes (1); heating the ambient air within the chutes (1) using solar radiation from the Sun transmitted through transparent covers and reflected by interior coatings inside the chutes (1) to produce heated air and humidifying the heated air within the enclosure to produce heated and humidified air; accelerating the heated and humidified air upward through the narrowing geometry of the chutes (1); directing the heated and humidified air into a swirl chamber (27) via a plurality of vanes to impart rotational motion to the heated air, thereby forming a vortex; using a plurality of sails (39) suspended below the roof of the greenhouse in the interior of the greenhouse (55) to guide rising heated air from the interior of the greenhouse (55) toward the swirl chamber (27), thereby supplementing the vortex airflow; spinning an electric wind turbine (10) with the vortex airflow to generate electricity; exhausting the vortex upward through a cone (2) and stack (16) assembly; misting the heated air within the chutes (1) with water droplets and water vapor to increase air pressure and enhance vortex strength; opening and closing a plurality of dampers and at least one orifice door system in response to signals from a plurality of thermostats (40), a plurality of anemometers (41), and a plurality of actuators (24) with a photocell sensor on top of each of the actuators, automatically to maintain plant-sustaining environmental conditions; storing electricity generated by the electric wind turbine (10) in grid-scale batteries, which are equipment within a plurality of electrical equipment (13), and distributing excess power to external loads; cultivating hydroponic plants on an interior gravel base (14), with nutrient solutions circulated by pumps powered by electricity generated by the electric wind turbine (10); and regulating temperature and humidity inside the greenhouse for cultivating plants in a climate-controlled interior of the greenhouse (55), wherein the chutes (1) altogether assembled into a clamshell configuration, each of the chutes (1) including transparent outer covers on top and bottom of the chutes (1) as top and bottom layers referred to as panes, a reflective film (22), and a heat-absorbing material screen (21) in between the top and bottom outer covers as intermediate layers, configured to heat air inside the cavity formed between the transparent outer covers on top and bottom of the chutes (1) by exposure to the Sun and direct the heated air upward inside the greenhouse, wherein the greenhouse further comprises a plurality of beams supporting the top and bottom of the chutes (1) and forming the sides of the chutes (1), with the top rails or joists of the beams (3) holding the sides and edges of the chutes (1) forming the roof of the greenhouse, by standard joists for roof support, a plurality of concrete piers (5) as strong footings supporting the greenhouse base, a plurality of columns (25), and keeping the greenhouse structure solid under extreme wind conditions, the plurality of vanes configured to impart a rotational direction to the heated air, including upper vanes referred to as chute vanes (32), and lower vanes referred to as interior greenhouse vanes (33), arranged around the swirl chamber (27) at the top of the greenhouse, configured to guide the heated air into a vortex of pressurized heated airflow referred to as the vortex, a plurality of vents, including upper vents referred to as chute vents (28), and lower vents referred to as interior greenhouse vents (29), to pour the heated air into the swirl chamber (27), the electric wind turbine (10) with blades of the turbine (43) positioned within the swirl chamber (27) rotated by the vortex, and operable to convert kinetic energy of the vortex formed by the heated air pouring into the swirl chamber (27) from the chutes (1) and the interior of the greenhouse (55) into electricity, the cone (2) and stack (16) assembly at the top of the greenhouse, positioned above the swirl chamber (27) to stabilize and vertically guide the vortex upwards to exhaust out of an orifice located above the swirl chamber (27) at the top of the greenhouse, a plurality of shutters that form an air-cooling system, including electric ventilation shutters (11) and emergency pressure relief shutters (42), the plurality of dampers including an operable damper door (23), upper dampers for chute vanes (32) referred to as chute dampers (30), and lower dampers for interior greenhouse vanes (33) referred to as interior greenhouse dampers (31), the at least one orifice door system referred to as an orifice closure device (35), a plurality of misters (34), a plurality of radiators (46), a catwalk (6) around the top of the greenhouse with a ladder (7) to reach the catwalk (6) for easy access to the interior of the swirl chamber (27) and vortex-producing equipment, an equipment, airlock control, and maintenance building referred to as equipment building (8) with the plurality of electrical equipment (13) inside it, a central mono pole support for the roof of the greenhouse, referred to as a central support pole (12), a plurality of sails (39) positioned within the central chamber to impart rotational motion to the heated air rising from the interior of the greenhouse (55) and guiding the heated air up to the interior greenhouse vanes (33), at least one structural ring (38) consisting of an upper structural ring (38a) and a lower structural ring (38b), a perforated metal panel (44) at the top of the stack (16) that allows the heated air to flow from the emergency pressure relief shutters (42), along the outside of the cone (2), and then out of the perforated metal panel (44) at the top of the stack (16), an attachment (47) of the plurality of sails (39) to the plurality of columns (25) at each of the corners of the greenhouse, a plurality of solar heat collectors (48), a plurality of pumps (49), at least one storage tank for antifreeze solution (50), at least one storage tank for clean, non-salty fresh water (51), at least one storage tank for nutrient-rich water (56), a field of an array of solar heat collectors (52), a network of piping systems (53), a plurality of diagonal braces (45) attached to the angles of the sides of the greenhouse, to help keep a plurality of columns (25) vertical and sides square, and the climate-controlled interior of the greenhouse (55) configured for hydroponic cultivation of plants beneath the chutes (1) forming the roof of the greenhouse, with the gravel base (14) floor of the greenhouse and Lexan panels referred to as Lexan windows (15) for allowing natural light to enter along all the sides of the greenhouse into the interior of the greenhouse (55) for the growth of the plants, wherein the plurality of multi-paned, paired trapezoidal chutes (1) comprises triangular modules arranged in a substantially circular array, and each of the chutes (1) is wider at the bottom than at the top to accelerate airflow upward inside the chutes (1), and is at least double-paned, meaning it has two panes, wherein the clamshell-shaped geometry of the roof of the greenhouse formed by the plurality of multi-paned, paired trapezoidal chutes (1) arranged radially around a central axis comprises a convex outer surface and a concave inner surface configured to focus solar radiation and guide airflow toward the swirl chamber (27), wherein the clamshell-shaped geometry of the roof of the greenhouse induces spiral flow vectors converging toward a central axis, wherein the heated and humidified air produced by injecting heated water vapor into the rising air in the chutes (1) leads to an increase in enthalpy and buoyancy of the air column in the vortex, wherein the plurality of beams has each of the beams as a standard-type beam with webbing in its center and top rails or joists of the beams (3) with ends that are bolted to a central structural ring (38) that surrounds the turbine (10) at the top of the roof, and bottom rails or joists of the beams (18) with ends that are bolted to the plurality of columns (25) that form the edges of the multiple sides of the building, wherein the beams are comprised of the top rails or joists of the beams (3), the bottom rails or joists of the beams (18), a webbing made of metal in the center of the beams (9) for Lexan sheathing that supports the top rails or joists of the beams (3), the bottom rails or joists of the beams (18), sheets of Lexan plastic panels (17) that seal the central webbing area encasing both sides of the webbing inside the beams, wherein the plurality of beams is structured such that in the Northern Hemisphere, the two centermost, longest beams face directly South to match the Sun's highest location in the sky in that hemisphere such the Sun shines directly inside them during the longest day of the summer, and in the Southern Hemisphere, the two centermost, longest beams face directly North to match the Sun's highest location in the sky in that hemisphere such the Sun shines directly inside them during the longest day of the Winter, while the remaining beams are mounted at angles consecutively higher on both the West and East sides such that the final beams at the end of each side are more elevated than the centermost chutes (1) forming the roof of the greenhouse, wherein the central support pole (12) placement inside the greenhouse is structured such that it lays the plurality of beams and the plurality of multi-paned, paired trapezoidal chutes (1) back to internally transmit more Solar energy throughout the year when the position of the Sun varies in height, wherein the transparent outer covers in the chutes (1) provide shape to the roof of the greenhouse for visible light capture, and heating of air in the greenhouse, and the two panes heat the ambient air inside the double-paned chutes (1) to generate pressurized heated airflow, the ambient air is the air that entered from a lower intake opening of the chutes (4) at each of the chutes (1), wherein the two panes in the double-paned chutes (1) include a top plastic, UV-resistant, and transparent sheet covering for the roof of the greenhouse, referred to as upper pane (19) of the chutes (1), and a bottom plastic and transparent sheet covering of the roof for the greenhouse, referred to as lower pane (20) of the chutes (1), wherein the upper pane (19) of the chutes (1) covers the clamshell configuration of the greenhouse in its entirety as the top pane of the roof of the greenhouse, wherein the plurality of multi-paned, paired trapezoidal chutes (1) forming the roof of the greenhouse has each of the double-paned chutes (1) between the plurality of beams with a trapezoidal passage, the lower intake opening of the chutes (4), and one of the chute vanes (32) at the top of each of the chutes (1), wherein the trapezoidal passage which forms an air chamber (26) by the sheets of Lexan plastic panels (17) that seal with the use of silicon caulk the central webbing area encasing both sides of the webbing inside the beams, the upper pane (19) of the chutes (1) and the lower pane (20) of the chutes (1) forming the roof of the greenhouse and the chute dampers (30) sealing the top of the chutes (1), and operable damper door (23) sealing the bottom of the chutes (1) and altogether the air chamber (26) so formed is completely sealed to move the heated air inside the chutes (1), wherein the chutes (1), altogether assembled into a clamshell configuration, are oriented at an angle substantially perpendicular to incoming solar rays from the Sun at the latitude of installation of the greenhouse, meaning the latitude where the greenhouse is located on the Earth, wherein the chute vents (28) pour the heated air coming from the chutes (1) into the chute vanes (32) that surround the swirl chamber (27), and the interior greenhouse vents (29) pour the heated air coming from the interior of the greenhouse (55) into the interior greenhouse vanes (33) that surround the swirl chamber (27), wherein the swirl chamber (27) has the chute vents (28), the chute vanes (32), the interior greenhouse vents (29), and the interior greenhouse vanes (33) are angled counterclockwise when the greenhouse is located in the Northern Hemisphere of the Earth and clockwise when the greenhouse is located in the Southern Hemisphere of the Earth to take advantage of the Coriolis forces which tend to spin a vortex in a counterclockwise direction in the Northern Hemisphere and spin a vortex in a counterclockwise direction in the Southern Hemisphere, wherein the vortex is produced from the heated air partly produced in the chutes (1) by heating ambient air entering the chutes (1) from lower intake openings (4) for the chutes (1) are formulated to resist ultraviolet light from the Sun, so they do not break down from exposure to the Sun, wherein the chutes (1) produce an extra capacity hot air pressure system that rotates the blades of the turbine (43) that drives electrical energy production by the turbine (10) at the top of the clamshell, wherein the stack (16) and cone (2) assembly allow the vortex to pass directly in the center of the turbine (10) oriented towards the top of the greenhouse, protects against drag, keeps the vortex vertical, and protects it from side winds, wherein the electrical equipment (13) inside the equipment building (8) thermostatically controls the plurality of shutters, the plurality of dampers, and the orifice door system to regulate airflow and temperature in the greenhouse, wherein the electric wind turbine (10) is positioned below the cone (2) in an assembly that allows the vortex to exhaust out of the greenhouse as its rotational airflow is converted into electricity by rotating the blades of the turbine (43), wherein the turbine (10) generates electricity which is stored in grid-scale batteries, which are part of the plurality of electrical equipment (13) inside the equipment building (8), and powers both greenhouse operations and external systems, wherein the emergency pressure relief shutters (42) are positioned adjacent to but outside the swirl chamber (27), configured to vent excess air pressure in response to the turbine (10) over-revving, causing electrical problems, or destructive wind conditions, thereby protecting the greenhouse and maintaining plant-sustaining temperatures inside the greenhouse, wherein the plurality of columns (25) supports the corners of each of the sides of the greenhouse and the bottom edges of the beams (3), wherein the orifice closure device (35) is positioned above the swirl chamber to shut off upward airflow in response to environmental conditions selectively, wherein the plurality of dampers has a spring and latch system (37) for each of the dampers to seal the dampers, the spring and latch system (37) comprising a snap latch (37a), an electric striker plate (37b), and a spring-loaded adjustable hinge (37c), and the spring and latch system is configured to regulate the opening and closing of each of the dampers based on and in response to air pressure and temperature actuated by signals from the plurality of actuators (24), the plurality of anemometers (40), and the plurality of thermostats (41), wherein the plurality of thermostats (41) is calibrated to maintain interior temperatures between approximately 45° F. and 85° F. for optimal plant growth, wherein the plurality of anemometers (40) is situated at the top of the greenhouse at the handrails of the catwalk (6) and sends a signal to close the orifice closure device (35) if the wind outside is above a destructive speed that makes the vortex dangerous for buildings around the greenhouse, wherein the sides undergo structural expansion and contraction due to temperature changes, as part of the structure is heated by the Sun while another part remains in shade, wherein the central support pole (12) has four angular supports to hold up the structural ring (38), wherein the central support pole (12) supports the internal structure inside the greenhouse, including the interior greenhouse vanes (33), the turbine (10), the cone (2), and the stack (16) to hold them in place with angled supports holding a lower structural ring (38b), wherein the upper structural ring (38a) is attached to the catwalk (6) and is situated just above the blades of the turbine (43), and the orifice closure device (35) is supported and encircled by the upper structural ring (38a), wherein the plurality of sails (39) comprises transparent sheets arranged in a corkscrew configuration and encircle the interior of the greenhouse (55) to impart rotational motion to the heated air from the interior of the greenhouse (55), wherein the plurality of sails (39) is shaped into long trough-shaped structures that capture the rising heated air and nudge it into a slow-moving vortex that then rises into the interior greenhouse vanes (33) to spin the interior air more quickly, until that air from the interior of the greenhouse (55) is sucked into the faster-moving air from the chutes (1) flowing to the swirl chamber (27) and this additional internal air from the interior of the greenhouse (55) supplements the faster-moving air from the chutes (1), wherein the greenhouse with the clamshell-shaped roof maintains the temperature inside the greenhouse for the plants growing in the interior of the greenhouse (55), and for the heated air inside the greenhouse, in part by sending the heated air up and out of the greenhouse to exhaust out of the greenhouse via the cone (2), wherein the greenhouse with the clamshell-shaped roof maximizes the exposure to the Sun without burning the plants growing inside the interior of the greenhouse (55), via various mechanisms including through absorption of the Sun's heat onto the gravel base (14) floor of the greenhouse, having large shuttered openings via the electric ventilation shutters (11) to allow in ambient air to the greenhouse, wherein the plurality of anemometers (40), which are wind speed sensors located on top of the greenhouse, the plurality of thermostats (41), which are temperature sensors located at different locations on top of and inside the greenhouse, and the plurality of actuators (24) with photocell sensors, regulate opening and closing of the plurality of dampers including the operable damper door (23), the chute dampers (30), and the interior greenhouse dampers (31), and opening and closing of the plurality of shutters including the electric ventilation shutters (11) and the emergency pressure relief shutters (42), wherein the plurality of shutters, including the electric ventilation shutters (11) and the emergency pressure relief shutters (42), are remote-controlled and powered interconnected for greenhouse ventilation for air cooling and pressure relief, wherein the equipment building (8) is sealed with a pressure seal damper to maintain an airlock when the temperature outside is low, as sensed by the plurality of thermostats (41), or when the winds are high, as sensed by the plurality of anemometers (40) and holds the electrical equipment (13) including a heavy-duty, high-capacity battery and an electrical inverter like that used for the electrical grid to take the alternating current electricity from the turbine (10) and turn that alternating current electricity into the direct current electricity used by the battery, wherein the ladder (7) is located above the equipment building (8) that rises to the catwalk (6) that provides easy access to the interior of the vortex-producing equipment inside the swirl chamber (27), wherein the electric ventilation shutters (11) located along the sides of the greenhouse are thermostatically controlled by signals from the plurality of thermostats (41) to open when the temperature in the interior of the greenhouse (55) is above a set temperature and close when the temperature in the interior of the greenhouse (55) is below the set temperature, wherein the electric ventilation shutters (11), the emergency pressure relief shutters (42), the orifice closure device (35), the stack (16) and cone (2) assembly, the lower intake openings (4), any other inlets of air into the greenhouse, and any other exhaust vents of air to the outside from inside the greenhouse are fitted with fine mesh screening to keep out dust and parasites that can affect the plants growing inside the greenhouse, wherein using the plurality of dampers are specially angled to control the plurality of vents to self-adjust their pressure output such that air from all of the vents is maximized and equalized at the same time to avoid a situation where the air that goes into the swirl chamber (27) from those vents with maximum airflow end up leaking into the low airflow vents which are vents that do not produce much heated airflow upward, and the low airflow vents siphon off the air from the surrounding chutes (1), reducing the power of air that goes to the swirl chamber (27) and then the vortex inside the swirl chamber (27), wherein the orifice closure device (35) in the center of the roof above the swirl chamber (27) is used to seal the heated air inside the greenhouse during cold nights, wherein the plurality of pumps (49) comprises pumps (49) carrying various liquids from one place to another in and around the greenhouse, with each pump (49) having a rotary pump for a liquid and an electric motor for driving the pump (49), wherein the liquid is selected from a group consisting of antifreeze solution; cool clean, non-salty fresh water; hot clean, non-salty fresh water; and nutrient-rich water, wherein the plurality of pumps (49) are powered by the turbine (10) at the top of the greenhouse, wherein the network of piping systems (53) moves the various liquids from one place to another in and around the greenhouse, pumped by the plurality of pumps (49), wherein the interior of the greenhouse (55) further comprises a plurality of hydroponic systems (57), and a plant growth lighting system (54) to support year-round plant cultivation and growth, wherein the solar heat collectors (48) are an array of simple black corrugated metal panels that use surface of the corrugated metal panels to transfer the heat from the Sun to the antifreeze solution running over it to result in heated antifreeze solution and capture the heated antifreeze solution and transfer it to the next solar heat collector in the plurality of the solar heat collectors (48).

In another embodiment of the greenhouse of the present invention, as disclosed herein, wherein the chutes (1) are dimensioned and the roof is oriented according to latitude-specific angles to maximize exposure to the Sun, wherein the latitude-specific angles are based upon the latitude of the location of the greenhouse on Earth, wherein the latitude is the angle at which the greenhouse is situated on the Earth away from the Equator.

In another embodiment of the greenhouse of the present invention, as disclosed herein, wherein the reflective film (22) comprises ultraviolet and infrared reflective, transparent Mylar film that reflects the ultraviolet and infrared light from the Sun up into the chutes (1) in the enclosure formed between the upper pane (19) and the lower pane (20) of the chutes (1), and the heat-absorbing material screen (21) comprises a removable cloth screen with adjustable absorption which is a high-temperature, removable cloth weave material that reduces loss of heat coming into the chutes (1) from the upper pane (19) by absorption from the Sun and to keep the heat within the chutes (1) of the greenhouse, wherein the heat-absorbing material screen (21) is attached on top of the reflective film (22), the reflective film (22) is attached on top of the lower pane (20) of the chutes (1) as viewed from the bottom of the roof of the greenhouse, and the upper pane (19), the lower pane (20), the heat-absorbing material screen (21), and the reflective film (22) in the chutes maximize energy capture from the Sun.

In another embodiment of the greenhouse of the present invention, as disclosed herein, wherein the cone (2) has a wide upper opening and a narrow lower opening as a right-side-up cone as a funnel for exhausting the vortex oriented upwards and is configured to reduce drag on the vortex compared to an inverted cone, and the cone (2) is supported and held upright by the stack (16), which is a cylindrical structure just above the turbine (10) situated inside the swirl chamber (27).

In another embodiment of the greenhouse of the present invention, as disclosed herein, wherein the plurality of misters (34) comprising misting nozzles and pipes comprise misters for the interior of the greenhouse (34a) that inject moisture formed by spraying a fine mist of water vapor into the heated air rising and pouring upwards from the interior of the greenhouse (55) through the interior greenhouse vents (29) to provide a saturated air environment to maximize plant growth inside the greenhouse (55) and to maintain the temperature inside the greenhouse by using the water vapor coming into the greenhouse by the misters for the interior of the greenhouse (34a) to cool down the heated air inside the interior of the greenhouse (55), and misters for the chutes (34b) that inject moisture formed by spraying a fine mist of heated water vapor into the heated air rising and pouring upwards from the each of the chutes (1) towards the turbine (10) through the chute vents (28) to increase the heated air pressure of the heated air flowing in the swirl chamber (27) to striking the blades of the turbine (43) forming a vortex to engulf and rotate the blades of the turbine (43) to enhance vortex strength and produce electricity more efficiently, wherein the misters for the interior of the greenhouse (34a) have switchable valves regulating the pipes of the misters for the interior of the greenhouse (34a) and the misters for the interior of the greenhouse (34a) are turned on by the switchable valves that open when the heat in the interior of the greenhouse (55) hits above a first minimum set temperature, and wherein the misters for the chutes (34b) have switchable valves regulating the pipes of the misters for the chutes (34b) and the misters for the chutes (34b) are turned on by the switchable valves that open when the heat in the chutes (1) hits below a second minimum set temperature, and wherein the storage tank for antifreeze solution (50) is a composite of two tanks, a large insulated tank that has a large copper coil inside it wrapped around a second, smaller tank that holds the antifreeze solution with a capacity to fill the plurality of radiators (46) encircling the lower walls of the interior of the greenhouse (55), the plurality of solar heat collectors (48), and the network of piping systems (53) connecting the solar heat collectors (48) located outside the greenhouse to the plurality of radiators (46) inside the interior of the greenhouse (55), wherein the large copper coil wrapped around the smaller tank inside the large insulated tank within the storage tank for antifreeze solution (50) acts as a heat exchanger, while the larger tank acts as an antifreeze-buffered thermal storage tank for supplying heated water to the misters for the chutes (34b) supplying heated water in the chutes (1), and wherein the antifreeze solution is pumped back through the small tank within the storage tank for antifreeze solution (50) on to the field of an array of solar heat collectors (52) until the small tank reaches a set temperature to maintain the cycle of antifreeze heating.

In another embodiment of the greenhouse of the present invention as disclosed herein, wherein the plurality of pumps (49) comprises pumps (49) carrying various liquids from one place to another in and around the greenhouse, with each pump (49) having a rotary pump for a liquid and an electric motor for driving the pump (49), wherein the liquid is selected from a group consisting of antifreeze solution; cool clean, non-salty fresh water; hot clean, non-salty fresh water; and nutrient-rich water, and wherein the plurality of pumps (49) are selected from a group of pumps (49) including pumps (49) to push the antifreeze solution from the solar heat collectors (48) to one of the at least one storage tank for antifreeze solution (50) and then on to the plurality of radiators (46) in the greenhouse for heating the interior of the greenhouse (55); pumps (49) which are hydroponic pumps to push and pump cool clean, non-salty water from the storage tank for clean, non-salty fresh water (51) into the greenhouse via misters for the interior of the greenhouse (34a) located inside the interior of the greenhouse (55); pumps (49) which are hydroponic pumps to push and pump heated clean, non-salty water into the greenhouse via misters for the chutes (34b) located inside the chutes (1); and pumps (49) to push nutrient-rich water from the storage tanks for nutrient-rich water (56) to the interior of the greenhouse (55) for the hydroponic cultivation of plants, wherein the plurality of pumps (49) are powered by the turbine (10) at the top of the greenhouse.

In another embodiment of the greenhouse of the present invention as disclosed herein, wherein the network of piping systems (53) moves the various liquids from one place to another in and around the greenhouse, pumped by the plurality of pumps (49), and wherein the network of piping systems (53) comprises piping systems (53) selected from a group consisting of piping systems (53) that connects all of the solar heat collectors (48) to the storage tank for antifreeze solution (50) and supplies heated antifreeze solution to the plurality of radiators (46) encircling the lower walls of the interior of the greenhouse (55) and provides heat by circulating heated antifreeze solution through the solar heat collectors (48) to the storage tank for antifreeze (50); piping systems (53) that connect the storage tank for cool clean, non-salty fresh water (51) to the interior of the greenhouse (55) to supply the clean, non-salty fresh water to the plurality of misters (34) throughout the greenhouse; piping systems (53) that connect the large tank inside the storage tank for antifreeze solution (50) which is supplied with the clean, non-salty fresh water from the storage tank for clean, non-salty fresh water (51) to be heated by heat exchange inside the storage tank for antifreeze solution (50) and the heated water is then supplied to the misters for the chutes (34b) in the chutes (1); piping systems (53) that connect the storage tanks for nutrient-rich water (56) to the interior of the greenhouse (55) for the hydroponic cultivation of plants.

In another embodiment of the greenhouse of the present invention, as disclosed herein, wherein the plurality of dampers and actuators (24) are operatively coupled to the chutes (1) and swirl chamber (27), said plurality of dampers being automatically controlled by thermostats (41) and anemometers (40) to regulate airflow into and out of the greenhouse.

In some embodiments of the present invention, as disclosed herein, each chute is angled relative to geographic latitude such that its surface is substantially perpendicular to solar incidence during midday

In some embodiments of the present invention, as disclosed herein, the heat-absorbing intermediate layer comprises a black open-weave shade cloth configured to absorb between 10% and 90% of incident solar radiation.

In some embodiments of the present invention, as disclosed herein, further comprising a modular frame supporting the chute assemblies, the modular frame being transportable and configurable for phased construction, wherein the structure is modular and prefabricated, with numbered beams and chutes for rapid assembly.

In some embodiments of the present invention, as disclosed herein, at least eighteen chute assemblies are arranged to form a substantially circular array.

In some embodiments of the present invention, as disclosed herein, at least twenty-four chute assemblies are arranged to form a substantially circular array.

In some embodiments of the present invention, as disclosed herein, the chute assemblies are supported by modular lightweight frames.

In some embodiments of the present invention, as disclosed herein, the modular lightweight frames are configured for phased construction and transportable installation.

In some embodiments of the present invention, as disclosed herein, motorized sliding doors are positioned at the swirl chamber outlet to regulate airflow.

In some embodiments of the present invention, as disclosed herein, pressure relief vents configured to discharge excess airflow when the sliding doors are partially closed.

In some embodiments of the present invention, as disclosed herein, wherein the beams include steel joists with Lexan side panels sealed with removable silicone caulk.

In some embodiments of the present invention, as disclosed herein, wherein the mist injection nozzles are positioned in an upper one-third portion of the length of each chute to prevent moisture retention within the chute.

In some embodiments of the present invention, as disclosed herein, wherein the antifreeze tank comprises a coil-based heat exchanger coupled to a separate water reservoir that supplies heated water to the misting nozzles.

In some embodiments of the present invention, as disclosed herein, further comprising motorized sliding doors at the orifice of the funnel exhaust, the doors configured to regulate ventilation and vortex strength, and further comprising pressure relief vents disposed adjacent to the orifice, the vents configured to open when the sliding doors are closed to maintain airflow through the funnel.

In some embodiments of the present invention, as disclosed herein, wherein each chute is inclined at an angle corresponding to a latitude-dependent orientation to maximize solar incidence and minimize reflectivity.

In some embodiments of the present invention, as disclosed herein, wherein the sails are curved in a corkscrew-like arrangement to impart rotational motion to rising heated air into a slower vortex from the reservoir of heated and moistened air from the interior of the greenhouse to supplement the more robust and rigorous vortex from the chutes in the daytime, fueled by direct heat from the Sun in the chutes.

In some embodiments of the present invention, as disclosed herein, wherein the funnel exhaust has an upright geometry with a wide upper orifice that reduces drag on the vortex airflow compared to a narrow chimney outlet.

In some embodiments of the present invention, as disclosed herein, wherein the misting system increases the enthalpy and buoyancy of the rising air column to enhance vortex sustainability.

In an embodiment of the present invention, it provides a thermal energy augmentation system for a solar vortex greenhouse, comprising: a misting system comprising nozzles positioned within chute assemblies; a hot water supply configured to deliver heated vapor to the misting system; and a thermal storage tank containing an antifreeze solution. In another embodiment of the present invention, providing the thermal energy augmentation system as disclosed herein, further comprising a heat exchanger coil immersed in the antifreeze solution, the coil configured to heat water supplied to the misting system. In another embodiment of the present invention providing the thermal energy augmentation system as disclosed herein, wherein the misting system injects vapor into an upper portion of the chute assemblies to entrain moisture into rising airflow. In another embodiment of the present invention providing the thermal energy augmentation system as disclosed herein, wherein the antifreeze solution is heated by solar gain.

In another embodiment of the present invention providing the thermal energy augmentation system as disclosed herein, wherein the misting system is further configured to provide irrigation to crops grown within the greenhouse enclosure.

In an embodiment of the present invention, it provides a prefabricated solar greenhouse kit comprising: a plurality of factory-manufactured beams, chutes, dampers, and cone components, each labeled with identifiers for assembly; standardized shipping-container packaging of the prefabricated parts; assembly interfaces including removable silicone seals for replacing panes, bolted joints for beams, and pre-formed footings for vertical supports; wherein, when assembled, the greenhouse forms a clamshell-shaped structure configured to generate a solar-induced vortex airflow that drives a turbine; and wherein said kit is adapted for construction by semi-skilled labor on site, thereby enabling rapid erection of a power-producing greenhouse structure. In another embodiment of the present invention providing the prefabricated solar greenhouse kit, as disclosed herein, wherein the prefabricated beams include steel joists with Lexan side panels sealed with removable silicone caulk. In another embodiment of the present invention providing the prefabricated solar greenhouse kit as disclosed herein, wherein the prefabricated kit includes numbered beam (3a through 3l) and chute pairs (1a through 1l) sized according to a latitude-based slope angle. In another embodiment of the present invention providing the prefabricated solar greenhouse kit, as disclosed herein, wherein the footings comprise precast reinforced concrete piers configured to resist extreme wind loads. In another embodiment of the present invention providing the prefabricated solar greenhouse kit, as disclosed herein, wherein the prefabricated parts are configured to be shipped in standard shipping containers and assembled on site using bolted joints.

In an embodiment of the present invention, it provides a computer-implemented method for controlling airflow and climate in a solar vortex greenhouse, the method comprising: receiving input signals from one or more sensors including anemometers measuring exterior wind speed, thermostats measuring interior and exterior temperature, and photocells measuring incident sunlight; processing said signals with a control system comprising a processor and memory storing executable instructions; generating control outputs to actuators coupled to dampers at chute inlets and outlets, orifice closure doors, and ventilation shutters; adjusting the position of said dampers, doors, and shutters to regulate vortex airflow and maintain interior temperature within a predetermined range; and transmitting control signals to water pumps and mister nozzles to selectively introduce moisture into heated airflow based on said input signals. In another embodiment of the present invention providing the computer-implemented method as disclosed herein, wherein when the anemometer detects exterior winds exceeding a threshold speed, the processor commands the orifice doors and chute dampers to close, thereby suppressing the vortex. In another embodiment of the present invention providing the computer-implemented method as disclosed herein, wherein when the thermostat detects interior temperature below a minimum threshold, the processor closes all dampers and shutters to retain heat inside the greenhouse. In another embodiment of the present invention providing the computer-implemented method as disclosed herein, wherein when the photocell detects low sunlight intensity, the processor signals supplemental grow lighting systems to activate. In another embodiment of the present invention providing the computer-implemented method as disclosed herein, wherein actuator control is achieved using spring-loaded hinges, electronic striker plates, and latching mechanisms that respond to said processor outputs. In another embodiment of the present invention providing the computer-implemented method as disclosed herein, wherein the control system comprises a two-stage thermostat that activates radiators when the interior temperature drops below 45° F. and deactivates the radiators when the temperature rises above 85° F.

In an embodiment of the present invention, it provides a thermal moisture injection system for a solar greenhouse comprising: a plurality of misting nozzles disposed in an upper third portion of each chute of a clamshell-shaped enclosure; a heat exchanger system comprising a storage tank containing antifreeze solution; a coil disposed within the antifreeze tank and fluidly coupled to a separate water reservoir; a circulation pump configured to deliver heated water from the reservoir to the misting nozzles; and a control system configured to operate the pump to supply heated mist on demand, wherein the misting nozzles inject hot water mist into airflow within the chutes to sustain moist-air vortex formation and extend energy generation beyond periods of direct solar heating. In another embodiment of the present invention providing the thermal moisture injection system as disclosed herein, wherein the antifreeze tank provides thermal regulation for both mist injection and greenhouse temperature stabilization. In another embodiment of the present invention providing the thermal moisture injection system as disclosed herein, wherein the misting nozzles are directed to inject hot mist into vane openings of the clamshell structure.

In an embodiment of the present invention, it provides a vortex airflow system for a clamshell-shaped solar greenhouse comprising: a plurality of vanes configured to direct heated air into a central swirl chamber; a funnel-shaped exhaust disposed above the swirl chamber, the funnel having a wide upper orifice that reduces drag on rising vortex airflow; a set of motorized sliding doors positioned at the orifice of the funnel, the doors configured to selectively regulate airflow; and at least one pressure relief vent fluidly coupled to the funnel and configured to open when the doors are closed, wherein the funnel exhaust, vanes, and door/vent system cooperate to stabilize vortex airflow and regulate greenhouse temperature while maintaining power generation efficiency. In another embodiment of the present invention providing the vortex airflow system as disclosed herein, wherein the motorized sliding doors are operated by a feedback controller responsive to internal temperature and vortex airflow velocity. In another embodiment of the present invention providing the vortex airflow system as disclosed herein, wherein the pressure relief vents are configured to exhaust airflow through perforations in an upper surface of the funnel.

Thus, the prior art adds to the field of the invention by its disclosed solar vortex clamshell greenhouse advancing the field by: designing and simulating triangular chute assemblies with transparent outer surfaces and black open-weave absorbers; demonstrating that right-side-up funnel exhausts significantly reduce drag compared to chimneys; developing a 1/10-acre test prototype design to validate airflow behavior and vortex initiation under controlled conditions; modeling solar incidence optimization, with chute angles tuned to site-specific latitudes for maximum efficiency; and proposing antifreeze-buffered misting augmentation for continuous operation beyond direct solar hours.

The invention will be further explained by the following Examples, which are intended to be purely exemplary of the invention and should not be considered as limiting the invention in any way.

### EXAMPLES

The following example provides exemplary embodiments of the implantable devices and sealing halo units of the present invention.

In this example of the present invention, embodiments of the present invention are exemplified in the form of sculptural models to test sub-structures of a basic design shape of the greenhouse roof as disclosed in the present invention that appears like an opened half of a clamshell that is placed face down. The basic components to conduct preliminary experiments to demonstrate the efficacy of elements of the design. The dimensions of the design specifications shown in the Examples below reflect the size of a small-scale model, approximately 1/10th of an acre in size. This experimental, or pilot, model proves that a much larger greenhouse structure with the functional design of the present invention will not only capture a maximum amount of heat from the Sun for its acreage, but due to its functional design, the present invention can direct that heat and moisture at the top of the structure into a vortex that will drive an internal wind turbine to generate electricity to run both the greenhouse and farm equipment for the entire farm. Additionally, the Examples demonstrate that the functional design of the present invention also forces the vortex it produces to exhaust out of the orifice at the top with sufficient velocity to rise and form a micro-climate that will increase precipitation over the Greenhouse and the farm area. This micro-climate, with more clouds, will also increase the albedo over the greenhouse and farm to decrease the overall stagnant heat that smothers farms and ranches, especially in near-to-full-desert conditions.

The present invention provides a combination of design elements that are functional in a manner to aid with the following applications:

Farmers can grow considerable tonnage of organic crops in the controlled environment of the greenhouse, which is already done in many countries. The greenhouse disclosed in the present invention is more efficient than many older designs since it uses far less water than many conventional greenhouses that do not have hydroponic systems used in the presently disclosed clamshell-shaped greenhouse. Additionally, in comparison to the more efficient traditional greenhouses, the greenhouse as disclosed herein does not require burning fossil fuels to power HVAC systems that are usually required in hi-tech commercial greenhouses. The greenhouse of the present invention maintains the temperature of the crops/plants and air inside the interior of the greenhouse by sending the warm air up and out of the greenhouse and it uses cool water that is brought inside and misted inside the greenhouse and circulated in the hydroponic systems by pumps that are powered by the turbine at the top of the clamshell.

The present invention via models and prototypes is tested to maximize the capture of solar heat as the Sun rises, reaches its zenith and falls each day. The functional design of the structure of the greenhouse of the present invention sets up the angle of the roof so it faces the Sun perpendicularly more than any other traditional greenhouse design, by being based upon its latitude location on the Earth. This specific angle is set up easily during construction, where the roof support beams are attached at specific angles in elevation onto the sides of the structure and/or the angle of site placement (on a hill, for instance) to match the latitude angle of the earth to the sun at that location. In FIG. 1 as disclosed herein, a structural design of the greenhouse as a photograph is provided showing that if it were located in the Northern Hemisphere, the two centermost, longest beams would face directly South so the Sun would shine directly inside them during the longest day of the summer. And, a solar clamshell greenhouse that is built in the Southern Hemisphere will have its centermost, longest beams facing due North to match the Sun's highest location in the sky in that hemisphere. The remaining beams are mounted at angles consecutively higher on both the west and east sides so that the final beams at the end of each side are 20 or more degrees more elevated than the centermost roof panes of the chutes. So, as the Sun rises in the East and falls in the West, its rays will shine consecutively directly into the side panes on the East, then progress to the centermost panes during noontime and then onto the western panes as the day progresses until the western-most pane receives the final rays of the sun almost directly at the end of the day. Note that the panes in the examples and the panes of the chutes planned for future and ongoing experimentation in the greenhouse will be formulated to resist ultraviolet light from the sun, so they do not break down from solar exposure.

The present invention in the Examples is a scale model of 1/10th of an acre, but it is being scaled up to 20 acres in size given the strength of its functional design. Various parts of the structure of the disclosed greenhouse are being constructed to be pre-packaged as an “erector set” of pre-numbered pieces at the factory that are bolted together at the job site. They arrive at the job site via shipping containers to be erected by less-skilled workers after higher-skilled construction workers have done the preliminary grading, setting of footings for the vertical supports, water retention, solar still heating that supplies extra heating for cold weather, and wired up to the latest model of a commercial battery designed to be used in electric grid applications to capture the electricity that runs the greenhouse.

The use of commercial, “off-the-shelf” products is a key element of this greenhouse functional design of the present invention so that many of the substructures and the machinery to run the greenhouse can be purchased at reduced cost. This purchase strategy can include: remote-controlled, powered interconnected shutters for greenhouse ventilation and pressure-relief dampers, the electric wind turbine, the pumps and piping for circulating water, the heavy-duty, high-capacity battery and electrical inverter like that used for the electrical grid, the standard metal beams for roof support and chute construction, and the wind speed and temperature sensors and actuators to open/close the dampers of the orifice at the top of the clamshell and to open/close the dampers or doors at the top and bottom of the double glazed window panes that form the roof.

Finally, the organic farm that resides inside the greenhouse can be fully supplied and set up by outside vendors who design and build high-tech farms that provide hydroponic-style growing systems once the greenhouse construction is complete.

In this fashion, the greenhouse of the present invention is sold to users as a prefabricated, controlled-cost structure that goes up quickly for a known price, like a large, prefabricated steel truss storage or manufacturing building. That provides multiple sources of income for the greenhouse parts manufacturers and helps local unskilled workers and skilled construction workers to have more job opportunities, while farmers have better management over their farms. The farm organization also gets a fast set-up of an efficient farm to provide more time and resources for the farmers or farm investments to work with college extension teachers or other experts to provide teaching advanced farming techniques, solar heating, energy production and, possibly, food manufacturing to the employees and/or other owners, investors or community supporters to provide greater opportunities to generate profits. The present invention discloses that the modular greenhouse structure can be part of a community organization of people who can “learn by doing” with help from educators, skilled craftsmen, and technical professionals as consultants. As an Examples, this concept has been introduced to a native American tribe in northern Nevada where they have near-desert sunny conditions at a high altitude. They are blessed with the largest warm springs in the area to provide water to grow produce on their ranch. Their community sees the benefit for their youth with multiple opportunities for learning and employment through the installation of this design on their land. We believe that other farm communities will see these opportunities as well.

The present invention discloses a clamshell-shaped greenhouse that has much less total cost than alternative methods of solar electricity generation such as using mirrors to heat a high temperature turbine on a tower, or current large wind turbines or solar panels. All of those alternatives are more expensive to build, use much more costly raw materials and must use large amounts of fossil fuels to manufacture them. Also, just as importantly, the maintenance of those alternatives is more expensive than a solid structure with a wide base anchored to the ground that is easy to erect, has simple access to do maintenance and can hold up to major weather events better than those alternatives. Finally, the alternatives of wind turbines or solar panels do not usually involve an integrated greenhouse, which can produce more income to the community from the crops grown inside and eliminate fuel costs and pollution to run that equipment since it is powered by solar vortex electrical energy fueled by free solar heating.

### Example 1

In exemplary embodiments of the present invention, this example discloses that the shape of the greenhouse of the present invention is unique in that a clamshell shape of a transparent roof will allow the solar energy to most directly hit and enter the panes of the roof. That means that the roof panes must be angled to point, as directly as possible, towards the sun during the day and during the year. Since the Sun points pretty directly at the equator of the Earth, and the greenhouse is likely sited either above or below the equator, by raising the angle of the greenhouse roof panes that face the sun is equal to the degrees of latitude where the greenhouse sits on the Earth. So, the clamshell shape of the embodiment disclosed in the present invention shows that it has the largest roof panes and those that face towards the equator of the Earth at the degrees of latitude where the greenhouse sits on the Earth. The original clamshell design as shown by a photograph in FIG. 1 is the foundation for the prototype of the current functional design of the present invention as shown in FIG. 2.

In exemplary embodiments of the present invention, as shown in FIG. 2, it shows the top rails or joists of the beams (3) holding the sides and edges of the plurality of multi-paned, paired trapezoidal chutes (1), also referred to as chutes (1) around a central chamber forming the roof of the greenhouse, i.e., supporting the edges of the plastic panes in the chutes (1) that form the roof of the greenhouse. The clamshell shape is designed to be a strong structure that is easy to maintain and it is supported at the base with a plurality of concrete piers (5) as strong footings supporting the greenhouse base. Those supports are designed to keep the structure solid under extreme wind loads. The top part of the clamshell has a catwalk (6) for ease of entrance to the inner workings of the turbine, vents and other mechanisms, described below, and finally, there are stairs or ladder (7) up to the catwalk (6). The disclosed greenhouse uses the heating of air inside the double panes of the chutes (1) to pull air up from the bottom opening of the panes, i.e., from a lower intake opening of the chutes (4) at each of the chutes (1), to the top interior where a vortex is generated and it rises through a cone (2). The cone in the present invention as disclosed in FIG. 2 is a right-side-up cone versus the original inverted cone shape shown in the initial prototype of the present invention as shown in FIG. 1. The example shows that this change has been made as a result of through considerable research and experimentation which demonstrated that a cone with the small end at the top and placed above any plume of rising hot air, will tend to cause a lot of drag on the rising air molecules, especially reducing the power of a vortex inside the cone as it rises. A vortex takes the shape of a wide-at-the-top cone, so if it is surrounded by an inverted cone, the sides of the vortex will strike the inverted sides of the cone. Thus, the power of the vortex will be constrained. However, if a cone with a small end that is larger in diameter than the vortex is placed around the vortex that is forming, the vortex will form its natural cone shape well inside the right-side-up metal cone. This will not only allow the hot air vortex to rise easier (less drag), but it will guide the column of the vortex to remain vertical, preventing the vortex from potentially damaging property around the greenhouse if there are exterior side winds pushing the column of the vortex sideways.

In exemplary embodiments of the present invention, in FIG. 3 of the present invention, it discloses a sectional view that shows the key equipment that functions to support the clamshell-shaped roof of the greenhouse and provide the flow of air and light into the greenhouse. The schematic of a greenhouse building of the present invention is shown with a West elevation, the longest beams to the right, and the shortest and highest slope beams at the back of the structure. Note that the building is supported by a centrally located pole which is a central mono pole support for the roof of the greenhouse, referred to as a central support pole (12) from East to West sides and is ¾th the length back from the Equator-facing front of the clamshell building as disclosed in the present example of the present invention. The central support pole (12) placement is designed to lay the beams (comprising and identified by the top rails or joists of the beams (3) holding the sides and edges of the chutes (1) forming the roof of the greenhouse, by standard joists for roof support) and panes of the chutes (1) back to internally transmit more solar energy throughout the year when the position of the sun varies in height. Shown below the bottom of the structure are the plurality of concrete piers (5) as strong footings supporting the greenhouse base supporting the columns that then support the roof beams. This partially interior view also shows some of the technical systems, including the electric wind turbine (10), also referred to as turbine (10) interchangeably, that is spun by the heated and moistened air resulting from the ambient air is the air that entered from the lower intake opening of the chutes (4) at each of the chutes (1) flowing up through the panes of the chutes (1) to the turbine (10). Also, shown is an equipment, airlock control, and maintenance building referred to as the equipment building (8) with a plurality of electrical equipment (13) also referred to as equipment (13) interchangeably, inside it, located at the left bottom edge of the greenhouse, holding various equipment (13) including the battery and invertor to take the AC current from the turbine (10) and turn that electricity into the direct current used by the battery. The equipment building (8) is sealable with a pressure seal damper to maintain an airlock when the temperature outside is low as assessed by one of the thermostats located outside the greenhouse from among the plurality of thermostats (41) or when the winds are high as assessed by one of the anemometers from among the plurality of anemometers (40). Above the equipment building (8) is the ladder (7) that rises to the catwalk (6) that provides easy access to the interior of the vortex-producing equipment nestled inside the swirl chamber (27). Along the sides of the clamshell-shaped building of the greenhouse are located commercially available electric ventilation shutters (11) that are thermostatically controlled to open when the temperature goes above, 50° F. (10° C.) and close below that temperature. This and any other inlets of ambient air into the greenhouse, and any exhaust vents of heated air and/or heated and moistened or moist air from inside the greenhouse to the outside, and any other openings of the greenhouse to the outside are fitted with a fine mesh screening to keep out parasites (and dust that could interfere with the equipment) that can affect farming done inside the greenhouse. Finally, there are a long series of Lexan panels referred to as Lexan windows (15) for allowing natural light to enter along all the sides of the greenhouse.

In exemplary embodiments of the present invention, it provides an additional view of the support of the Greenhouse is shown in FIG. 4. The overall diameter of this pilot greenhouse of the example of the present invention is planned to have a diameter of 75 feet (22.86 meters). This view of the central support pole (12) shows how its placement is ¼th of the distance to the opposite wall of the building (facing the Equator). The gravel base (14) floor of the greenhouse in the interior of the greenhouse (55) is filled with dark colored rock to help with the absorption of heat from the Sun entering through the panes of the chutes (1). The equipment building (8) is shown again with the electrical equipment (13) such as commercial batteries, electrical breakers and the invertor to convert alternating current from the turbine (10) to direct current for the batteries that are attached to the wall of the building.

In exemplary embodiments of the present invention, in FIG. 5 shows how the functional design of the present invention maintains maximum solar exposure with the least reflectivity from the roof panes of the chutes (1). The benefit of the clamshell shape of the greenhouse forces the pitch of the panes directed towards the Equator to be the lowest (flattest) towards the Equator, and the pitch of the roof panes facing the East and West to be progressively more and more steep. The longest panes on the roof face the Equator and the functional design of the present invention as shown can be used in either the Northern Hemisphere or Southern Hemisphere, with the transparent panes of the chutes (1) allowing maximum light from Sun rays onto the dark gravel base (14) floor and walls of the greenhouse to capture heat while providing visible light for growing plants. The remaining infrared and ultraviolet solar rays are captured within the double layered panes (upper pane (19) of the chutes (1) and lower pane (20) of the chutes (1)) with a coating technology described herein below. This exemplary embodiment of the greenhouse maximizes the solar exposure in desert areas without burning the plants growing inside, through absorption of the Sun's heat onto the dark gravel base (14) floor, having large shuttered openings in the electric ventilation shutters (11) to allow in ambient air from the outside to the inside of the greenhouse, the use of a plurality of misters (34) to cool the incoming air, and the Sun filtering coating on the window panes themselves.

To explain how the sunlight enters the panes of the roof or the panes of the chutes (1) throughout the year, an example of a greenhouse that is sited at 27 degrees on the Earth, i.e., its latitude is 27 degrees) (27°. This latitude angle is used in the exemplary embodiment of the present invention since the majority of the deserts on Earth fall in or near that latitude degree range from North to South hemispheres. The clamshell-shaped greenhouse functional structure of the present invention has been designed to have a wide array of possible roof slopes. The specific roof slopes for each structure are to be designed to match the specific latitude where each greenhouse is built on the Earth. Furthermore, the 27° slope for both the potential Northern Hemisphere and Southern Hemisphere exposure of the exemplified greenhouse herein is done because that roof slope angle is based upon a location in both the Northern and Southern hemispheres on Earth where the majority of large amounts of sunlight and deserts occur.

For example: Saudi Arabia, India, Nepal, Peoples Republic of China, U.S. states of southern parts, namely, Texas and Florida, and Mexico's Baja California peninsula all are located around the 27° Northern latitude on the Earth. In the Southern Hemisphere, 27° from the Equator intersects such areas as Argentina, Chile, Brazil, South Africa and Australia. When looking at a global map that shows less greenery, the largest areas of desert are generally located around 27° or so on the Earth. The clamshell-shaped greenhouse of the present invention is designed to have beams that can be easily clamped into position, so that the slope of the roof can be positioned to be located to the appropriate angle of sunlight that matches the latitude of the construction site. The whole point of this functional design feature of the disclosed invention is that the roof will allow the most visible sunlight to pass through it to come into the structure with the least amount of reflection from the plastic panes (19, 20) that form the chutes (1) covering the greenhouse. Each specific clamshell-shaped greenhouse of the present invention is built to allow for maximum solar transmission into the structure of the greenhouse for both the movement of the Sun throughout the day and throughout the seasons, all based upon the latitude of its site.

The example further provides the reason why the latitude is the major determinate for a greenhouse as that of the present invention receiving maximum sunlight throughout the year. The solstices can influence the maximum amount of Sun that hits a particular point on the earth. For the Northern Hemisphere, the date of the summer solstice is around June 20-22 depending on the year, then add the angle of declination of the earth (which is 23.5 degrees), the Earth is most tipped towards the sun during those days. Therefore, the season is summer in the Northern Hemisphere because the Sun's rays are close to directly overhead in the Northern Hemisphere. On the winter solstice, the Northern Hemisphere of the Earth is tipped most away from the Sun, because the angle of declination makes the Sun's appearance lowest in the sky for those who are located above the Equator. For the Southern Hemisphere, the opposite effect is true, the Earth is tipped the closest towards the Sun during December so the Earth, south of the Equator is warmest then and when the Earth is tipped at the greatest angle from the Sun, south of the Equator in June, then the Earth, south of the Equator is the coldest.

The clamshell-shaped greenhouse of the present invention is designed to maximize the solar exposure effect with the pitch of the roof allowing the roof panes to be “looking” or angled as directly at the Sun as possible. In FIG. 2 and FIG. 3 disclosed herein, assuming that the exemplary greenhouse of the present invention is located in the Northern Hemisphere, the clamshell shape drawings of the aforementioned figures show a South facing exposure with the longest panes facing the South. This means with the functional design of the present invention, the southernmost panes of the chutes (1) on the roof of the greenhouse are the longest and the lowest in angle to maximize solar exposure and to reduce reflectivity. The combination of a low angle allows for the Sun to be near to 90 degrees above the greenhouse during the summer and the long length allows for the Sun to be focused into the top of the greenhouse during the winter when the Sun rises to a lower maximum height. So, for example, at the peak of the summer solstice (June 20-22 each summer) the angle of the Sun above the horizon for the greenhouse at 27 degrees of Northern latitude is 90 degrees minus 27 degrees latitude above the Equator minus 23.5 degrees of tip or declination of the Earth. That results in degrees of solar angle: 90°-(27°-) 23.5°=86.5° of angle of the Sun to the Earth during the summer. By taking the complement of that number or 90°-86.5°=3.5° slope, panes of the roof or the chutes (1) of the greenhouse of the present invention at this angle would allow the maximum transmission of sunlight through the roof panes of the chutes (1) during the Sun's position to be highest on the summer solstice. During the winter solstice, the angle to the sun is 90 degrees minus both the 27 degrees above the equator and the 23.5 degrees of declination or angle the earth leans away from the sun on its axis or 90°-(27°+) 23.5°=39.5°. For the roof of the greenhouse to present the most perpendicular face to the Sun in the winter, it would have to have a complement of 90 degrees, or 90°-39.5°=50.5°. The present invention provides the clamshell-shaped greenhouse as disclosed herein as a permanent, fixed building, so the roof panes of the chutes (1) of the greenhouse are kept at an angle facing the equator to maintain an average point between those two maximum performance roof slopes as calculated above. By taking the two sets of degrees found above and dividing by 2 the midpoint of the two slopes can be reached: (50.5°+) 3.5°/2=27°, which is the latitude where the greenhouse is sited. So, as shown in this example of the present invention, to maximize the exposure of the roof of the greenhouse of the present invention over the course of a year, the degrees in latitude where the building is sited will be the average degrees of pitch that the Sun is perpendicular to the panes of the roof of the chutes (1) of the greenhouse throughout the year. Since the exemplified greenhouse of this example is sited at 27 degrees latitude, that will be the average degree of roof pitch for the exemplified greenhouse sited at either the Northern or the Southern hemisphere location away from the Equator. The declination is factored out of the equation because the declination of the Earth offsets itself throughout the course of the year as the Earth revolves around the Sun. For the Northern Hemisphere, that angle changes from 23.5 degrees lower in the winter to 23.5 degrees higher during the summer so the declination changes are balanced out after a year. For the Southern Hemisphere, the angles are reversed, so during December for the Southern Hemisphere the Earth points toward the Sun by a maximum of 23.5 degrees (warm season) and during June, the Earth points away a maximum of 23.5 degrees from the sun (cold season). Thus, the greenhouse of the example of the present invention that is located on a Southern latitude, the angle of the Earth towards the Sun will rise and fall just as it does in the Northern Hemisphere, and so the declination effect on the rise and fall of the angle of the Sun's appearance in the sky will be canceled out throughout the course of a full year regardless of the latitude above or below the Equator. And, finally, if the greenhouse is sited exactly at the Equator, then almost the entire length of the roof panes of the chutes (1) of the greenhouse would need very low degrees of elevation or a very low roof line shape. Although, raising and lowering the angles of the roof panes pointed at the Sun was considered when developing the present invention, depending upon the season, which would allow some additional sunlight to enter the greenhouse. And, although the design of the clamshell of the greenhouse of the present invention uses a central support pole (12) to support the roof that could be telescoped taller or shorter; however, the gain for additional solar exposure would be very expensive to extend the plurality of beams (for example, 3a to 31 in Table 1 and FIG. 11) and central support pole (12) and to have a mechanical or hydraulic system lift or lower the roof of the building, especially if the greenhouse was built to cover multiple acres. Thus, the present invention at the present time is designed to retain the current functional design and maximize solar heating inside the greenhouse with other, more cost-effective methods as described below.

Since the functional design of the greenhouse of the present invention is for a structure that is fixed and not adjustable, this clamshell shape is designed to maximize the entrance of the Sun's rays into the greenhouse interior throughout the day. In FIG. 5, besides the design of the clamshell of the exemplified embodiment of the present invention, with the longest and lowest slope panes of the chutes (1) that face towards the equator, as the sun moves from the East or to the West, the slope of the panes of the chutes (1) rises higher and higher to the back of the structure with slope angles rising to over 60 degrees. The slope of the beams of 27 degrees facing the Equator offsets the angle the Earth is away from the Equator where the sun shines directly. The latitude is just the angle where the greenhouse is situated on the Earth away from the Equator. The Sun's arch of travel during the day rises from low on the horizon in the East and moves upward to its highest point around noon each day, then drops lower in the sky as it moves westerly to the horizon. The slope angle of the panes of the chutes (1) on each side of the clamshell-shaped greenhouse have slopes that are angled higher on the sides to capture a maximum amount of sunlight when the Sun is not at its zenith position, so the angle of 63 degrees shown in FIG. 5 is located at the back of the greenhouse.

The overall clamshell design of the greenhouse of the present invention captures more sunlight during each day than a flat roof or a low dome-shaped roof. It is important to keep in mind that the most sunlight enters a window when the flat surface of the pane of the chutes (1) is directly facing the Sun or at 90 degrees to the Sun. So, when the Sun is 30 degrees up from the horizon during the morning or evening, the panes of the chutes (1) of the greenhouse must be at an angle of 60 degrees so that the combination of 30 degrees of the sun from the horizon plus 60 degrees of roof slope equals the 90 degrees, the angle of the most direct sunlight which allows in the maximum solar energy.

A final feature of the functional design of the present invention is the stack (16) which supports the cone (2) shown before in FIG. 2. This cylindrical structure controls the positioning of the cone (2) so that its orifice is located directly over the vortex as it rises out of the greenhouse of the present invention.

### Example 2

This example of the present invention provides details about the development of the prototypes that were combined to demonstrate that the captured air inside a set of double-paned window panes that form the roof of the greenhouse referred to as the chutes (1) can produce sufficient air pressure to form a vortex of air that spins blades of the turbine (43).

In exemplary embodiments of the present invention, in FIG. 6 shows photograph of a prototype of an experimental chute in the plurality of chutes (1), where the exemplified chute of this example had had a length of 22 feet, or (670.56 cm), and consisted of sides that were 8″ (20.3 cm) high, with the opening at the top width of 12″ (30.5 cm) and the opening at the bottom was 6 ft in width or 72 inches (182.88 cm). The dimensions of this chute of the exemplified embodiment of the present invention took the form of a trapezoid that would make the sides angled and the top of the chute was ⅙ as wide as the bottom. This experimental chute had two levels, one a plastic sheet on top to seal the space and a sheet of wood below that was covered with black roofing felt to maximize heat absorption. The experimental chute was only designed to capture heat as much as possible when the transparent plastic top was aimed at the sun, and when elevated towards the sky, would pour out hot air from the narrow top. In that regard, it was observed that this chute would heat the air that came in at the bottom of the chute to over 100° F. (37.77° C.). A typical test with the experimental chute showed that the ambient air was at 80° F. (26.67° C.) at the bottom intake and when tested at the chute top, the air temperature reached at least 180° F. (82.22° C.). The chutes absorb heat from the sun, causing the air inside to increase in pressure (P), following Blaise Pascal's formula: P=F/A. The air molecules become very activated by heat, pushing against the enclosed volume of the chutes, thus increasing the force (F) assuming the area at the top of the chute is the same as the bottom. However, another exemplary embodiment of the present invention has also been designed, where the shape of the chutes (1) becomes smaller at the top. As noted above, the width of the chute went from 6 ft. to 1 ft, from bottom to top, decreasing the area (A) by 6. By dividing the area by 6 at the top of the chutes, can result in P=F/A/6 or 6P times the pressure when the gas is squeezed at the top of the chutes. Two things are happening in the chutes (1): a) the volume in the chutes (1) as built becomes smaller and smaller as the gas/air rises, and b) the pressure of the hot air increases. The result is the hot air or heated air from exposure to the Sun inside the chutes (1) becomes less dense and lighter, it tends to move upward in each of the chutes (1) faster and faster. The heated air in the chutes (1) acts as a fluid, so the hot air molecules draw the cold air molecules behind them upward, creating a “stack effect”. This sets up a cycle of hot air continuing to draw the cold air into the chutes (1) creating a flow process that forces the hot air to follow the upward angle of the chutes (1) up and out of the chutes (1). When the heated air comes out, it has a great amount of velocity, enough to move the blades of the turbine (43) in the turbine (10) of the swirl chamber (27) of the greenhouse of the present invention to produce electricity.

In the following examples through a series of photographs in the following Figures of the present invention, a number of tests conducted in these examples using simplified prototypes of the present invention are shown to provide a physical example of how each of the chutes (1) connects to the vanes, which are the upper vanes referred to as chute vanes (32) that can spin air into a vortex, which then spins the blades of the turbine (43). In the following exemplified embodiments of the present invention, photographic demonstrations of the various renderings of the present invention are shown to illustrate and demonstrate how the functional design of the present invention is used to extract solar heat using the chutes (1) and what equipment was designed to generate a vortex to spin the blades of the turbine (43).

In FIG. 7, a photographical rendering of a top-down view of an actual set of 16 vanes, upper vanes or chute vanes (32) of an earlier prototype is shown, where each of the vanes (32) is placed next to each other making up a circular series of curved chute vanes (32) that move air around a central area, called the swirl chamber (27), where an air vortex forms. The chute vanes (32) were originally built to enclose an area diameter of 22 inches (55.9 cm) across the swirl chamber (27), with a circumference of 69 inches (175.26 cm). FIG. 7 shows the original experimental design of the chute vanes (32) that are used to spin the air that comes from the chutes (1). The number of vents, referred to as chute vents (28) and chute vanes (32) is 16 in this illustration shown in FIG. 7, and their direction of spin (is clockwise) when viewed from the top are different and opposite from the design of the present invention. The present invention exemplified in a later embodiment has a total of at least 18 chutes (1), 18 chute vents (28) and 18 chute vanes (32) which are mounted in a larger configuration. The chute vanes (32) are directed in a counterclockwise direction for the exemplified embodiment model of the present invention unlike shown in FIG. 7, to take advantage of the Coriolis forces which tend to spin a vortex in a counterclockwise direction in the Northern Hemisphere the site of the exemplified embodiment of the present invention. This makes the artificial vortex closer to the natural counterparts in each of the hemispheres. The prototype was a small test project, to see if air could be moved by the vanes into a vortex, which was achieved in FIG. 7. With a larger arrangement of chute vanes (32) for the embodiment of the present invention, the Coriolis forces will be more powerful, and it is planned on maximizing those forces by designing the chute vanes (32) of the embodiment of the present invention to spin the air counterclockwise. In the center of this array of chute vanes (32) is the swirl chamber (27) that encompasses the outer tips of the chute vanes (32) into the center of the space surrounded by the chute vanes (32). The swirl chamber (27) space is where the vortex forms, and where an electric wind turbine (10) is placed to turn at the maximum spin velocity of the vortex.

In FIG. 8, it shows a photographical rendering of an enclosure that captured the air flow from a prototype chute (1) (seen earlier in FIG. 6). Also shown supported by a tripod mount, is a simulation set of blades of a turbine (43) which could be observed through the top of the swirl chamber (27) to see if the air flow was moving into a vortex in the exemplified prototype.

In FIG. 9, it shows a photographic rendering of the completed assemblage of the chutes (1), chute vanes (32), chute vents (28), the swirl chamber (27), and the cone (2) at top of the prototype of the greenhouse of the present invention. FIG. 9 shows that the exemplified chute of the plurality of chutes (1) is connected up to the enclosure where the hot air blows into the vents called the chute vents (28), then moves into the chute vanes (32), then spinning the simulated blades of the turbine (43) that were previously shown in FIG. 8, inside the swirl chamber (27) surrounded by a cone (2) structure of the present invention. The cone (2) structure on the prototype was inverted to capture the vortex and observe that the simulated turbine blades were spinning. In contrast to this earlier design of the present invention, the current design as claimed and exemplified later, and as shown in the schematics of FIGS. 2, 3, and 5, the cone in the presently claimed invention is right-side-up to maximize the upward flow of the vortex up and out of the swirl chamber (27) as exhaust from that cone (2).

In FIG. 10, it shows a photographic rendering of the full distance view of the individual chute representing the plurality of chutes (1) of the present invention connected to the enclosure that contains the swirl chamber (27) and the inverted cone system (2) of the earlier prototypes and embodiments before reaching the current functional design of the right-side-up cone (2) as shown in FIGS. 2, 3 and 5 above, to capture the cycling air inside the swirl chamber (27).

In exemplary embodiments of the present invention, FIG. 11 shows how the beams (represented by the top rails or joists of the beams (3) holding the sides and edges of the chutes (1) forming the roof of the greenhouse, by standard joists for roof support) and chutes (1) are planned to be assembled based on the lessons from the earlier prototype of the single chute connected to cone prototype (as shown above in FIG. 10) into a complete solar collection system of the present invention. FIG. 11 shows the arrangement of the total group of beams (12 on each side, 3a to 3l for a total of 24 beams) and chutes (1a to 1l, 12 on each side of the central support pole (12) for a total of 24 chutes) with a top-down view. The information on all of the measurements of beams and chutes for the 1/10th of an acre pilot structure is laid out in complete detail in Table 1.

As aforementioned, there are a set of 24 beams represented by the top rails or joists of the beams (3)) that are identified with reference numerals 3a to 3l on either side of the central support pole (12) and the central orifice door, referred to as an orifice closure device (35) above the swirl chamber (27). Twelve of the beams are assigned to the left side of the FIG. 11 and shown in Table 1, identified as 3a to 3l and the remaining twelve beams are assigned to the right side of the FIG. 11, also identified as 3a to 3l. The first number of the pair indicates that it is a beam and the alphabet of the reference numeral indicates the relative size of the beam as shown in Table 1 identifying a variation of the top rails or joists of the beams (3). When the 24 beams are attached together with their respective chutes (1), the chutes (1) are also identified by corresponding reference numerals, 1a to 1l chutes on the left side of the roof, and another 1a to 1l are located on the right side of the roof of the exemplified greenhouse schematic. Each of the chutes (1) blows into their respective chute vents (28) that connects to their respective chute vanes (32) at the swirl chamber (27) in the top-center of the greenhouse.

The measurements of the experimental chute structure were built to test the form of a trapezoid with sides angled at 15 degrees. When a group of 18 of the same angled chutes (1) are attached together at their sides, the 15° angle shaped chutes (1) mate together to take on a smooth circular form made up of chutes (1) covering 270°. The design of the clamshell shape of the assembly of the chutes (1) allows almost all of the direct sunlight to fall onto the 270 degrees of exposure on top of the greenhouse from the East to West. The 90 degrees that are located at the back of the circular roof cover the remaining degrees of the circumference of the circular roof of the greenhouse. The said 90 degrees has 6 sets of double-paned sheets of plastic, i.e., chutes (la to 1c on either side of the central support pole (12), shown as shaded gray in FIG. 11) sandwiched between the beams (3a to 3c and the central support pole (12) on either side) to attach below to the equipment building (8) and seal the back of the structure. Those 6 panes are the shortest double-paned roof chutes (1) but they receive almost none of Sun's exposure to heat them. So, they will not have the full system of a chute hot air collection system since they receive so little Sun. With little Sun, these chute pairs 1a to 1c, will not produce much hot air flow upward, so if there were chute top openings for those back windows, there would be no wind coming from them. They would tend to actually siphon off the air from the surrounding chutes, reducing the power of air that goes to the swirl chamber and then the vortex. This siphon effect has been observed with other experiments of the present invention when an electric blower was attached into the chute prototype that was blowing into the enclosure (shown operating in FIG. 9). If the air from a vent that has high amount of solar heating puts out more air than a chute vent (28) that has low solar heating and low air output, the air that goes into the swirl chamber (27) from those vents with maximum air flow will leak into the low-flow vents. Thus, the present invention also discloses a very direct method of using specially angled dampers to control each of the vents to self-adjust their pressure output so that air from all of the vents is maximized and equalized at the same time. Also shown in FIG. 11, in the center of the roof, is the orifice closure device (35) that is used to seal the air warm inside the greenhouse during cold nights.

In exemplary embodiments of the present invention, FIG. 12 shows more of the detail of the beam and how it helps support the top and bottom of the chutes and how it forms the sides of the chutes. Each beam is a standard-type commercial beam with webbing in its center and a steel top and bottom rails with ends that are bolted to a center structural ring that surrounds the turbine at the top of the roof and to the columns that form the edges of the multiple sides of the building. In the beams, a webbing made of metal in the center of the beams (9) for Lexan sheathing supports the top rails or joists of the beams (3) and the bottom rails or joists of the beams (18) and sheets of Lexan plastic panels (17) that seal the central webbing area encasing both sides of the webbing inside the beams. Lexan is chosen because it is very strong, unlikely to shatter, and it is very smooth, so that air flowing over the sides has little drag. When the trapezoidal plastic sheets on the top (19) and bottom (20) of the double paned chutes (1) are attached with high temperature silicone caulk horizontally under the top rails or joists of the beams (3) and on top of the bottom rails or joists of the beams (18), the plastic sheets become the top (19) and bottom (20) of the chutes (1). Then the Lexan sides are sealed with silicon caulk to the edges or flanges below the top or joists of the beams (3) and above the bottom of the rails or joists of the beams (18), so each of the chutes (1) is completely sealed into a square tube to move hot air inside it. The type of silicone caulk that seals the seams of the chutes (1) is a removable type so a transparent pane or the internal Lexan sheet can be replaced if damaged. This system of assembly retains the solar-heated hot air and allows it to flow at the upward angle of the chutes (1) when the Sun shines on the chutes (1).

### Example 3

This example of the present invention provides how the chutes (1) of the present invention guides and focus the energy from the Sun and demonstrates that the chutes (1) are key not only to the shape and the visible light collecting capacity of the clamshell greenhouse, but they also produce an extra capacity hot air pressure system that drives electrical energy production at the top of the clamshell.

In exemplary embodiments of the present invention, FIG. 13 shows the bottom of the chutes (1), with its air control devices but also its solar exposure control devices. Starting at the top of FIG. 13, the top pane of the roof that covers the entire clamshell is a plastic sheeting referred to as the upper pane (19) of the chutes (1), a commercially available transparent plastic sheeting used for greenhouses, UV resistant and at least 10 millimeter thickness, that is stretched over the top of the top rails or joists of the beams (3) holding the sides and edges of the chutes (1) forming the roof of the greenhouse with caulk sealing and bolted down with metal strips, as shown in FIG. 13. The sheets of Lexan plastic panels (17) that seal the central webbing area, a webbing made of metal in the center of the beams (9) for Lexan sheathing that supports the top rails or joists of the beams (3), the bottom rails or joists of the beams (18), encasing both sides of the webbing inside the beams of the chutes (1) are affixed to the top (3) and bottom (18) of the beams as described in FIG. 12 on the beam and chute structure. The bottom of the chute, referred to as lower pane (20) of the chutes (1) has a similar transparent plastic sheet caulked and bolted to the bottom rails or joists of the beams (18). The important elements that capture and retain heat inside the chutes (1) are two key layers, a) attached directly to the top part of the bottom transparent plastic sheet, the lower pane (20), which is a commercially available transparent Mylar reflective film (22) that reflects Ultraviolet and Infrared light up into the chute enclosure. It is cemented with a commercial high-heat removable silicone adhesive. b) Above and onto that film is cemented a high-temperature, removable commercial cloth weave material used in greenhouses, referred to as a heat-absorbing material screen (21) to further reduce heating coming through the plastic enclosing sheets into the greenhouse. This cloth weave attached to the Mylar reflective film (22) and the bottom plastic lower pane (20) at the bottom of the chutes (1) provides a capture system to retain as much heat as possible inside the chutes (1), while allowing through the chutes (1) the necessary percentage of visible light to grow plants from the sunlight that comes into the chutes (1).

With these additions to the interior of the glazing inside the windows on the clamshell roof, the U value of the roof panes (chutes (1)) should be more than commercial argon-filled windows. However, since there is considerable convection with a dead-air space of 2 feet (61 cm) and the chutes (1) carry moisture in them to add energy to the rising hot air flow, an optional third “pane” of clear Mylar film referred to as intermediate pane (36) may be added to the greenhouses of the present invention which are located in a very cold climate. This intermediate pane (36) can be sealed at a ⅝ the of an inch (1.59 cm) distance from either the upper pane (19) or the lower pane (20) to reduce the effects of convection and moisture inside the dual panes, thereby reducing the heat transfer through the panes. This intermediate pane (36) will slightly increase the amount of light capture over the current layers of UV plastic film and the heat reduction blanket material inside the two panes (19, 20) of the chutes (1), while not having a large dead air space to allow convection heat transfer. The black blanket, i.e., the heat-absorbing material screen (21) attached to the lower pane (20) can be purchased with a range of light absorption values since these cloth sheets come in a range of 10% to 90% absorption values. The pass-through percentage of sunlight through the two panes (19, 20), the blanket weave, i.e., heat-absorbing material screen (21) and the Mylar reflective film (21) and the extra insulating Mylar pane, the intermediate pane (36) will be determined before installation by measuring with a photometer (that is associated as a photocell sensor on top of actuators from among a plurality of actuators (24)) what percentage of light comes through all of the plastic sheets of the chutes (1) and various samples of weaves to determine what sunlight will be adequate for the plants to be grown there while assuring the maximum heat collection within the chutes (1).

The vertical support for the bottom of the chute is via a plurality of columns (25), shown below the chutes (1) next to the Lexan panels referred to as Lexan windows (15) for allowing natural light to enter along all the sides of the greenhouse that go around the sides of the entire greenhouse structure of the present invention. Also located at the bottom-angled side of the chutes (1), just above the Lexan windows (15) and closing off the entire entrance to the inside of the chutes (1) is an operable damper door (23), also regulated by the plurality of actuators (24) comprising a photocell sensor.

In exemplary embodiments of the present invention, FIG. 14 shows the same view of the bottom of one of the chutes (1) as that of FIG. 13 with the only change being the detail that shows the damper, i.e., operable damper door (23), controlled by one of the actuators (24) which has a photocell on its top. The photocell has a reverse-phase photocell using a relay. When it is sufficiently bright outside, the photocell powers a relay to turn on the normally closed contacts to the damper to turn on the actuator to open the damper. When the external light becomes dim, the photocell will de-energize the relay, allowing the normally closed contacts to close and turn the circuit off. There is also a wind override circuit on this operable damper door (23) to close it during the day for storms, which is controlled by one of the anemometers among the plurality of anemometers (40), which is explained later in the exemplified embodiments and figures discussed below. All of the remaining number indicators indicate the same operational elements as shown and described in FIG. 13.

In exemplary embodiments of the present invention, FIG. 15 provides cutaway view of the chute vents (28) for hot air coming out of the chutes (1) carried by the beams attached to the chutes (1) by the top rails or joists of the beams (3) holding the chutes (1) in place and below them are the lower vents referred to as interior greenhouse vents (29) that flow from the interior of the greenhouse (55) into the swirl chamber (27) nestling the electric wind turbine (10) in its center to receive the air pressure as vortex driving the blades of the turbine (43). The chute vanes (32) that are supplied by the chutes (1) are the top vanes and the interior greenhouse vanes (33) are supplied by the bottom vents, referred to as interior greenhouse vents (29), but they are not shown in this illustration so that the pathway up the chutes (1) and the inside of the swirl chamber (27) can be seen more clearly.

In exemplary embodiments of the present invention, FIG. 16 shows the mechanisms that control the flow of hot air from the chutes (1) and the interior of the greenhouse (55). A spring and latch system (37) is illustrated in this example for the management of each of the dampers in the plurality of dampers in the present invention, including the chute dampers (30) and the interior greenhouse dampers (31), the spring and latch system (37) comprising a snap latch (37a), an electric striker plate (37b), and a spring-loaded adjustable hinge (37c), where the a spring-loaded adjustable hinge (37c) has a fairly simple spring-loaded barrel built into the hinge (37c) and adjusted so that it has enough tension to close the damper loosely against the damper seal when there is very little hot air pushing the damper outward. The snap latch (37a) mechanism engages the electric striker plate (37b) when the spring pulls the damper almost shut. The snap latch (37a) hits a contact switch to pull the latch in swiftly so the latch (37a) will snap into the hole in the striker plate (37b) and hold the damper tightly against the seal on the edge of the opening. There is a heat sensor included in the latch system, so that when hot air reaches a certain temperature against the damper (around 180 OF or 82° C.) there is enough pressure to produce sufficient force to push open the damper. The temperature sensor overrides the signal from the contact switch and energizes the electric striker plate (37b). As long as that temperature is heating the sensor, the striker plate (37b) withdraws from the snap latch (37a), thereby allowing the hot air to push the damper open. This type of electric striker plate (37b) and latch (37a) can be purchased from suppliers of door security companies. The temperature sensor actuator is one from the plurality of actuators (24) and the spring-loaded adjustable hinge (37c) can also be purchased commercially.

In exemplary embodiments of the present invention, FIG. 17 shows chute vanes (32) (not showing interior greenhouse vanes (33)), and chute dampers (30) and interior greenhouse dampers (31) that supply the air to the swirl chamber (27) of the present invention. The vanes from the chutes or chute vanes (32) are angled in this example of the present invention to move the hot air or heated air (that may be heated and moistened air) from the chutes (1) in a counterclockwise direction for the current system of the present invention since this example is in the Northern Hemisphere. The chute vanes (32) as well as the interior greenhouse vanes (33, not shown here) would be angled the opposite way for a greenhouse that is located in the Southern Hemisphere. The chute vanes (32), shown in this exemplary embodiment of the present invention, angle the entire chutes (1) so that air flows from inside the chute vanes (32). At the outside edge of each of the chute vanes (32) is located a chute damper (30) or door with an adjustable spring and latch system (37) comprising a snap latch (37a), an electric striker plate (37b), and a spring-loaded adjustable hinge (37c) mechanism shown in FIG. 16. The composition of the door is aluminum with insulating batting inside or a high-temperature composite material. The closing mechanisms are situated so that each of the chute dampers (30) from the chutes vanes (32), and each of the interior greenhouse dampers (31) from the interior greenhouse vanes (33), bringing hot air from the interior of the greenhouse (55) have two spring-loaded adjustable hinges (37c) that have built-in springs with energy to push the door slightly closed. However, when the hot air rises through the chutes (1) and additional hot air enters the interior greenhouse vents (29) from below, from the interior of the greenhouse (55), where the hot air overwhelms the spring tension on the doors or dampers and the doors or dampers are pushed open. The dampers control the flow of heated air from the lowest output vanes to prevent “leaking” or “scavenging” of air from the highest output vanes into lower output vanes. If the highest air vanes push the doors somewhat closed on the lower output vanes, the closing of those low output doors increase the velocity from the low output doors. So that lower volume of air in the vane, when compressed by the door or damper, will increase air pressure coming out of the low volume vane to keep air flowing from as many vanes as possible. It is shown in FIG. 17 that there are a number of open doors or dampers. Shown on the outer edge of each of the doors is a snap latch (37a). On the seal of each of the doors is an electric striker plate (37b), that mates to the snap latch (37a). Examples of the spring-loaded adjustable hinge (37c) are shown on the side of the door/damper which pulls the door closed, on the edge of the door opposite the snap latch (37a). This system provides a fairly simple method to keep the air flow moving smoothly from the chutes (1) and greenhouse interior (55). Experimentation has found that when one of the chutes (1) that was receiving the maximum solar heat from the Sun while other chutes (2) were not directly under the Sun, the hot air would leak from the hottest chute to the cooler chutes. The doors or dampers direct the air flow in a counter-clockwise direction in this disclosed model of the present invention, and the weak flowing doors/dampers deflect the air from the most powerful chutes. This lets the air from the weak flowing chutes (1) to come out and mix with the stronger air flows. This keeps a balance of air flows allowing the mixing of separate air flows. Finally, note that the emergency pressure relief shutters (42) are shown located above the swirl chamber (27) in the center of the dampers (30, 31). The aforementioned emergency pressure relief shutters (42) are located just outside of the swirl chamber (27) to direct an escape of air if the turbine (10) is over-revving or causing electrical problems.

In exemplary embodiments of the present invention, FIG. 18 shows the whole arrangement of the vanes from the chutes (32) facing in a counterclockwise direction for the greenhouse structure situated in the Northern Hemisphere. The dampers (chute dampers (30), and interior greenhouse dampers (31)) shown in FIG. 18 have three fully closed off vanes (chute vanes (32), and interior greenhouse vanes (33)) from the back side of the clamshell greenhouse. Those are fully closed off because they are located away from solar exposure (with Northern exposure in this case) and almost no heating. The remaining chute dampers (30) and interior greenhouse dampers (31) are partially or fully open. That shows that when the Sun is moving through its arc above the greenhouse, the chutes (1), which provide the majority of high energy hot air, will have their dampers (30) open when the Sun is lighting the chutes (1) directly below it. When the Sun moves to the West, those westerly vanes receive hot air from solar heating later in the day, so those dampers will open and stay open later in the day. All during the day, the air will be spin in the swirl chamber (27) into a vortex that also spins the turbine (10). Importantly, as shown, located on the catwalk (6) railing are two sensors that a positioned at the top of the greenhouse, including the wind sensor, one of the anemometers (40), and the temperature sensor, one of the thermostats (41) located on the outside of the greenhouse that controls the air inlet from the electric ventilation shutters (11) at the bottom of the sides of the greenhouse (refer back to examples of the shutters in FIGS. 3 and 5). Finally, there is a cylindrical structure just above the vanes (32, 33) and turbine (10), called the stack (16) which holds the cone (2) upright (shown also in FIGS. 3, and 5) and in position so that the vortex passes directly around the center of the turbine (10) and comes up vertically, protected by the cone (2), which is right-side-up, i.e., wide above and narrow below) from side winds.

In exemplary embodiments of the present invention, FIG. 19 provides a large sectional view, which is an East-looking view, with the north side on the left and the south side on the right) of all of the elements that move the air flow to the turbine (10) and then up through the central orifice, control vent to the bottom of the cone (2) and then vertically out of the greenhouse. Looking on the right, can be seen the chutes (1) where the air flow, shown by the ribbon-like arrow, moves towards the turbine (10). As the air moves up one of the chutes (1), it is sprayed with a very fine mist of hot water from a misting nozzle (34) referred to as misters for the chutes (34b). All of the chutes (1) have misters for the chutes (34b) which have valves on their pipes. The pipes are turned on by switchable valves that open with the same electrical signal used to turn on the switch to release each damper latch, i.e., snap latch (37a), when the heat in the chutes (1) hits a minimum temperature. This misting process is crucial since it can dramatically increase the amount of hot air pressure flowing out to the blades of the turbine (43). Hot air will absorb considerable moisture, which provides additional energized molecules in a set volume of air, hence more pressure per volume. The heated, moistened air moves out of the chutes (1) on the right side of the diagram in FIG. 19, through the misters (34b), through the chute vanes (32), through the chute dampers (30) opened by the snap latch (37a) to allow air into the swirl chamber (27), indicated below the turbine (10), striking the blades of the turbine (43) forming a vortex to engulf and rotate the turbine blades. The interior greenhouse vanes (33) move air from the interior of the greenhouse (55), through to the interior greenhouse dampers (31), also with a snap latch (37a) opened, where interior air moves up into the swirl chamber (27) to add additional hot air pressure to push the blades of the turbine (43) and generate electricity through the turbine (10). The air from the interior of the greenhouse (55) is both hot and moist since it is heated from exposure to the Sun and a large portion of water that is absorbed into the air from the hydroponic plant growing in the interior of the greenhouse (55). This particular sectional view in this FIG. 19 cuts away part of the chute and lower vane on the right, so the viewer can see the air flow coming up through those avenues.

Moreover, the dampers (30, 31) shown have the snap latches (37a) shown just to the right side of the turbine (10) since they are in the swirl chamber (27) when the air is flowing. The electric striker plates (37b) on the edge of the upper or chute vanes (32) and lower or interior greenhouse vanes (33) show where the snap latches (37a) will swing onto the dampers (30, 31) to the right and shut the vanes (32, 33) down when the air is not moving through the chutes (1). The electric striker plates (37b) that the damper doors connect to using the snap latches (37a) and their operation were previously shown in FIG. 16.

On the left, what was discussed in FIG. 18 that the dampers/doors (30, 31) do not have hinges or latches in this case since they are part of 3 pairs of chutes (refer to 3a to 3c in FIG. 11 and Table 1) are permanently closed off by being attached to the rear of the building and back part of the greenhouse where the Sun is not reachable. The vortex is directed around them by the vanes (32, 33).

This internal structure with the vanes (32, 33), turbine (10), cone (2), stack (16) are all supported by the central support pole (12) that has a structure to hold them all in place with angled supports holding a lower structural ring (38b) that supports all of the lower vanes, i.e., the interior greenhouse vanes (33), and a second upper support ring or upper structural ring (38a), attached to the catwalk (6) next to it, and just above the blades of the turbine (43).

Finally, below the lower vanes, the interior greenhouse vanes (33) are hung a group of 18 transparent sails (39), that encircle the interior of the greenhouse (55). They are made of stiff plastic that is shaped into long trough-shaped structures that will capture the rising hot air and nudge it into a slow-moving vortex that then rises into the lower vanes, the interior greenhouse vanes (33) to spin the interior air more quickly, until that air is sucked into the faster-moving air flowing to the swirl chamber (27) from the chutes (1). This combination of an extremely large volume of moist hot air from the greenhouse interior, supplying its heat and moisture to the hotter, faster spinning moist air from the chutes (1), maintains the movement of the vortex longer than just the hot air pressure from the chutes (1), which have a short duration of solar heat on each chute as the Sun moves across the sky.

In exemplary embodiments of the present invention, FIG. 20 provides a view from above of the orifice closure device (35) that is shown with representations of aluminum metal sheets that are attached to the bottom of the closure device. The mechanism of the orifice closure device (35) sits above the turbine (10). The swirl chamber (27) area is immediately around the turbine (10) and it is closed off from the emergency pressure relieve shutters (42) that lie outside of swirl chamber (27). The dampers for the chute vanes, chute dampers (30) and for the interior greenhouse vanes, interior greenhouse dampers (31) are shown by looking inside the orifice closure device (35) to provide a perspective of its placement just above the swirl chamber (27) that encircles the blades of the turbine (43). The orifice control doors or the orifice closure device (35) are supported and encircled by the upper structural ring (38a) which holds the orifice closure device (35) in place. The upper vanes or chute vanes (32) are angled in a counter-clockwise direction for this Northern Hemisphere sited solar vortex greenhouse.

In exemplary embodiments of the present invention, FIG. 21 shows the orifice closure device (35) which is fully closed. It shows one of the anemometers (40) at the top of the hand rail of the catwalk (6) of the present invention that sends a signal to close the doors of the orifice closure device (35) if the wind outside is above a destructive speed (60 mph, for instance) that would make the vortex dangerous for buildings around the greenhouse. The doors are closed on the orifice closure device (35) so that the entire air movement from the swirl chamber (27) is sealed off and air stops moving upward. At the same time, the anemometer (40) sends a signal to the actuators (24, as shown on FIG. 14) to close the bottom damper doors, the operable damper door (23) on all of the chutes (1), the upper or chute dampers (30) on the chutes (1), the doors of the lower or interior greenhouse dampers (31), and the orifice closure device (35). Once the anemometer (40) detects winds below 60 mph, it returns control to the thermostat (40). The outside thermostat (41a) will generate a signal to open the orifice door device or operable damper door (23), the upper or chute dampers (30) and the lower or interior greenhouse dampers (31) bringing air up from the interior of the greenhouse (55). This is to keep the interior well-ventilated when the wind speed is less than the high wind parameters. The outside thermostat (41a) at the top of the railing of the catwalk (6) shares its readings with a similar thermostat on the support pole inside the greenhouse, the inside thermostat (41b). If either outside or inside thermostat (41a, 41b) has a reading above a temperature tolerated by the growing plants (say 45° F. or 7.2° C.) the orifice control doors or orifice closure device (35) is powered open until they hit their stops. This primes the circuit to close the orifice control doors or orifice closure device (35) when the lower thermostat detects a temperature lower than 45° F. or 7° C.

The bottom chute damper doors or the operable damper door (23) on the chutes (1) are also closed when the temperature inside the top of the greenhouse drops below approximately the 45° F. mark or 7.2° C. Also, with that external temperature, both outside and inside thermostats (41a, 41b) send a signal to the valve supplying the chute misters (34b) in all of the chutes (1) to cut off the hot water supplied to them. The signal from the anemometer (40) will have precedence over the thermostat (41a, 41b). Both the orifice control doors or the orifice closure device (35) and the chute bottom dampers or the operable damper door (23) have kill switches in the equipment building (8 as shown in FIG. 3) for control by the greenhouse staff. When the outside thermostat (41a) at the top of the greenhouse opens the ventilation shutters (11) to cool the interior, this simultaneously pushes hot air in the upper parts of the greenhouse to move upward to power the turbine (10). When the interior air becomes cool at a temperature that approaches the lower limit of plant tolerance, the inside thermometer (41b) is wired to close the ventilation shutters (11). All of these controls for temperatures and wind speeds in the disclosed greenhouse structure of the present invention are there to maximize plant growth while protecting the structure.

In exemplary embodiments of the present invention, FIG. 22 shows further details of the process when the thermostat closes the various ventilation dampers as the air inside the greenhouse becomes cool. This is shown by the closed condition of the orifice closure doors or orifice closure device (35), and the closed doors of the chute and internal greenhouse dampers (30, 31) shown around the outer edge of the blades of the turbine (43) attached to the turbine (10) in the swirl chamber (27).

To the left side of FIG. 22 is shown how the rising air in the chutes (1) (shown with curving arrows captured by a cutaway drawing of a chute interior) is stopped by the chute dampers (30) and the lower or interior greenhouse dampers (31) which are both closed, preventing hot air from entering the swirl chamber (27). The damper doors of the chute dampers (30) are latched by the snap latch (37a) from left to right around the swirl chamber (27), closing air flow throughout the chutes (1). The chutes (1) have a representative pipe and nozzle leading to the center of the upper chute, i.e., the chute misters (34b), which have been turned off. The air swirls in the chutes (1) for some minutes as it cools down. This action by the thermostat (41) causes the entire set of chutes (1), which form the roof, to seal completely. This allows the very well insulated roof panes of the chutes (1), which include very deep dead air space between the double panes (19, 20) on the roof, with the multiple coatings (21, 22) and can be outfitted with an additional film pane, and intermediate pane (36) that can be added for an exceptional cold climate (refer to FIG. 14). This can be a considerable advantage over typical thin spacing of dual greenhouse glazing because the clamshell roof with features referenced in FIG. 14: a thick dead-air space or air chamber (26), a fiber blanket or the heat-absorbing material screen (21) to absorb solar heat, the reflective film (22), and UV/IR coating on the lower window or lower pane (20). As described in FIG. 14, an optional Mylar film or intermediate pane (36) can be attached about ⅝th of an inch (1.59 cm) down from the top plastic pane or the upper pane (19) in the chutes (1) of the greenhouse roof. This Mylar film will slightly increase the amount of light capture over the other layers of UV plastic film and the heat reduction blanket material inside the two panes of the windows. The entire combination of coatings and transparent panes will require testing with a heat flux tester or a thermocouple and light meter to determine how much heat and light is coming through the panes of the windows. The light absorption of the fiber blanket can be adjusted by purchasing the maximum heat absorption while allowing enough visible light through the blanket to maximize plant growth. The blankets or heat-absorbing material screen (21) are available in 10% to 90% heat absorption from suppliers for greenhouses.

The interior of the greenhouse (55) has considerable heat banked by the dark interior structures, such as the black stones that are in the base of the structure or the gravel base (14) floor of the greenhouse. Also, the greenhouse has radiators (43) around the sides of the structure in the interior of the greenhouse (55) that are heated by a solar heat collection system comprising a plurality of solar heat collectors (48) as discussed later. The valves to the radiators (43) are opened by the interior thermostat (41b) which is a two-stage thermostat in the interior of the greenhouse (55) to keep the interior temperature above 50° F. or 10° C. and the other stage of the interior thermostat (41b) closes the valve to the radiators when the inside temperature reaches 85° F. or 29.4° C., or a top set temperature as may be desired for the selected plants to grow well in the interior of the greenhouse (55) by hydroponics.

Further, the emergency pressure relief shutters (42) are located just above the chutes (1) all the way around the swirl chamber (27). They are closed in this mode, fully sealing the interior as shown in FIG. 22. If air must be evacuated from the chutes (1) to greatly decrease air flow and prevent damage to the turbine (10), the emergency pressure relief shutters (42) will release air from the chutes (1) while the upper or chute vanes (32) and the orifice closure device (35) will be open. The emergency pressure relieve shutters (42) are located just at the top of the vanes, chute vanes (32) so that when activated the air will flow up to the emergency pressure relief shutters (42).

In exemplary embodiments of the present invention, FIG. 23 shows another view from the side of the swirl chamber (27) and one of the chutes (1) leading up to it in the mode for nighttime shutdown of air movement in the greenhouse. This position of all of the air flow components described below is done by the outer thermostats (41a) and inside thermostats (41b) initiating the closing signals to them when the temperature outside and inside reaches cool temperatures, around 45° F. (7° C.). All the 18 upper or chute dampers (30) in the chutes (1) are closed off to seal the chutes (1) near to the swirl chamber (27). The 18 interior greenhouse dampers (31) for the interior greenhouse vanes (33) are also shut off. The orifice closing door mechanism or the orifice closure device (35), originally shown in FIG. 21 with closed doors, now shown as a solid sealed piece at the bottom of the cone (2). All of these controlling elements stop the air flow to the blades of the turbine (43) which come to a stop. Also, the emergency pressure relief shutters (42) are sealed closed as well so the entire air movement system in the greenhouse is now fully sealed. The damper doors (30, 31) are shown with the snap latches (37a) on these dampers, which open to the right when there is air flowing (shown by the dotted lines). The spring-loaded adjustable hinges (37c) on the back of the dampers (30, 31) (shown by screws on the right edge of the dampers) have tension to close the damper door to the left.

So, air movement comes out of the vanes when it overcomes the tension in the spring-loaded adjustable hinges (37c). At this moment, the damper doors are latched shut and the viewer sees the doors closed on edge. The FIG. 23 also shows an alternative view of the position of the emergency pressure relief shutters (42) that is directly situated above the chute vanes (32), sealing the top of the chute vanes (32). If the turbine (10) begins overrevving or overheating, then the process of air evacuation proceeds opening the emergency pressure relief shutters (42).

### Example 4

This example of the present invention provides and explains the protection system for the turbine and electrical system of the present invention. To that end, there is a key feature built into the greenhouse air control system. This is called the emergency pressure relief shutters (42) system. It is designed to prevent over-revving of the turbine which can result in electrical shorts and potential fire.

In exemplary embodiments of the present invention, FIG. 24 relates to two main elements of this protection system. The first element of the over-revving protection system is the turbine output is measured by an electrical meter that monitors the output of the turbine (10). If that meter hits a red line, the turbine electrical connection is shut down. There is also a backup commercial high heat breaker switch on the turbine (10) which shuts the output of the turbine (10) off when it overheats. When either the electrical meter hits its red line or the high heat breaker switch is closed, a second relay monitoring these switches will energize all of the chute vane dampers, i.e., chute dampers (30) to close and the interior vane dampers or interior greenhouse dampers (31) to open, as shown in FIG. 24 in a cutaway view that only shows the dampers (30, 31) and the swirl chamber (27) and none of the interior elements. The chute dampers (30) are closed and the interior greenhouse dampers (31) are all open to allow air to flow up from the interior to the turbine (10) to help with its emergency cooling. The latches on the doors marked chute dampers (30), shown by the snap latch (37a) connect with the electric striker plate (37b) and are grabbed by the fingers of the strike mechanism, closing the doors. The spring-loaded adjustable hinges (37c) are shown by screws located on the opposite edge of the same door and the spring barrels on the inner sides of the lower doors. The lower doors have the latches released, so you can see that those doors are open. The orifice closing mechanism or the orifice closure device (35) is powered by the relay to open, seen in FIG. 20, allowing warm air from the interior to flow upward past the turbine (10), cooling it. The relay also opens the emergency pressure relief shutters (42) seen opening in FIG. 24, allowing the hot, moist air from the chutes to flow directly up, away from spinning the turbine (10).

In exemplary embodiments of the present invention, FIG. 25 is a sectional view of the air flow during the emergency pressure relief event. Any air that goes up to the chutes (1) and the chute vanes (32) is now allowed out of the emergency pressure relief shutters (42) directly above the chute vanes (32), and it rises quickly on the outside of the cone (2) up against the stack (16). The air then follows the relative low air pressure up to the perforated metal panel (44) at the top of the stack (16), a screen integrated into the top of the stack (16). At that point the rising air will evacuate the greenhouse structure.

When looking at the open nature of the lower vanes or interior greenhouse vanes (33), which corral and direct hot air that is floating up in the greenhouse, that air will float into the lower vanes or the interior greenhouse vanes (33), which have their damper doors or interior greenhouse vanes (33) open (shown in FIG. 24). The warm air from the interior will float around the turbine (10) and up through the orifice closure device (35) to help cool the turbine (10), as it moves to the lower the pressure through the orifice closure device (35), and exits the greenhouse up the cone (2).

In exemplary embodiments of the present invention, FIG. 26 provides a three-dimensional view showing another angle of what occurs when of the emergency evacuation system is activated. This view shows very clearly the air flow up and out of the power head of the structure. One aspect of this view shows on the left side of FIG. 26 that the chute dampers (30) on the chutes (1) stop the air from going into the swirl chamber (27) and the air has nowhere else to go but up through the emergency pressure relief shutters (42). The emergency pressure relief shutters (42) allow the hot air that is left in chutes (1) to rise naturally, away from the turbine (10) and the swirl chamber (27), taking the path of least resistance around the sides of the stack (16), then up through the perforated metal panel (44) at the top of the stack (16) that allows the heated air to flow from the emergency pressure relief shutters (42), along the outside of the cone (2), and then out of the perforated metal panel (44) at the top of the stack (16). Also, the orifice door system or the orifice closure device (35) is totally open above the turbine (10), being opened by a signal from the relay that controls the emergency pressure relief shutters (42).

To summarize, the flow of air, shown by ribbons of arrows, has these paths: 1) up the emergency pressure relief shutters (42) past the cone (2) and out the perforated metal panel (44) at the top of the stack (16), and 2) going up from the interior, through the lower vents or interior greenhouse vents (29), directed by the interior greenhouse vanes (33), and through the interior greenhouse dampers (31), then floating up over the turbine (10), out of the orifice closure device (35) and finally float upward out of the cone (2).

In exemplary embodiments of the present invention, FIG. 27 provides a side view of the entire electric power production system and its control elements. And, in the related exemplary embodiments of the present invention, FIG. 28 provides a below view of the entire electric power production system and its control elements. There are some key features that make the system of the present invention work. The mechanical equipment shown here rests on a very solidly built greenhouse structure and is attached to a structural ring (38) that also holds a catwalk (6) with a safety rail for workers to adjust and repair the equipment inside the greenhouse. When the Sun enters the panes (19, 20) of the chutes (1) sequentially around the entire clamshell greenhouse throughout the course of the day, heating the air inside of all of the chutes (1) from East to West in sequence and what passes up through the chutes (1) heats the interior of the greenhouse (55). The chutes (1) move the hot air inside them up to the pass through a mist of warm water produced by the chute misters (34b) shown in FIG. 28. That warm mist adds pressure to the hot air flow, since the mist causes the hot air to absorb more molecules into the air rising up the chutes (1). The warm air captured inside the greenhouse drifts up more slowly, but it adds a large volume of heat. The interior air passes through the lower or interior greenhouse vanes (33), angled the same as the upper or chute vanes (32). Since the Sun does not hit all of the tops or upper panes (19) of the chutes (1) simultaneously, the chute dampers (30) on the outside of the chute vanes (32) and interior greenhouse vanes (33) direct air flow around the inside the swirl chamber (27) direct the flow of hot and moist air smoothly outward to form the vortex, keeping the air from being scavenged from adjacent vanes to direct it into a sideways spinning vortex. The direction of the vortex spins at an angle so if viewed from a top-down direction it is angled counterclockwise in the Northern Hemisphere, clockwise in the Southern Hemisphere following the direction of the Coriolis forces. This swirl of air forms the vortex that pushes on the blades of the turbine (43) to spin the turbine (10) throughout the day. The vortex rises up through the open small end of the cone (2) held upright by the stack (16), a column of metal attached to the cone (2) to hold it in an upright position, centered above the vortex. When the temperature inside the greenhouse drops to plant damaging temperatures or darkness approaches, then the orifice closing device (35) closes its opening by a control signal from either of the outside thermostats (41a) or the inside thermostats (41b) with the result already shown in FIG. 22 with all of the dampers closing off the upper or chute vanes (32) and lower or interior greenhouse vanes (33), to keep warm air inside the interior of the greenhouse (55). These are the primary events that occur during each day to produce electrical power to run the farming operations that are powered by electricity, such as hydroponic pumps, planting and harvesting equipment, lighting and especially control of the growing environment to maximize healthy plant growth.

In exemplary embodiments of the present invention, FIG. 29 shows the detail of how the interior warm air supply is controlled in the undercarriage of the interior greenhouse vanes (33) and swirl power system to complement the heat sources from the chutes (1) and increase electricity generation. The central support pole (12) has 4 angular supports that hold up the structural ring (38). Attached to the structural ring (38) are 18 sails (39) that match up to pour hot, moist air onto the interior greenhouse vanes (33). Those sails (39) are long curved stiff clear plastic, curved to form troughs that nudge the warm air from the interior of the greenhouse (55) up to the interior greenhouse vanes (33) and on to the swirl chamber (27). The ribbons of arrows showing the air flow moving up the sails (39) into the interior greenhouse vanes (33). There are two benefits to have warm air coming up from the base of the greenhouse: 1) the upward convection of hot air pulls cool air from outside of the greenhouse, moderating interior temperatures for the health of the plants and workers in the structure, and 2) the rising warm air provides a large reservoir of warm air to keep the vortex spinning throughout the course of each day when there are variations in sunshine from hour to hour. The hot air from the interior passes through the interior greenhouse vanes (33), pushing upon the lower or interior greenhouse dampers (31) and then onto the turbine (10).

In exemplary embodiments of the present invention, FIG. 30 shows the interior of the greenhouse (55) moving down into the inside of the greenhouse as viewed from the central support pole (12) to see the plurality of sails (39) that are stretched to attach to the plurality of columns (25) that support each of the corners of the greenhouse, and keeping the greenhouse structure solid under extreme wind conditions and supports the corners of each of the sides of the greenhouse and the bottom edges of the beams. The plurality of sails (39) come down within 8 feet (244 cm) where they are attached to an attachment (47) to the plurality of columns (25) at each of the corners of the greenhouse to catch the warm air as it rises, directing that air into a wide cyclonic air movement that rises to the interior greenhouse vanes (33) that spin that cyclonic airflow into a tighter vortex at the top. The lower pane of the chutes (20) are shown stretched above the sails (39). Also, the inner thermostat (41b) that controls the opening and closing of the air supply from the ventilation shutters (11) which open when air is needed to lower the temperature detected by the inside thermostat (41b) on the central support pole (12).

In exemplary embodiments of the present invention, FIG. 31 shows the details of the interior heating, cooling and misting systems of the greenhouse. The plurality of radiators (46) that are supplied by solar heated antifreeze are shown located around the base of the sides of the greenhouse. The antifreeze and watering systems are shown in the following schematic in FIG. 32. The antifreeze solution is controlled by a valve and pump, turned on by the outside thermostat (41a) on the rail at the top of the catwalk (6) above the turbine (10), that lets in the hot antifreeze solution when the temperature drops to plant damaging temperatures. The inside thermostat (41b) on the central support pole (12) is wired to turn the antifreeze heating solution off when the interior temperature in the interior of the greenhouse (55) reaches temperatures that are optimal for plant growth. During the day, when the chutes (1) are opened to provide hot, moist air to the chute vanes (32) at the top of the greenhouse, the ventilation shutters (11) are opened by the inside thermostat (41b) on the central support pole (12). The ventilation shutters (11) are commercially obtained, electrically moveable, interconnected shutters in the lower side panels around the exterior of the greenhouse. The interior greenhouse misters (34a) are turned on by the inside thermostat (41b) on the central support pole (12). The interior greenhouse misters (34a) are located on each column of the plurality of columns (25), approximately 6 feet high (183 cm) to help increase air moisture to put more molecules into the air while it is being heated to flow upward to the turbine (10) as well as provide a saturated air environment to maximize plant growth. The interior greenhouse misters (34a) are also be controlled with a humidistat (part of the inside thermostat (41b) on the central support pole (12)) to maintain a specific level of humidity in the greenhouse by opening or closing the ventilation shutters (11) at any time of the day. Additional solar heat effects are always operating within the greenhouse: a) the gravel base (14) floor of the greenhouse has black gravel or even macadam to capture solar heat energy, b) the Lexan panels referred to as Lexan windows (15) that let in visible light and some heat energy around the sides of the Greenhouse. Finally, the plurality of diagonal braces (45) are attached to the angles of the sides of the greenhouse, to help keep a plurality of columns (25) vertical and sides square. The sides have structural expansion and contraction brought on by changes in temperature when part of the structure is being heated by the sun while another part is in shade.

In exemplary embodiments of the present invention, FIG. 32 provides a schematic of the solar generated hot water and antifreeze system. The plurality of solar heat collectors (48) is an array of simple black corrugated metal panels that can be fashioned inside a simple metal box with a UV plastic covering the front which can be angled back at the latitude of their location using a clamp-type hinge. The panels can be located just outside of the greenhouse, far enough away so the shadow of surrounding buildings and the greenhouse itself does not fall on the panels of the solar heat collectors (48). The number of panels to heat the greenhouse and provide water for misting can be determined by how much antifreeze in gallons or liters will be heated to at least 160° F. (71° C.) average per day in the Sun at the location near the greenhouse. The formula for computing the solar heating panels is provided by a commercial solar water heating company, SunEarth™ and can be viewed on their website. Using the formula provided from the said SunEarth™ company that sells collectors that use copper pipe soldered to a black painted metal plate or painted collectors, we will use the English measurements since the company provided measurements in that standard.

In FIG. 32, the schematic shows collectors of only 3 ft×4 ft in size, to heat 50 gallons of water and 20 gallons of antifreeze to 160° F. Assuming that the greenhouse of the exemplary embodiment disclosed herein is located in very Southern U.S. at 27 degrees latitude where the ground water is 60° F., calculating based on the formula from the SunEarth™ company: (Ratio of collector required per GPD of draw formula:

R_{sizing}=1.15*8.34*(135−T_{mains/well})/Q_{collector})

and so,

R_{sizing}=1.15×8.34×(160−60)=9.59×100=959sq.ft. of solar collector area.

If the embodiment uses the 3×4 ft in size or 12 sq. ft. divided into the number of square feet, the total number of collectors is approximately 80 collectors. If there is less room on the lot for both the Greenhouse and collectors, then doubling the size of the collectors to 4×6 ft in size and orienting them so the width is 6 feet will work. That will result in less wind exposure as well. The number of the larger collectors would be approximately 40.

Since the collectors used by SunEarth™ are fixed in a direction towards the Equator, they will be less efficient than if each collector in the greenhouse array is mounted on a commercial motorized sun-tracking system. Some companies that sell solar trackers are: First Sun Energy™ and All Earth Renewables™ with costs up to and more than $1000 per panel. However, the collectors can be ganged together in a series of rows with metal rods to connect them to a commercial one-axis sun-tracking motor for each row. The motor pushes the collectors from east to west during the day and it has a retracting actuator/spring on the metal rods to return the panels to the eastern direction at sunset. This sun-tracking system could maximize the solar exposure to match or even exceed the performance of the SunEarth™ system while costing far less than dual axis commercial tracking systems. Still, it would be a significant increase in cost to have solar tracking for an increase in efficiency of up to 35%. If the capacity of the panels is sufficient to heat up the 70 gallons water requirement per day with fixed panels pointed toward the Equator, it would not be necessary to purchase the cost of the tracking system.

A simple drip tube is attached to each of the solar heat collectors (48) by a set of small insulated hoses in the network of piping systems (53) that have antifreeze solution pumped from the solar heat collectors (48) into a large insulated tank within a dual tank system of a storage tank for antifreeze solution (50), which has a large copper coil inside it wrapped around a second, smaller tank that holds antifreeze. In this case, piping systems (53) that connects all of the solar heat collectors (48) to the storage tank for antifreeze solution (50) and supplies heated antifreeze solution to the plurality of radiators (46) encircling the lower walls of the interior of the greenhouse (55) and provides heat by circulating heated antifreeze solution through the solar heat collectors (48) to the storage tank for antifreeze (50). The smaller tank has enough capacity to fill the radiators (43), the solar heat collectors (48), and the piping systems (53), approximately 20 gallons. Fresh, clean, non-salty water is supplied via piping systems (53) that connect the storage tank for clean, non-salty fresh water (51) to the interior of the greenhouse (55) to supply the cool clean, non-salty fresh water to the misters of interior greenhouse (34a) supplying the interior of the greenhouse, and others that connect the large tank inside the storage tank for antifreeze solution (50) which is supplied with the clean, non-salty fresh water from the storage tank for clean, non-salty fresh water (51) with 50 gallon capacity, to be heated by heat exchange inside the storage tank for antifreeze solution (50) and the heated water is then supplied to the misters for the chutes (34b) in the chutes (1). The plurality of radiators (46) has hot antifreeze pumped to them when the outside thermostat (41a) turns on a pump from among the plurality of pumps (49) to power the antifreeze out of the tank, fill the radiators, and then cycle the antifreeze back to the copper coil surrounding the small tank. The antifreeze is always being pumped back through the small tank and onto a field of an array of solar heat collectors (52) until the small tank reaches a set temperature, like 160° F. or 71° C., to maintain the cycle of antifreeze heating. At that set point, a thermostat (41d) part of the plurality of thermostats (41) on the pump shuts down the pump. The outside thermostat (41a, on top of the catwalk (6)) is set to turn on the pump to the radiators (46) when the outside thermostat (41a) and the inside thermostat (41b) both reach the low point temperature that plants cannot live comfortably (i.e., 45° F. or 7.2° C.).

In other words, for the misters (34), the path of water is one-way unlike for circulating antifreeze solution. One of the pipe pumps (49) pumps cool clean, non-salty fresh water to the interior greenhouse misters (34a), as shown on FIG. 31 on the inside wall of the greenhouse. Another piping system (53) connect the large tank inside the storage tank for antifreeze solution (50) which is supplied with the clean, non-salty fresh water from the storage tank for clean, non-salty fresh water (51) to be heated by heat exchange inside the storage tank for antifreeze solution (50) and the heated water is then supplied to the misters for the chutes (34b) in the chutes (1) as shown on the right side of the schematic, FIG. 33. The fresh water is refilled every day or two from a larger mobile tank or piped from a utility water source via at hose attached to a faucet shown screwed into the exterior of the large, fresh water tank.

In another words, among the plurality of pumps (49) are pumps (49) carrying various liquids from one place to another in and around the greenhouse, with each pump (49) having a rotary pump for a liquid and an electric motor for driving the pump (49), where the liquid to be pumped is selected from a group consisting of antifreeze solution; cool clean, non-salty fresh water; hot clean, non-salty fresh water; and nutrient-rich water, that is carried by various pumps (49) described as follows that individually are responsible for pumping these different liquids and these pumps (49) are selected from a group of pumps (49) including pumps (49) to push the antifreeze solution from the solar heat collectors (48) to one of the at least one storage tank for antifreeze solution (50) and then on to the plurality of radiators (46) in the greenhouse for heating the interior of the greenhouse (55); pumps (49) which are hydroponic pumps to push and pump cool clean, non-salty water from the storage tank for clean, non-salty fresh water (51) into the greenhouse via misters for the interior of the greenhouse (34a) located inside the interior of the greenhouse (55); pumps (49) which are hydroponic pumps to push and pump heated clean, non-salty water into the greenhouse via misters for the chutes (34b) located inside the chutes (1); and pumps (49) to push nutrient-rich water from the storage tanks for nutrient-rich water (56) to the interior of the greenhouse (55) for the hydroponic cultivation of plants, wherein the plurality of pumps (49) are powered by the turbine (10) at the top of the greenhouse.

And the network of piping systems (53) moves the various liquids from one place to another in and around the greenhouse, pumped by the plurality of pumps (49), and among the network of piping systems (53) are different types of piping systems (53) with different responsibilities and functions selected from a group consisting of piping systems (53) that connects all of the solar heat collectors (48) to the storage tank for antifreeze solution (50) and supplies heated antifreeze solution to the plurality of radiators (46) encircling the lower walls of the interior of the greenhouse (55) and provides heat by circulating heated antifreeze solution through the solar heat collectors (48) to the storage tank for antifreeze (50); piping systems (53) that connect the storage tank for cool clean, non-salty fresh water (51) to the interior of the greenhouse (55) to supply the clean, non-salty fresh water to the plurality of misters (34) throughout the greenhouse; piping systems (53) that connect the large tank inside the storage tank for antifreeze solution (50) which is supplied with the clean, non-salty fresh water from the storage tank for clean, non-salty fresh water (51) to be heated by heat exchange inside the storage tank for antifreeze solution (50) and the heated water is then supplied to the misters for the chutes (34b) in the chutes (1); piping systems (53) that connect the storage tanks for nutrient-rich water (56) to the interior of the greenhouse (55) for the hydroponic cultivation of plants.

In exemplary embodiments of the present invention, FIG. 33, it provides a schematic showing that the electrical system of the present invention which is supplied exclusively from the turbine (10) that is located at the top of the clamshell greenhouse as disclosed herein. All of this electrical equipment is available commercially and is to be installed under the guidance of a qualified electrician or electrical engineer to assure that the electrical demand will be balanced to match the maximum output of the turbine (10) of the present invention. During the process of installation, the air flow during maximum solar heat will be measured through the chutes (1) and up from the interior of the greenhouse (55). Once the maximum air flow and heat is assessed, then a turbine (10) will be acquired that matches or exceeds the air flow of the vortex. Also, the electrical storage and output equipment, part of the electrical equipment (13) kept inside the equipment building (8) will be purchased to fit the turbine (10). Then, the electricity is wired to power the equipment (13), to include lights (54), water pumps (49) for the radiators (43) and misters (34) and to supply nutrients for the plants, power for the various shutters (11, 42) in the greenhouse, safety systems, and various control dampers (30, 31, 23) on the structure.

The turbine (10) will send the electricity to an inverter among the electric equipment (13) located in the equipment building (8) at the back part of the greenhouse, which converts the alternating current from the turbine (10). The converted current from the inverter is fed into a commercial DC battery (also included in the electrical equipment (13)) that is designed to perform thousands of cycles of charges and is the least costly available with that cycling performance. The wiring then is connected inside the greenhouse to run the plurality of pumps (49), for the plurality of radiators (43) and the water circulating and misting systems (34), and open-air cooling systems like ventilation shutters (11) on the sides of the greenhouse and starter lighting for plant shoots, plant growth lighting system (54). Shown particularly in FIG. 33 are the chute misters (34b) supplied with heated clean, non-salty fresh water pumped via one of the pumps (49) among the plurality of pumps (49) by one of the piping systems (53) taking heated water, which is heated in the large tank of the storage tank for antifreeze solution (50) coming in from the storage tank for clean, non-salty fresh water (51) by heat exchange from heated antifreeze in small tank of the storage tank for antifreeze solution (50). The small tank in the composite two tank system of the storage tank for antifreeze solution (50), which supplies heated antifreeze solution to the plurality of radiators (46) in FIGS. 31 and 32, also has the large tank surrounding that antifreeze smaller tank. That surrounding larger tank in the storage tank for antifreeze solution (50) has a separate pump from among the plurality of pumps (49) to deliver fresh water to the misters (34b) at the top of the chutes (1), shown in the top right of FIG. 33.

The present invention thus provides the solar vortex clamshell greenhouse, which is a synergistic interplay of mechanical elements and natural forces. It is a greenhouse that can grow tons of very valuable, clean organic crops without needing to use carbon-fueled HVAC systems. Its systems are designed to use the power from the Sun for those tasks in addition to providing all of the energy that is needed to plant, harvest, and manufacture products from the crops grown inside the greenhouse. Since the disclosed greenhouse is a clean, fully controlled enclosure, there is no need for insecticides or herbicides, or even soil, since the growing medium for the plants is hydroponic, utilizing a tendril system of support such as Stone Wool™, manufactured by Grodan™. The food and water are provided to plants without the poisons used in conventional, industrial farming. The disclosed greenhouse environment maintains full control of the air that flows in and out of its interior, with full screening on all dampers and shutter and top openings that encircle the structure to keep out insects and other pests. Finally, the wind vortex that is produced at the top of the greenhouse can rise many thousands of feet, generating a micro-climate. That climate can coalesce moisture in the surrounding air to return it to the farm for reuse on the farm. This self-sufficient farm can be more efficient in its use of plants, water, fertilizer, equipment and energy resources than even the most efficient commercial farms and commercial greenhouses used in agriculture today.

The present invention thus provides a solar vortex generator greenhouse comprising a clamshell array of transparent chute assemblies. Solar radiation heats the air beneath the chutes, which rises into a central chamber. Transparent panes of the chutes arranged in a corkscrew impart rotational motion, creating an atmospheric vortex. The vortex exits through a wide-topped funnel exhaust connected to a swirl turbine, producing electrical power. A misting system injects hot water vapor into the airflow to increase enthalpy, while an antifreeze-buffered storage tank and heat exchanger maintain operation during off-sun periods. The structure doubles as a greenhouse enclosure, enabling cultivation of food, hemp, or specialty crops. The modular design allows scalable deployment for community or commercial use.

The present invention overcomes a lot of drawbacks of the prior art resulting from high structural cost, like for tall chimneys require massive reinforced construction, limiting commercial deployment; aerodynamic inefficiency with chimney drag reduces energy yield; land underutilization, where large collector surfaces are barren, serving no additional purpose; operational intermittency, where most systems fail during cloudy or nighttime conditions; and lack of agricultural integration, where none of the prior designs were conceived as standalone power plants.

The present invention is particularly advantageous over the prior art by providing a system that eliminates reliance on tall towers or massive concrete bases; provides dual-use functionality: both power generation and greenhouse farming; uses misting and antifreeze-buffered thermal storage to sustain vortices in low-sun or nighttime conditions; and employs a clamshell chute geometry that is modular, lightweight, and scalable. Due to its cost effectiveness, modularity, efficient harvesting of solar energy and conversion to electricity, ability to be operational in challenging environments, scalability, and tremendous potential for job creation, it is highly economically rewarding too in additional to being technologically advanced.

It will be apparent to those skilled in the art that various modifications and variations can be made in the practice of the present invention without departing from the scope or spirit of the invention. Other embodiments of the invention will be apparent to those skilled in the art from considering of the specification and practice of the invention. It is intended that the specification and examples be considered as exemplary only, with a true scope and spirit of the invention being indicated by the following claims.

What is claimed is:

1. A solar vortex, clamshell-shaped, energy conversion, and plant growing dual-purpose greenhouse, comprising:
a clamshell-shaped roof formed of a plurality of multi-paned, paired trapezoidal chutes (1) around a central chamber, the chutes (1) altogether assembled into a clamshell configuration, each of the chutes (1) including transparent outer covers on top and bottom of the chutes (1) as top and bottom layers referred to as panes, a reflective film (22), and a heat-absorbing material screen (21) in between the top and bottom outer covers as intermediate layers, configured to heat air inside the cavity formed between the transparent outer covers on top and bottom of the chutes (1) by exposure to the Sun and direct the heated air upward inside the greenhouse;
a plurality of beams supporting the top and bottom of the chutes (1) and forming the sides of the chutes (1), with the top rails or joists of the beams (3) holding the sides and edges of the chutes (1) forming the roof of the greenhouse, by standard joists for roof support;
a plurality of concrete piers (5) as strong footings supporting the greenhouse base, a plurality of columns (25), and keeping the greenhouse structure solid under extreme wind conditions;
a plurality of vanes configured to impart a rotational direction to the heated air, including upper vanes referred to as chute vanes (32), and lower vanes referred to as interior greenhouse vanes (33), arranged around a swirl chamber (27) at the top of the greenhouse, configured to guide the heated air into a vortex of pressurized heated airflow referred to as the vortex;
a plurality of vents, including upper vents referred to as chute vents (28), and lower vents referred to as interior greenhouse vents (29), to pour the heated air into the swirl chamber (27);
an electric wind turbine (10) with blades of the turbine (43) positioned within the swirl chamber (27) rotated by the vortex, and operable to convert kinetic energy of the vortex formed by the heated air pouring into the swirl chamber (27) from the chutes (1) and the interior of the greenhouse (55) into electricity;
a stack (16) and cone (2) assembly at the top of the greenhouse, positioned above the swirl chamber (27) to stabilize and vertically guide the vortex upwards to exhaust out of an orifice located above the swirl chamber (27) at the top of the greenhouse;
a plurality of shutters that form an air-cooling system, including electric ventilation shutters (11) and emergency pressure relief shutters (42);
a plurality of dampers including an operable damper door (23), upper dampers for chute vanes (32) referred to as chute dampers (30), and lower dampers for interior greenhouse vanes (33) referred to as interior greenhouse dampers (31);
at least one orifice door system referred to as an orifice closure device (35);
a plurality of misters (34);
a plurality of actuators (24) with a photocell sensor on top of each of the actuators;
a plurality of anemometers (40);
a plurality of thermostats (41);
a plurality of radiators (46);
a catwalk (6) around the top of the greenhouse with a ladder (7) to reach the catwalk (6) for easy access to the interior of the swirl chamber (27) and vortex-producing equipment;
an equipment, airlock control, and maintenance building referred to as equipment building (8) with a plurality of electrical equipment (13) inside it;
a central mono pole support for the roof of the greenhouse, referred to as a central support pole (12);
a plurality of sails (39) positioned within the central chamber to impart rotational motion to the heated air rising from the interior of the greenhouse (55) and guiding the heated air up to the interior greenhouse vanes (33);
at least one structural ring (38) consisting of an upper structural ring (38a) and a lower structural ring (38b);
a perforated metal panel (44) at the top of the stack (16) that allows the heated air to flow from the emergency pressure relief shutters (42), along the outside of the cone (2), and then out of the perforated metal panel (44) at the top of the stack (16);
an attachment (47) of the plurality of sails (39) to the plurality of columns (25) at each of the corners of the greenhouse;
a plurality of solar heat collectors (48);
a plurality of pumps (49);
at least one storage tank for antifreeze solution (50);
at least one storage tank for clean, non-salty fresh water (51);
at least one storage tank for nutrient-rich water (56);
a field of an array of solar heat collectors (52);
a network of piping systems (53);
a plurality of diagonal braces (45) attached to the angles of the sides of the greenhouse, to help keep a plurality of columns (25) vertical and sides square; and
a climate-controlled interior of the greenhouse (55) configured for hydroponic cultivation of plants beneath the chutes (1) forming the roof of the greenhouse, with a gravel base (14) floor of the greenhouse and Lexan panels referred to as Lexan windows (15) for allowing natural light to enter along all the sides of the greenhouse into the interior of the greenhouse (55) for the growth of the plants,
wherein the plurality of multi-paned, paired trapezoidal chutes (1) comprises triangular modules arranged in a substantially circular array, and each of the chutes (1) is wider at the bottom than at the top to accelerate airflow upward inside the chutes (1), and is at least double-paned, meaning it has two panes,
wherein the clamshell-shaped geometry of the roof of the greenhouse formed by the plurality of multi-paned, paired trapezoidal chutes (1) arranged radially around a central axis comprises a convex outer surface and a concave inner surface configured to focus solar radiation and guide airflow toward the swirl chamber (27),
wherein the clamshell-shaped geometry of the roof of the greenhouse induces spiral flow vectors converging toward a central axis,
wherein the plurality of beams has each of the beams as a standard-type beam with webbing in its center and top rails or joists of the beams (3) with ends that are bolted to a central structural ring (38) that surrounds the turbine (10) at the top of the roof, and bottom rails or joists of the beams (18) with ends that are bolted to the plurality of columns (25) that form the edges of the multiple sides of the building,
wherein the beams are comprised of the top rails or joists of the beams (3), the bottom rails or joists of the beams (18), a webbing made of metal in the center of the beams (9) for Lexan sheathing that supports the top rails or joists of the beams (3), the bottom rails or joists of the beams (18), sheets of Lexan plastic panels (17) that seal the central webbing area encasing both sides of the webbing inside the beams,
wherein the plurality of beams is structured such that in the Northern Hemisphere, the two centermost, longest beams face directly South to match the Sun's highest location in the sky in that hemisphere such the Sun shines directly inside them during the longest day of the summer, and in the Southern Hemisphere, the two centermost, longest beams face directly North to match the Sun's highest location in the sky in that hemisphere such the Sun shines directly inside them during the longest day of the Winter, while the remaining beams are mounted at angles consecutively higher on both the West and East sides such that the final beams at the end of each side are more elevated than the centermost chutes (1) forming the roof of the greenhouse,
wherein the central support pole (12) placement inside the greenhouse is structured such that it lays the plurality of beams and the plurality of multi-paned, paired trapezoidal chutes (1) back to internally transmit more Solar energy throughout the year when the position of the Sun varies in height,
wherein the transparent outer covers in the chutes (1) provide shape to the roof of the greenhouse for visible light capture, and heating of air in the greenhouse, and the two panes heat the ambient air inside the double-paned chutes (1) to generate pressurized heated airflow, the ambient air is the air that entered from a lower intake opening of the chutes (4) at each of the chutes (1),
wherein the two panes in the double-paned chutes (1) include a top plastic, UV-resistant, and transparent sheet covering for the roof of the greenhouse, referred to as upper pane (19) of the chutes (1), and a bottom plastic and transparent sheet covering of the roof for the greenhouse, referred to as lower pane (20) of the chutes (1),
wherein the upper pane (19) of the chutes (1) covers the clamshell configuration of the greenhouse in its entirety as the top pane of the roof of the greenhouse,
wherein the plurality of multi-paned, paired trapezoidal chutes (1) forming the roof of the greenhouse has each of the double-paned chutes (1) between the plurality of beams with a trapezoidal passage, the lower intake opening of the chutes (4), and one of the chute vanes (32) at the top of each of the chutes (1),
wherein the trapezoidal passage which forms an air chamber (26) by the sheets of Lexan plastic panels (17) that seal with the use of silicon caulk the central webbing area encasing both sides of the webbing inside the beams, the upper pane (19) of the chutes (1) and the lower pane (20) of the chutes (1) forming the roof of the greenhouse and the chute dampers (30) sealing the top of the chutes (1), and operable damper door (23) sealing the bottom of the chutes (1) and altogether the air chamber (26) so formed is completely sealed to move the heated air inside the chutes (1),
wherein the chutes (1), altogether assembled into a clamshell configuration, are oriented at an angle substantially perpendicular to incoming solar rays from the Sun at the latitude of installation of the greenhouse, meaning the latitude where the greenhouse is located on the Earth,
wherein the chute vents (28) pour the heated air coming from the chutes (1) into the chute vanes (32) that surround the swirl chamber (27), and the interior greenhouse vents (29) pour the heated air coming from the interior of the greenhouse (55) into the interior greenhouse vanes (33) that surround the swirl chamber (27),
wherein the swirl chamber (27) has the chute vents (28), the chute vanes (32), the interior greenhouse vents (29), and the interior greenhouse vanes (33) are angled counterclockwise when the greenhouse is located in the Northern Hemisphere of the Earth and clockwise when the greenhouse is located in the Southern Hemisphere of the Earth to take advantage of the Coriolis forces which tend to spin a vortex in a counterclockwise direction in the Northern Hemisphere and spin a vortex in a counterclockwise direction in the Southern Hemisphere,
wherein the vortex is produced from the heated air partly produced in the chutes (1) by heating ambient air entering the chutes (1) from lower intake openings (4) for the chutes (1) are formulated to resist ultraviolet light from the Sun, so they do not break down from exposure to the Sun,
wherein the chutes (1) produce an extra capacity hot air pressure system that rotates the blades of the turbine (43) that drives electrical energy production by the turbine (10) at the top of the clamshell,
wherein the stack (16) and cone (2) assembly allow the vortex to pass directly in the center of the turbine (10) oriented towards the top of the greenhouse, protects against drag, keeps the vortex vertical, and protects it from side winds,
wherein the electrical equipment (13) inside the equipment building (8) thermostatically controls the plurality of shutters, the plurality of dampers, and the orifice door system to regulate airflow and temperature in the greenhouse,
wherein the electric wind turbine (10) is positioned below the cone (2) in an assembly that allows the vortex to exhaust out of the greenhouse as its rotational airflow is converted into electricity by rotating the blades of the turbine (43),
wherein the turbine (10) generates electricity which is stored in grid-scale batteries, which are part of the plurality of electrical equipment (13) inside the equipment building (8), and powers both greenhouse operations and external systems,
wherein the emergency pressure relief shutters (42) are positioned adjacent to but outside the swirl chamber (27), configured to vent excess air pressure in response to the turbine (10) over-revving, causing electrical problems, or destructive wind conditions, thereby protecting the greenhouse and maintaining plant-sustaining temperatures inside the greenhouse,
wherein the plurality of columns (25) supports the corners of each of the sides of the greenhouse and the bottom edges of the beams (3),
wherein the orifice closure device (35) is positioned above the swirl chamber to shut off upward airflow in response to environmental conditions selectively,
wherein the plurality of dampers has a spring and latch system (37) for each of the dampers to seal the dampers, the spring and latch system (37) comprising a snap latch (37a), an electric striker plate (37b), and a spring-loaded adjustable hinge (37c), and the spring and latch system is configured to regulate the opening and closing of each of the dampers based on and in response to air pressure and temperature actuated by signals from the plurality of actuators (24), the plurality of anemometers (40), and the plurality of thermostats (41),
wherein the plurality of thermostats (41) is calibrated to maintain interior temperatures inside the interior of the greenhouse (55) between 45° F. and 85° F. for optimal plant growth,
wherein the plurality of anemometers (40) is situated at the top of the greenhouse at the handrails of the catwalk (6) and sends a signal to close the orifice closure device (35) if the wind outside is above a destructive speed that makes the vortex dangerous for buildings around the greenhouse,
wherein the sides undergo structural expansion and contraction due to temperature changes, as part of the structure is heated by the Sun while another part remains in shade,
wherein the central support pole (12) has four angular supports to hold up the structural ring (38),
wherein the central support pole (12) supports the internal structure inside the greenhouse, including the interior greenhouse vanes (33), the turbine (10), the cone (2), and the stack (16) to hold them in place with angled supports holding a lower structural ring (38b),
wherein the upper structural ring (38a) is attached to the catwalk (6) and is situated just above the blades of the turbine (43), and the orifice closure device (35) is supported and encircled by the upper structural ring (38a),
wherein the plurality of sails (39) comprises transparent sheets arranged in a corkscrew configuration and encircle the interior of the greenhouse (55) to impart rotational motion to the heated air from the interior of the greenhouse (55),
wherein the plurality of sails (39) is shaped into long trough-shaped structures that capture the rising heated air and nudge it into a slow-moving vortex that then rises into the interior greenhouse vanes (33) to spin the interior air more quickly, until that air from the interior of the greenhouse (55) is sucked into the faster-moving air from the chutes (1) flowing to the swirl chamber (27) and this additional internal air from the interior of the greenhouse (55) supplements the faster-moving air from the chutes (1),
wherein the greenhouse with the clamshell-shaped roof maintains the temperature inside the greenhouse for the plants growing in the interior of the greenhouse (55), and for the heated air inside the greenhouse, in part by sending the heated air up and out of the greenhouse to exhaust out of the greenhouse via the cone (2),
wherein the greenhouse with the clamshell-shaped roof maximizes the exposure to the Sun without burning the plants growing inside the interior of the greenhouse (55), via various mechanisms including through absorption of the Sun's heat onto the gravel base (14) floor of the greenhouse, having large shuttered openings via the electric ventilation shutters (11) to allow in ambient air to the greenhouse,
wherein the plurality of anemometers (40), which are wind speed sensors located on top of the greenhouse, the plurality of thermostats (41), which are temperature sensors located at different locations on top of and inside the greenhouse, and the plurality of actuators (24) with photocell sensors, regulate opening and closing of the plurality of dampers including the operable damper door (23), the chute dampers (30), and the interior greenhouse dampers (31), and opening and closing of the plurality of shutters including the electric ventilation shutters (11) and the emergency pressure relief shutters (42),
wherein the plurality of shutters, including the electric ventilation shutters (11) and the emergency pressure relief shutters (42), are remote-controlled and powered interconnected for greenhouse ventilation for air cooling and pressure relief,
wherein the equipment building (8) is sealed with a pressure seal damper to maintain an airlock when the temperature outside is low, as sensed by the plurality of thermostats (41), or when the winds are high, as sensed by the plurality of anemometers (40) and holds the electrical equipment (13) including a heavy-duty, high-capacity battery and an electrical inverter like that used for the electrical grid to take the alternating current electricity from the turbine (10) and turn that alternating current electricity into the direct current electricity used by the battery,
wherein the ladder (7) is located above the equipment building (8) that rises to the catwalk (6) that provides easy access to the interior of the vortex-producing equipment inside the swirl chamber (27),
wherein the electric ventilation shutters (11) located along the sides of the greenhouse are thermostatically controlled by signals from the plurality of thermostats (41) to open when the temperature in the interior of the greenhouse (55) is above a set temperature and close when the temperature in the interior of the greenhouse (55) is below the set temperature,
wherein the electric ventilation shutters (11), the emergency pressure relief shutters (42), the orifice closure device (35), the stack (16) and cone (2) assembly, the lower intake openings (4), any other inlets of air into the greenhouse, and any other exhaust vents of air to the outside from inside the greenhouse are fitted with fine mesh screening to keep out dust and parasites that can affect the plants growing inside the greenhouse,
wherein the plurality of dampers are employed to specially angled to control the plurality of vents to self-adjust their pressure output such that air from all of the vents is maximized and equalized at the same time to avoid a situation where the air that goes into the swirl chamber (27) from those vents with maximum airflow end up leaking into the low airflow vents which are vents that do not produce much heated airflow upward, and the low airflow vents siphon off the air from the surrounding chutes (1), reducing the power of air that goes to the swirl chamber (27) and then the vortex inside the swirl chamber (27),
wherein the orifice closure device (35) in the center of the roof above the swirl chamber (27) is used to seal the heated air inside the greenhouse during cold nights,
wherein the plurality of pumps (49) comprises pumps (49) carrying various liquids from one place to an+96+ other in and around the greenhouse, with each pump (49) having a rotary pump for a liquid and an electric motor for driving the pump (49), wherein the liquid is selected from a group consisting of antifreeze solution; cool clean, non-salty fresh water; hot clean, non-salty fresh water; and
nutrient-rich water, wherein the plurality of pumps (49) are powered by the turbine (10) at the top of the greenhouse,
wherein the network of piping systems (53) moves the various liquids from one place to another in and around the greenhouse, pumped by the plurality of pumps (49),
wherein the interior of the greenhouse (55) further comprises a plurality of hydroponic systems (57), and a plant growth lighting system (54) to support year-round plant cultivation and growth, and
wherein the solar heat collectors (48) are an array of simple black corrugated metal panels that use surface of the corrugated metal panels to transfer the heat from the Sun to the antifreeze solution running over it to result in heated antifreeze solution and capture the heated antifreeze solution and transfer it to the next solar heat collector in the plurality of the solar heat collectors (48).

2. The greenhouse of claim 1, wherein the chutes (1) are dimensioned and the roof is oriented according to latitude-specific angles to maximize exposure to the Sun, wherein the latitude-specific angles are based upon the latitude of the location of the greenhouse on Earth, wherein the latitude is the angle at which the greenhouse is situated on the Earth away from the Equator.

3. The greenhouse of claim 1, wherein the reflective film (22) comprises ultraviolet and infrared reflective, transparent Mylar film that reflects the ultraviolet and infrared light from the Sun up into the chutes (1) in the enclosure formed between the upper pane (19) and the lower pane (20) of the chutes (1), and the heat-absorbing material screen (21) comprises a removable cloth screen with adjustable absorption which is a high-temperature, removable cloth weave material that reduces loss of heat coming into the chutes (1) from the upper pane (19) by absorption from the Sun and to keep the heat within the chutes (1) of the greenhouse, wherein the heat-absorbing material screen (21) is attached on top of the reflective film (22), the reflective film (22) is attached on top of the lower pane (20) of the chutes (1) as viewed from the bottom of the roof of the greenhouse, and the upper pane (19), the lower pane (20), the heat-absorbing material screen (21), and the reflective film (22) in the chutes maximize energy capture from the Sun.

4. The greenhouse of claim 1, wherein the cone (2) has a wide upper opening and a narrow lower opening as a right-side-up cone as a funnel for exhausting the vortex oriented upwards and is configured to reduce drag on the vortex compared to an inverted cone, and the cone (2) is supported and held upright by the stack (16), which is a cylindrical structure just above the turbine (10) situated inside the swirl chamber (27).

5. The greenhouse of claim 1, wherein the plurality of misters (34) comprising misting nozzles and pipes comprise misters for the interior of the greenhouse (34a) that inject moisture formed by spraying a fine mist of water vapor into the heated air rising and pouring upwards from the interior of the greenhouse (55) through the interior greenhouse vents (29) to provide a saturated air environment to maximize plant growth inside the greenhouse (55) and to maintain the temperature inside the greenhouse by using the water vapor coming into the greenhouse by the misters for the interior of the greenhouse (34a) to cool down the heated air inside the interior of the greenhouse (55), and misters for the chutes (34b) that inject moisture formed by spraying a fine mist of heated water vapor into the heated air rising and pouring upwards from the each of the chutes (1) towards the turbine (10) through the chute vents (28) to increase the heated air pressure of the heated air flowing in the swirl chamber (27) to striking the blades of the turbine (43) forming a vortex to engulf and rotate the blades of the turbine (43) to enhance vortex strength and produce electricity more efficiently, wherein the misters for the interior of the greenhouse (34a) have switchable valves regulating the pipes of the misters for the interior of the greenhouse (34a) and the misters for the interior of the greenhouse (34a) are turned on by the switchable valves that open when the heat in the interior of the greenhouse (55) hits above a first minimum set temperature, and wherein the misters for the chutes (34b) have switchable valves regulating the pipes of the misters for the chutes (34b) and the misters for the chutes (34b) are turned on by the switchable valves that open when the heat in the chutes (1) hits below a second minimum set temperature.

6. The greenhouse of claim 1, wherein the storage tank for antifreeze solution (50) is a composite of two tanks, a large insulated tank that has a large copper coil inside it wrapped around a second, smaller tank that holds the antifreeze solution with a capacity to fill the plurality of radiators (46) encircling the lower walls of the interior of the greenhouse (55), the plurality of solar heat collectors (48), and the network of piping systems (53) connecting the solar heat collectors (48) located outside the greenhouse to the plurality of radiators (46) inside the interior of the greenhouse (55), wherein the large copper coil wrapped around the smaller tank inside the large insulated tank within the storage tank for antifreeze solution (50) acts as a heat exchanger, while the larger tank acts as an antifreeze-buffered thermal storage tank for supplying heated water to the misters for the chutes (34b) supplying heated water in the chutes (1), and wherein the antifreeze solution is pumped back through the small tank within the storage tank for antifreeze solution (50) on to the field of an array of solar heat collectors (52) until the small tank reaches a set temperature to maintain the cycle of antifreeze heating.

7. The greenhouse of claim 1, wherein the plurality of dampers and actuators (24) are operatively coupled to the chutes (1) and swirl chamber (27), said plurality of dampers being automatically controlled by thermostats (41) and anemometers (40) to regulate airflow into and out of the greenhouse.

8. A combined power-generation and plant-growing system, comprising:
a solar vortex, clamshell-shaped, energy conversion, and plant growing dual-purpose greenhouse enclosure having a clamshell-shaped roof with a solar-energy and heat collecting plurality of multi-paned, paired trapezoidal chutes (1) arranged in a clamshell shape around a central chamber supported by a plurality of beams for roof support, a plurality of concrete piers (5) to support the base of the greenhouse, a central support pole (12) that provides support for the roof of the greenhouse;
a hydroponic plant growth system comprising a plurality of hydroponic systems (57) disposed inside the enclosure in the central chamber in the interior of the greenhouse (55);
a vortex airflow generating system comprising a plurality of vanes, including chute vanes (32) and a interior greenhouse vanes (33) arranged around a swirl chamber (27) located at the top of the greenhouse and configured to guide heated air into a vortex of pressurized heated airflow referred to as the vortex, a plurality of vents, including chute vents (28) and interior greenhouse vents (29), and chute dampers (30) and interior greenhouse dampers (33), and a plurality of sails (39);
an electric wind turbine (10) positioned in the swirl chamber (27) to generate electrical energy from the vortex airflow;
a temperature regulation system comprising a plurality of solar heat collectors (48), at least one storage tank for antifreeze solution (50), at least one storage tank for clean, non-salty fresh water (51), a field of an array of solar heat collectors (52), a network of piping systems (53), a plurality of pumps (49), a plurality of radiators (46), electric ventilation shutters (11), an emergency pressure relief shutters (42), a plurality of thermostats (41), a plurality of actuators (24) with a photocell sensor on top, a plurality of misters (34), an orifice closure device (35), an operable damper door (23), chute dampers (30), interior greenhouse dampers (31), a spring and latch system (37), and a stack (16) and cone (2) assembly at the top of the greenhouse, configured to regulate greenhouse temperature by circulating antifreeze and water;
a control system inside an equipment building (8) with a plurality of electrical equipment (13) inside it, integrating power output from the electric wind turbine (10), climate control sensors including the plurality of thermostats (41), the plurality of actuators (24) with a photocell sensor on top, an a plurality of anemometers (40), the plurality of radiators (46), a plurality of solar heat collectors (48), a plurality of pumps (49), at least one storage tank for antifreeze solution (50), the at least one storage tank for clean, non-salty fresh water (51), the field of an array of solar heat collectors (52), the network of piping systems (53); and
an irrigation system made of the plurality of hydroponic systems (57), a plant growth lighting system (54) inside a climate-controlled interior of the greenhouse (55) configured for hydroponic cultivation of plants beneath the chutes (1) forming the roof of the greenhouse, clean, non-salty fresh water piping systems (53b) that connect the storage tank for clean, non-salty fresh water (51) to the interior of the greenhouse (55) to supply the clean, non-salty fresh water to the plurality of misters (34) throughout the greenhouse, at least one storage tank for nutrient-rich water (56), and a plurality of hydroponic systems (57),
wherein the clamshell-shaped geometry of the roof of the greenhouse formed by the plurality of multi-paned, paired trapezoidal chutes (1) arranged radially around a central axis comprises a convex outer surface and a concave inner surface configured to focus solar radiation and guide airflow toward the swirl chamber (27),
wherein the clamshell-shaped geometry of the roof of the greenhouse induces spiral flow vectors converging toward a central axis,
wherein the solar vortex, clamshell-shaped, energy conversion, and plant growing dual-purpose greenhouse further comprises the plurality of multi-paned, paired trapezoidal chutes (1) around a central chamber, the chutes (1) altogether assembled into the clamshell configuration, each of the chutes (1) including transparent outer covers on top and bottom of the chutes (1) as top and bottom layers referred to as panes, a reflective film (22), and a heat-absorbing material screen (21) in between the top and bottom outer covers as intermediate layers, configured to heat air inside the cavity formed between the transparent outer covers on top and bottom of the chutes (1) by exposure to the Sun and direct the heated air upward inside the greenhouse, the plurality of beams supporting the top and bottom of the chutes (1) and forming the sides of the chutes (1), with the top rails or joists of the beams (3) of the plurality of beams holding the sides and edges of the chutes (1) forming the roof of the greenhouse, by standard joists for roof support, the plurality of concrete piers (5) as strong footings supporting the greenhouse base, a plurality of columns (25), and keeping the greenhouse structure solid under extreme wind conditions, the plurality of vanes configured to impart a rotational direction to the heated air, including upper vanes referred to as the chute vanes (32), and lower vanes referred to as the interior greenhouse vanes (33), arranged around the swirl chamber (27) at the top of the greenhouse, configured to guide the heated air into a vortex of pressurized heated airflow referred to as the vortex, the plurality of vents, including upper vents referred to as the chute vents (28), and lower vents referred to as the interior greenhouse vents (29), to pour the heated air into the swirl chamber (27), the electric wind turbine (10) with blades of the turbine (43) positioned within the swirl chamber (27) rotated by the vortex, and operable to convert kinetic energy of the vortex formed by the heated air pouring into the swirl chamber (27) from the chutes (1) and the interior of the greenhouse (55) into electricity, the stack (16) and cone (2) assembly at the top of the greenhouse, positioned above the swirl chamber (27) to stabilize and vertically guide the vortex upwards to exhaust out of an orifice located above the swirl chamber (27) at the top of the greenhouse, a plurality of shutters that form an air-cooling system, including the electric ventilation shutters (11) and the emergency pressure relief shutters (42), the plurality of dampers including the operable damper door (23), upper dampers for the chute vanes (32) referred to as the chute dampers (30), and lower dampers for the interior greenhouse vanes (33) referred to as the interior greenhouse dampers (31), a catwalk (6) around the top of the greenhouse with a ladder (7) to reach the catwalk (6) for easy access to the interior of the swirl chamber (27) and the vortex-producing equipment, a central mono pole support for the roof of the greenhouse, referred to as the central support pole (12), the plurality of sails (39) positioned within the central chamber to impart rotational motion to the heated air rising from the interior of the greenhouse (55) and guiding the heated air up to the interior greenhouse vanes (33), at least one structural ring (38) consisting of an upper structural ring (38a) and a lower structural ring (38b), a perforated metal panel (44) at the top of the stack (16) that allows the heated air to flow from the emergency pressure relief shutters (42), along the outside of the cone (2), and then out of the perforated metal panel (44) at the top of the stack (16), an attachment (47) of the plurality of sails (39) to a plurality of columns (25) at each of the corners of the greenhouse, a plurality of diagonal braces (45) attached to the angles of the sides of the greenhouse, to help keep a plurality of columns (25) vertical and sides square, a climate-controlled interior of the greenhouse (55) configured for hydroponic cultivation of plants beneath the chutes (1) forming the roof of the greenhouse, with a gravel base (14) floor of the greenhouse and Lexan panels referred to as Lexan windows (15) for allowing natural light to enter along all the sides of the greenhouse into the interior of the greenhouse (55) for the growth of the plants,
wherein the plurality of multi-paned, paired trapezoidal chutes (1) comprises triangular modules arranged in a substantially circular array, and each of the chutes (1) is wider at the bottom than at the top to accelerate airflow upward inside the chutes (1), and is at least double-paned, meaning it has two panes,
wherein the plurality of beams has each of the beams as a standard-type beam with webbing in its center and top rails or joists of the beams (3) with ends that are bolted to the central structural ring (38) that surrounds the turbine (10) at the top of the roof, and the bottom rails or joists of the beams (18) with ends that are bolted to the plurality of columns (25) that form the edges of the multiple sides of the building,
wherein the beams are comprised of the top rails or joists of the beams (3), the bottom rails or joists of the beams (18), a webbing made of metal in the center of the beams (9) for Lexan sheathing that supports the top rails or joists of the beams (3), the bottom rails or joists of the beams (18), sheets of Lexan plastic panels (17) that seal the central webbing area encasing both sides of the webbing inside the beams,
wherein the plurality of beams is structured such that in the Northern Hemisphere, the two centermost, longest beams face directly South to match the Sun's highest location in the sky in that hemisphere such the Sun shines directly inside them during the longest day of the summer, and in the Southern Hemisphere, the two centermost, longest beams face directly North to match the Sun's highest location in the sky in that hemisphere such the Sun shines directly inside them during the longest day of the Winter, while the remaining beams are mounted at angles consecutively higher on both the West and East sides such that the final beams at the end of each side are more elevated than the centermost chutes (1) forming the roof of the greenhouse,
wherein the central support pole (12) placement inside the greenhouse is structured such that it lays the plurality of beams and the plurality of multi-paned, paired trapezoidal chutes (1) back to internally transmit more Solar energy throughout the year when the position of the Sun varies in height,
wherein the transparent outer covers in the chutes (1) provide shape to the roof of the greenhouse for visible light capture, and heating of air in the greenhouse, and the two panes heat the ambient air inside the double-paned chutes (1) to generate pressurized heated airflow, the ambient air is the air that entered from a lower intake opening of the chutes (4) at each of the chutes (1),
wherein the two panes in the double-paned chutes (1) include a top plastic, UV-resistant, and transparent sheet covering for the roof of the greenhouse, referred to as upper pane (19) of the chutes (1), and a bottom plastic and transparent sheet covering of the roof for the greenhouse, referred to as lower pane (20) of the chutes (1),
wherein the upper pane (19) of the chutes (1) covers the clamshell configuration of the greenhouse in its entirety as the top pane of the roof of the greenhouse,
wherein the plurality of multi-paned, paired trapezoidal chutes (1) forming the roof of the greenhouse has each of the double-paned chutes (1) between the plurality of beams with a trapezoidal passage, the lower intake opening of the chutes (4), and one of the chute vanes (32) at the top of each of the chutes (1),
wherein the trapezoidal passage which forms an air chamber (26) by the sheets of Lexan plastic panels (17) that seal with the use of silicon caulk the central webbing area encasing both sides of the webbing inside the beams, the upper pane (19) of the chutes (1) and the lower pane (20) of the chutes (1) forming the roof of the greenhouse and the chute dampers (30) sealing the top of the chutes (1), and operable damper door (23) sealing the bottom of the chutes (1) and altogether the air chamber (26) so formed is completely sealed to move the heated air inside the chutes (1),
wherein the chutes (1), altogether assembled into a clamshell configuration, are oriented at an angle substantially perpendicular to incoming solar rays from the Sun at the latitude of installation of the greenhouse, meaning the latitude where the greenhouse is located on the Earth,
wherein the chute vents (28) pour the heated air coming from the chutes (1) into the chute vanes (32) that surround the swirl chamber (27), and the interior greenhouse vents (29) pour the heated air coming from the interior of the greenhouse (55) into the interior greenhouse vanes (33) that surround the swirl chamber (27),
wherein the swirl chamber (27) has the chute vents (28), the chute vanes (32), the interior greenhouse vents (29), and the interior greenhouse vanes (33) are angled counterclockwise when the greenhouse is located in the Northern Hemisphere of the Earth and clockwise when the greenhouse is located in the Southern Hemisphere of the Earth to take advantage of the Coriolis forces which tend to spin a vortex in a counterclockwise direction in the Northern Hemisphere and spin a vortex in a counterclockwise direction in the Southern Hemisphere,
wherein the vortex is produced from the heated air partly produced in the chutes (1) by heating ambient air entering the chutes (1) from lower intake openings (4) for the chutes (1) are formulated to resist ultraviolet light from the Sun, so they do not break down from exposure to the Sun,
wherein the chutes (1) produce an extra capacity hot air pressure system that rotates the blades of the turbine (43) that drives electrical energy production by the turbine (10) at the top of the clamshell,
wherein the stack (16) and cone (2) assembly allow the vortex to pass directly in the center of the turbine (10) oriented towards the top of the greenhouse, protects against drag, keeps the vortex vertical, and protects it from side winds,
wherein the electrical equipment (13) inside the equipment building (8) thermostatically controls the plurality of shutters, the plurality of dampers, and the orifice door system to regulate airflow and temperature in the greenhouse,
wherein the electric wind turbine (10) is positioned below the cone (2) in an assembly that allows the vortex to exhaust out of the greenhouse as its rotational airflow is converted into electricity by rotating the blades of the turbine (43),
wherein the turbine (10) generates electricity which is stored in grid-scale batteries, which are part of the plurality of electrical equipment (13) inside the equipment building (8), and powers both greenhouse operations and external systems,
wherein the emergency pressure relief shutters (42) are positioned adjacent to but outside the swirl chamber (27), configured to vent excess air pressure in response to the turbine (10) over-revving, causing electrical problems, or destructive wind conditions, thereby protecting the greenhouse and maintaining plant-sustaining temperatures inside the greenhouse,
wherein the plurality of columns (25) supports the corners of each of the sides of the greenhouse and the bottom edges of the beams (3),
wherein the orifice closure device (35) is positioned above the swirl chamber to shut off upward airflow in response to environmental conditions selectively,
wherein the plurality of dampers has a spring and latch system (37) for each of the dampers to seal the dampers, the spring and latch system (37) comprising a snap latch (37a), an electric striker plate (37b), and a spring-loaded adjustable hinge (37c), and the spring and latch system is configured to regulate the opening and closing of each of the dampers based on and in response to air pressure and temperature actuated by signals from the plurality of actuators (24), the plurality of anemometers (40), and the plurality of thermostats (41),
wherein the plurality of thermostats (41) is calibrated to maintain interior temperatures inside the interior of the greenhouse (55) between 45° F. and 85° F. for optimal plant growth,
wherein the plurality of anemometers (40) is situated at the top of the greenhouse at the handrails of the catwalk (6) and sends a signal to close the orifice closure device (35) if the wind outside is above a destructive speed that makes the vortex dangerous for buildings around the greenhouse,
wherein the sides undergo structural expansion and contraction due to temperature changes, as part of the structure is heated by the Sun while another part remains in shade,
wherein the central support pole (12) has four angular supports to hold up the structural ring (38),
wherein the central support pole (12) supports the internal structure inside the greenhouse, including the interior greenhouse vanes (33), the turbine (10), the cone (2), and the stack (16) to hold them in place with angled supports holding a lower structural ring (38b),
wherein the upper structural ring (38a) is attached to the catwalk (6) and is situated just above the blades of the turbine (43), and the orifice closure device (35) is supported and encircled by the upper structural ring (38a),
wherein the plurality of sails (39) comprises transparent sheets arranged in a corkscrew configuration and encircle the interior of the greenhouse (55) to impart rotational motion to the heated air from the interior of the greenhouse (55),
wherein the plurality of sails (39) is shaped into long trough-shaped structures that capture the rising heated air and nudge it into a slow-moving vortex that then rises into the interior greenhouse vanes (33) to spin the interior air more quickly, until that air is sucked into the faster-moving air flowing to the swirl chamber (27) from the chutes (1),
wherein the greenhouse with the clamshell-shaped roof maintains the temperature inside the greenhouse for the plants growing in the interior of the greenhouse (55), and for the heated air inside the greenhouse, in part by sending the heated air up and out of the greenhouse to exhaust out of the greenhouse via the cone (2),
wherein the greenhouse with the clamshell-shaped roof maximizes the exposure to the Sun without burning the plants growing inside the interior of the greenhouse (55), via various mechanisms including through absorption of the Sun's heat onto the gravel base (14) floor of the greenhouse, having large shuttered openings via the electric ventilation shutters (11) to allow in ambient air to the greenhouse,
wherein the plurality of anemometers (40), which are wind speed sensors located on top of the greenhouse, the plurality of thermostats (41), which are temperature sensors located at different locations on top of and inside the greenhouse, and the plurality of actuators (24) with photocell sensors, regulate opening and closing of the plurality of dampers including the operable damper door (23), the chute dampers (30), and the interior greenhouse dampers (31), and opening and closing of the plurality of shutters including the electric ventilation shutters (11) and the emergency pressure relief shutters (42),
wherein the plurality of shutters, including the electric ventilation shutters (11) and the emergency pressure relief shutters (42), are remote-controlled and powered interconnected for greenhouse ventilation for air cooling and pressure relief,
wherein the equipment building (8) is sealed with a pressure seal damper to maintain an airlock when the temperature outside is low, as sensed by the plurality of thermostats (41), or when the winds are high, as sensed by the plurality of anemometers (40) and holds the electrical equipment (13) including a heavy-duty, high-capacity battery and an electrical inverter like that used for the electrical grid to take the alternating current electricity from the turbine (10) and turn that alternating current electricity into the direct current electricity used by the battery,
wherein the ladder (7) is located above the equipment building (8) that rises to the catwalk (6) that provides easy access to the interior of the vortex-producing equipment inside the swirl chamber (27),
wherein the electric ventilation shutters (11) located along the sides of the greenhouse are thermostatically controlled by signals from the plurality of thermostats (41) to open when the temperature in the interior of the greenhouse (55) is above a set temperature and close when the temperature in the interior of the greenhouse (55) is below the set temperature,
wherein the electric ventilation shutters (11), the emergency pressure relief shutters (42), the orifice closure device (35), the stack (16) and cone (2) assembly, the lower intake openings (4), any other inlets of air into the greenhouse, and any other exhaust vents of air to the outside from inside the greenhouse are fitted with fine mesh screening to keep out dust and parasites that can affect the plants growing inside the greenhouse,
wherein the plurality of dampers are employed to specially angled to control the plurality of vents to self-adjust their pressure output such that air from all of the vents is maximized and equalized at the same time to avoid a situation where the air that goes into the swirl chamber (27) from those vents with maximum airflow end up leaking into the low airflow vents which are vents that do not produce much heated airflow upward, and the low airflow vents siphon off the air from the surrounding chutes (1), reducing the power of air that goes to the swirl chamber (27) and then the vortex inside the swirl chamber (27),
wherein the orifice closure device (35) in the center of the roof above the swirl chamber (27) is used to seal the heated air inside the greenhouse during cold nights,
wherein the plurality of pumps (49) comprises pumps (49) carrying various liquids from one place to another in and around the greenhouse, with each pump (49) having a rotary pump for a liquid and an electric motor for driving the pump (49), wherein the liquid is selected from a group consisting of antifreeze solution; cool clean, non-salty fresh water; hot clean, non-salty fresh water; and nutrient-rich water, wherein the plurality of pumps (49) are powered by the turbine (10) at the top of the greenhouse,
wherein the network of piping systems (53) moves the various liquids from one place to another in and around the greenhouse, pumped by the plurality of pumps (49),
wherein the solar heat collectors (48) comprise an array of corrugated solar absorbers circulating antifreeze fluid to the radiators (43) along interior walls of the interior of the greenhouse (55), wherein the array of corrugated solar absorbers use surface of the corrugated metal panels to transfer the heat from the Sun to the antifreeze solution running over it to result in heated antifreeze solution and capture the heated antifreeze solution and transfer it to the next solar heat collector in the plurality of the solar heat collectors (48),
wherein the hydroponic system is configured to operate without soil using nutrient-rich water circulated through the storage tank for nutrient-rich water (56) by a plurality of pumps (49) powered by the turbine (10) to support year-round plant cultivation and growth inside the interior of the greenhouse (55),
wherein the plurality of sails (39) suspended below the roof of the greenhouse and arranged to guide rising heated air from the interior of the greenhouse (55) into the interior greenhouse vanes (33),
wherein the plant growth lighting system (54) provides supplemental grow lighting that is powered by the electricity generated by the electric wind turbine (10) to extend plant growing hours inside the greenhouse, and it is supplemental to the natural light from the Lexan windows (15) during the daytime,
wherein the combined power-generation and plant-growing system simultaneously produces electricity and cultivates crops using only solar energy and water inputs, and
wherein the combined power-generation and plant-growing system is particularly suitable for low-water areas, including areas undergoing desertification, and areas that are deserts.

9. The system of claim 8, wherein the chutes (1) are dimensioned and the roof is oriented according to latitude-specific angles to maximize exposure to the Sun, wherein the latitude-specific angles are based upon the latitude of the location of the greenhouse on Earth, wherein the latitude is the angle at which the greenhouse is situated on the Earth away from the Equator.

10. The system of claim 8, wherein the reflective film (22) comprises ultraviolet and infrared reflective, transparent Mylar film that reflects the ultraviolet and infrared light from the Sun up into the chutes (1) in the enclosure formed between the upper pane (19) and the lower pane (20) of the chutes (1), and the heat-absorbing material screen (21) comprises a removable cloth screen with adjustable absorption which is a high-temperature, removable cloth weave material that reduces loss of heat coming into the chutes (1) from the upper pane (19) by absorption from the Sun and to keep the heat within the chutes (1) of the greenhouse, wherein the heat-absorbing material screen (21) is attached on top of the reflective film (22), the reflective film (22) is attached on top of the lower pane (20) of the chutes (1) as viewed from the bottom of the roof of the greenhouse, and the upper pane (19), the lower pane (20), the heat-absorbing material screen (21), and the reflective film (22) in the chutes maximize energy capture from the Sun.

11. The system of claim 8, wherein the cone (2) has a wide upper opening and a narrow lower opening as a right-side-up cone as a funnel for exhausting the vortex oriented upwards and is configured to reduce drag on the vortex compared to an inverted cone, and the cone (2) is supported and held upright by the stack (16), which is a cylindrical structure just above the turbine (10) situated inside the swirl chamber (27).

12. The system of claim 8, wherein the plurality of misters (34) comprising misting nozzles and pipes comprise misters for the interior of the greenhouse (34a) that inject moisture formed by spraying a fine mist of water vapor into the heated air rising and pouring upwards from the interior of the greenhouse (55) through the interior greenhouse vents (29) to provide a saturated air environment to maximize plant growth inside the greenhouse (55) and to maintain the temperature inside the greenhouse by using the water vapor coming into the greenhouse by the misters for the interior of the greenhouse (34a) to cool down the heated air inside the interior of the greenhouse (55), and misters for the chutes (34b) that inject moisture formed by spraying a fine mist of heated water vapor into the heated air rising and pouring upwards from the each of the chutes (1) towards the turbine (10) through the chute vents (28) to increase the heated air pressure of the heated air flowing in the swirl chamber (27) to striking the blades of the turbine (43) forming a vortex to engulf and rotate the blades of the turbine (43) to enhance vortex strength and produce electricity more efficiently, wherein the misters for the interior of the greenhouse (34a) have switchable valves regulating the pipes of the misters for the interior of the greenhouse (34a) and the misters for the interior of the greenhouse (34a) are turned on by the switchable valves that open when the heat in the interior of the greenhouse (55) hits above a first minimum set temperature, and wherein the misters for the chutes (34b) have switchable valves regulating the pipes of the misters for the chutes (34b) and the misters for the chutes (34b) are turned on by the switchable valves that open when the heat in the chutes (1) hits below a second minimum set temperature.

13. The system of claim 8, wherein the storage tank for antifreeze solution (50) is a composite of two tanks, a large insulated tank that has a large copper coil inside it wrapped around a second, smaller tank that holds the antifreeze solution with a capacity to fill the plurality of radiators (46) encircling the lower walls of the interior of the greenhouse (55), the plurality of solar heat collectors (48), and the network of piping systems (53) connecting the solar heat collectors (48) located outside the greenhouse to the plurality of radiators (46) inside the interior of the greenhouse (55), wherein the large copper coil wrapped around the smaller tank inside the large insulated tank within the storage tank for antifreeze solution (50) acts as a heat exchanger, while the larger tank acts as an antifreeze-buffered thermal storage tank for supplying heated water to the misters for the chutes (34b) supplying heated water in the chutes (1), and wherein the antifreeze solution is pumped back through the small tank within the storage tank for antifreeze solution (50) on to the field of an array of solar heat collectors (52) until the small tank reaches a set temperature to maintain the cycle of antifreeze heating.

14. The system of claim 8, wherein the plurality of dampers and actuators (24) are operatively coupled to the chutes (1) and swirl chamber (27), said plurality of dampers being automatically controlled by thermostats (41) and anemometers (40) to regulate airflow into and out of the greenhouse, and wherein the heated airflow circulation within the greenhouse moderates temperature and prevents humidity buildup.

15. A method of generating electricity while cultivating plants within a solar vortex greenhouse, the method comprising the steps of:
orienting a clamshell-shaped roof comprising a plurality of multi-paned, paired trapezoidal chutes (1) around a central chamber toward the Equator at a slope angle based on the latitude of installation of the greenhouse and transmitting solar radiation through the chutes (1);
admitting ambient air into the chutes (1) through a lower intake opening of the chutes (4) at each of the chutes (1);
heating the ambient air within the chutes (1) using solar radiation from the Sun transmitted through transparent covers and reflected by interior coatings inside the chutes (1) to produce heated air and humidifying the heated air within the enclosure to produce heated and humidified air;
accelerating the heated and humidified air upward through the narrowing geometry of the chutes (1);
directing the heated and humidified air into a swirl chamber (27) via a plurality of vanes to impart rotational motion to the heated air, thereby forming a vortex;
using a plurality of sails (39) suspended below the roof of the greenhouse in the interior of the greenhouse (55) to guide rising heated air from the interior of the greenhouse (55) toward the swirl chamber (27), thereby supplementing the vortex airflow;
spinning an electric wind turbine (10) with the vortex airflow to generate electricity;
exhausting the vortex upward through a cone (2) and stack (16) assembly;
misting the heated air within the chutes (1) with water droplets and water vapor to increase air pressure and enhance vortex strength;
opening and closing a plurality of dampers and at least one orifice door system in response to signals from a plurality of thermostats (40), a plurality of anemometers (41), and a plurality of actuators (24) with a photocell sensor on top of each of the actuators, automatically to maintain plant-sustaining environmental conditions;
storing electricity generated by the electric wind turbine (10) in grid-scale batteries, which are equipment within a plurality of electrical equipment (13), and distributing excess power to external loads;
cultivating hydroponic plants on an interior gravel base (14), with nutrient solutions circulated by pumps powered by electricity generated by the electric wind turbine (10); and
regulating temperature and humidity inside the greenhouse for cultivating plants in a climate-controlled interior of the greenhouse (55),
wherein the chutes (1) altogether assembled into a clamshell configuration, each of the chutes (1) including transparent outer covers on top and bottom of the chutes (1) as top and bottom layers referred to as panes, a reflective film (22), and a heat-absorbing material screen (21) in between the top and bottom outer covers as intermediate layers, configured to heat air inside the cavity formed between the transparent outer covers on top and bottom of the chutes (1) by exposure to the Sun and direct the heated air upward inside the greenhouse,
wherein the greenhouse further comprises a plurality of beams supporting the top and bottom of the chutes (1) and forming the sides of the chutes (1), with the top rails or joists of the beams (3) holding the sides and edges of the chutes (1) forming the roof of the greenhouse, by standard joists for roof support, a plurality of concrete piers (5) as strong footings supporting the greenhouse base, a plurality of columns (25), and keeping the greenhouse structure solid under extreme wind conditions, the plurality of vanes configured to impart a rotational direction to the heated air, including upper vanes referred to as chute vanes (32), and lower vanes referred to as interior greenhouse vanes (33), arranged around the swirl chamber (27) at the top of the greenhouse, configured to guide the heated air into a vortex of pressurized heated airflow referred to as the vortex, a plurality of vents, including upper vents referred to as chute vents (28), and lower vents referred to as interior greenhouse vents (29), to pour the heated air into the swirl chamber (27), the electric wind turbine (10) with blades of the turbine (43) positioned within the swirl chamber (27) rotated by the vortex, and operable to convert kinetic energy of the vortex formed by the heated air pouring into the swirl chamber (27) from the chutes (1) and the interior of the greenhouse (55) into electricity, the cone (2) and stack (16) assembly at the top of the greenhouse, positioned above the swirl chamber (27) to stabilize and vertically guide the vortex upwards to exhaust out of an orifice located above the swirl chamber (27) at the top of the greenhouse, a plurality of shutters that form an air-cooling system, including electric ventilation shutters (11) and emergency pressure relief shutters (42), the plurality of dampers including an operable damper door (23), upper dampers for chute vanes (32) referred to as chute dampers (30), and lower dampers for interior greenhouse vanes (33) referred to as interior greenhouse dampers (31), the at least one orifice door system referred to as an orifice closure device (35), a plurality of misters (34), a plurality of radiators (46), a catwalk (6) around the top of the greenhouse with a ladder (7) to reach the catwalk (6) for easy access to the interior of the swirl chamber (27) and vortex-producing equipment, an equipment, airlock control, and maintenance building referred to as equipment building (8) with the plurality of electrical equipment (13) inside it, a central mono pole support for the roof of the greenhouse, referred to as a central support pole (12), a plurality of sails (39) positioned within the central chamber to impart rotational motion to the heated air rising from the interior of the greenhouse (55) and guiding the heated air up to the interior greenhouse vanes (33), at least one structural ring (38) consisting of an upper structural ring (38a) and a lower structural ring (38b), a perforated metal panel (44) at the top of the stack (16) that allows the heated air to flow from the emergency pressure relief shutters (42), along the outside of the cone (2), and then out of the perforated metal panel (44) at the top of the stack (16), an attachment (47) of the plurality of sails (39) to the plurality of columns (25) at each of the corners of the greenhouse, a plurality of solar heat collectors (48), a plurality of pumps (49), at least one storage tank for antifreeze solution (50), at least one storage tank for clean, non-salty fresh water (51), at least one storage tank for nutrient-rich water (56), a field of an array of solar heat collectors (52), a network of piping systems (53), a plurality of diagonal braces (45) attached to the angles of the sides of the greenhouse, to help keep a plurality of columns (25) vertical and sides square, and the climate-controlled interior of the greenhouse (55) configured for hydroponic cultivation of plants beneath the chutes (1) forming the roof of the greenhouse, with the gravel base (14) floor of the greenhouse and Lexan panels referred to as Lexan windows (15) for allowing natural light to enter along all the sides of the greenhouse into the interior of the greenhouse (55) for the growth of the plants,
wherein the plurality of multi-paned, paired trapezoidal chutes (1) comprises triangular modules arranged in a substantially circular array, and each of the chutes (1) is wider at the bottom than at the top to accelerate airflow upward inside the chutes (1), and is at least double-paned, meaning it has two panes,
wherein the clamshell-shaped geometry of the roof of the greenhouse formed by the plurality of multi-paned, paired trapezoidal chutes (1) arranged radially around a central axis comprises a convex outer surface and a concave inner surface configured to focus solar radiation and guide airflow toward the swirl chamber (27),
wherein the clamshell-shaped geometry of the roof of the greenhouse induces spiral flow vectors converging toward a central axis,
wherein the heated and humidified air produced by injecting heated water vapor into the rising air in the chutes (1) leads to an increase in enthalpy and buoyancy of the air column in the vortex,
wherein the plurality of beams has each of the beams as a standard-type beam with webbing in its center and top rails or joists of the beams (3) with ends that are bolted to a central structural ring (38) that surrounds the turbine (10) at the top of the roof, and bottom rails or joists of the beams (18) with ends that are bolted to the plurality of columns (25) that form the edges of the multiple sides of the building,
wherein the beams are comprised of the top rails or joists of the beams (3), the bottom rails or joists of the beams (18), a webbing made of metal in the center of the beams (9) for Lexan sheathing that supports the top rails or joists of the beams (3), the bottom rails or joists of the beams (18), sheets of Lexan plastic panels (17) that seal the central webbing area encasing both sides of the webbing inside the beams,
wherein the plurality of beams is structured such that in the Northern Hemisphere, the two centermost, longest beams face directly South to match the Sun's highest location in the sky in that hemisphere such the Sun shines directly inside them during the longest day of the summer, and in the Southern Hemisphere, the two centermost, longest beams face directly North to match the Sun's highest location in the sky in that hemisphere such the Sun shines directly inside them during the longest day of the Winter, while the remaining beams are mounted at angles consecutively higher on both the West and East sides such that the final beams at the end of each side are more elevated than the centermost chutes (1) forming the roof of the greenhouse,
wherein the central support pole (12) placement inside the greenhouse is structured such that it lays the plurality of beams and the plurality of multi-paned, paired trapezoidal chutes (1) back to internally transmit more Solar energy throughout the year when the position of the Sun varies in height,
wherein the transparent outer covers in the chutes (1) provide shape to the roof of the greenhouse for visible light capture, and heating of air in the greenhouse, and the two panes heat the ambient air inside the double-paned chutes (1) to generate pressurized heated airflow, the ambient air is the air that entered from a lower intake opening of the chutes (4) at each of the chutes (1),
wherein the two panes in the double-paned chutes (1) include a top plastic, UV-resistant, and transparent sheet covering for the roof of the greenhouse, referred to as upper pane (19) of the chutes (1), and a bottom plastic and transparent sheet covering of the roof for the greenhouse, referred to as lower pane (20) of the chutes (1),
wherein the upper pane (19) of the chutes (1) covers the clamshell configuration of the greenhouse in its entirety as the top pane of the roof of the greenhouse,
wherein the plurality of multi-paned, paired trapezoidal chutes (1) forming the roof of the greenhouse has each of the double-paned chutes (1) between the plurality of beams with a trapezoidal passage, the lower intake opening of the chutes (4), and one of the chute vanes (32) at the top of each of the chutes (1),
wherein the trapezoidal passage which forms an air chamber (26) by the sheets of Lexan plastic panels (17) that seal with the use of silicon caulk the central webbing area encasing both sides of the webbing inside the beams, the upper pane (19) of the chutes (1) and the lower pane (20) of the chutes (1) forming the roof of the greenhouse and the chute dampers (30) sealing the top of the chutes (1), and operable damper door (23) sealing the bottom of the chutes (1) and altogether the air chamber (26) so formed is completely sealed to move the heated air inside the chutes (1),
wherein the chutes (1), altogether assembled into a clamshell configuration, are oriented at an angle substantially perpendicular to incoming solar rays from the Sun at the latitude of installation of the greenhouse, meaning the latitude where the greenhouse is located on the Earth,
wherein the chute vents (28) pour the heated air coming from the chutes (1) into the chute vanes (32) that surround the swirl chamber (27), and the interior greenhouse vents (29) pour the heated air coming from the interior of the greenhouse (55) into the interior greenhouse vanes (33) that surround the swirl chamber (27),
wherein the swirl chamber (27) has the chute vents (28), the chute vanes (32), the interior greenhouse vents (29), and the interior greenhouse vanes (33) are angled counterclockwise when the greenhouse is located in the Northern Hemisphere of the Earth and clockwise when the greenhouse is located in the Southern Hemisphere of the Earth to take advantage of the Coriolis forces which tend to spin a vortex in a counterclockwise direction in the Northern Hemisphere and spin a vortex in a counterclockwise direction in the Southern Hemisphere,
wherein the vortex is produced from the heated air partly produced in the chutes (1) by heating ambient air entering the chutes (1) from lower intake openings (4) for the chutes (1) are formulated to resist ultraviolet light from the Sun, so they do not break down from exposure to the Sun,
wherein the chutes (1) produce an extra capacity hot air pressure system that rotates the blades of the turbine (43) that drives electrical energy production by the turbine (10) at the top of the clamshell,
wherein the stack (16) and cone (2) assembly allow the vortex to pass directly in the center of the turbine (10) oriented towards the top of the greenhouse, protects against drag, keeps the vortex vertical, and protects it from side winds,
wherein the electrical equipment (13) inside the equipment building (8) thermostatically controls the plurality of shutters, the plurality of dampers, and the orifice door system to regulate airflow and temperature in the greenhouse,
wherein the electric wind turbine (10) is positioned below the cone (2) in an assembly that allows the vortex to exhaust out of the greenhouse as its rotational airflow is converted into electricity by rotating the blades of the turbine (43),
wherein the turbine (10) generates electricity which is stored in grid-scale batteries, which are part of the plurality of electrical equipment (13) inside the equipment building (8), and powers both greenhouse operations and external systems,
wherein the emergency pressure relief shutters (42) are positioned adjacent to but outside the swirl chamber (27), configured to vent excess air pressure in response to the turbine (10) over-revving, causing electrical problems, or destructive wind conditions, thereby protecting the greenhouse and maintaining plant-sustaining temperatures inside the greenhouse,
wherein the plurality of columns (25) supports the corners of each of the sides of the greenhouse and the bottom edges of the beams (3),
wherein the orifice closure device (35) is positioned above the swirl chamber to shut off upward airflow in response to environmental conditions selectively,
wherein the plurality of dampers has a spring and latch system (37) for each of the dampers to seal the dampers, the spring and latch system (37) comprising a snap latch (37a), an electric striker plate (37b), and a spring-loaded adjustable hinge (37c), and the spring and latch system is configured to regulate the opening and closing of each of the dampers based on and in response to air pressure and temperature actuated by signals from the plurality of actuators (24), the plurality of anemometers (40), and the plurality of thermostats (41),
wherein the plurality of thermostats (41) is calibrated to maintain interior temperatures between approximately 45° F. and 85° F. for optimal plant growth,
wherein the plurality of anemometers (40) is situated at the top of the greenhouse at the handrails of the catwalk (6) and sends a signal to close the orifice closure device (35) if the wind outside is above a destructive speed that makes the vortex dangerous for buildings around the greenhouse,
wherein the sides undergo structural expansion and contraction due to temperature changes, as part of the structure is heated by the Sun while another part remains in shade,
wherein the central support pole (12) has four angular supports to hold up the structural ring (38),
wherein the central support pole (12) supports the internal structure inside the greenhouse, including the interior greenhouse vanes (33), the turbine (10), the cone (2), and the stack (16) to hold them in place with angled supports holding a lower structural ring (38b),
wherein the upper structural ring (38a) is attached to the catwalk (6) and is situated just above the blades of the turbine (43), and the orifice closure device (35) is supported and encircled by the upper structural ring (38a),
wherein the plurality of sails (39) comprises transparent sheets arranged in a corkscrew configuration and encircle the interior of the greenhouse (55) to impart rotational motion to the heated air from the interior of the greenhouse (55),
wherein the plurality of sails (39) is shaped into long trough-shaped structures that capture the rising heated air and nudge it into a slow-moving vortex that then rises into the interior greenhouse vanes (33) to spin the interior air more quickly, until that air from the interior of the greenhouse (55) is sucked into the faster-moving air from the chutes (1) flowing to the swirl chamber (27) and this additional internal air from the interior of the greenhouse (55) supplements the faster-moving air from the chutes (1),
wherein the greenhouse with the clamshell-shaped roof maintains the temperature inside the greenhouse for the plants growing in the interior of the greenhouse (55), and for the heated air inside the greenhouse, in part by sending the heated air up and out of the greenhouse to exhaust out of the greenhouse via the cone (2),
wherein the greenhouse with the clamshell-shaped roof maximizes the exposure to the Sun without burning the plants growing inside the interior of the greenhouse (55), via various mechanisms including through absorption of the Sun's heat onto the gravel base (14) floor of the greenhouse, having large shuttered openings via the electric ventilation shutters (11) to allow in ambient air to the greenhouse,
wherein the plurality of anemometers (40), which are wind speed sensors located on top of the greenhouse, the plurality of thermostats (41), which are temperature sensors located at different locations on top of and inside the greenhouse, and the plurality of actuators (24) with photocell sensors, regulate opening and closing of the plurality of dampers including the operable damper door (23), the chute dampers (30), and the interior greenhouse dampers (31), and opening and closing of the plurality of shutters including the electric ventilation shutters (11) and the emergency pressure relief shutters (42),
wherein the plurality of shutters, including the electric ventilation shutters (11) and the emergency pressure relief shutters (42), are remote-controlled and powered interconnected for greenhouse ventilation for air cooling and pressure relief,
wherein the equipment building (8) is sealed with a pressure seal damper to maintain an airlock when the temperature outside is low, as sensed by the plurality of thermostats (41), or when the winds are high, as sensed by the plurality of anemometers (40) and holds the electrical equipment (13) including a heavy-duty, high-capacity battery and an electrical inverter like that used for the electrical grid to take the alternating current electricity from the turbine (10) and turn that alternating current electricity into the direct current electricity used by the battery,
wherein the ladder (7) is located above the equipment building (8) that rises to the catwalk (6) that provides easy access to the interior of the vortex-producing equipment inside the swirl chamber (27),
wherein the electric ventilation shutters (11) located along the sides of the greenhouse are thermostatically controlled by signals from the plurality of thermostats (41) to open when the temperature in the interior of the greenhouse (55) is above a set temperature and close when the temperature in the interior of the greenhouse (55) is below the set temperature,
wherein the electric ventilation shutters (11), the emergency pressure relief shutters (42), the orifice closure device (35), the stack (16) and cone (2) assembly, the lower intake openings (4), any other inlets of air into the greenhouse, and any other exhaust vents of air to the outside from inside the greenhouse are fitted with fine mesh screening to keep out dust and parasites that can affect the plants growing inside the greenhouse,
wherein using the plurality of dampers are specially angled to control the plurality of vents to self-adjust their pressure output such that air from all of the vents is maximized and equalized at the same time to avoid a situation where the air that goes into the swirl chamber (27) from those vents with maximum airflow end up leaking into the low airflow vents which are vents that do not produce much heated airflow upward, and the low airflow vents siphon off the air from the surrounding chutes (1), reducing the power of air that goes to the swirl chamber (27) and then the vortex inside the swirl chamber (27),
wherein the orifice closure device (35) in the center of the roof above the swirl chamber (27) is used to seal the heated air inside the greenhouse during cold nights,
wherein the plurality of pumps (49) comprises pumps (49) carrying various liquids from one place to another in and around the greenhouse, with each pump (49) having a rotary pump for a liquid and an electric motor for driving the pump (49), wherein the liquid is selected from a group consisting of antifreeze solution; cool clean, non-salty fresh water; hot clean, non-salty fresh water; and nutrient-rich water, wherein the plurality of pumps (49) are powered by the turbine (10) at the top of the greenhouse,
wherein the network of piping systems (53) moves the various liquids from one place to another in and around the greenhouse, pumped by the plurality of pumps (49),
wherein the interior of the greenhouse (55) further comprises a plurality of hydroponic systems (57), and a plant growth lighting system (54) to support year-round plant cultivation and growth,
wherein the solar heat collectors (48) are an array of simple black corrugated metal panels that use surface of the corrugated metal panels to transfer the heat from the Sun to the antifreeze solution running over it to result in heated antifreeze solution and capture the heated antifreeze solution and transfer it to the next solar heat collector in the plurality of the solar heat collectors (48).

16. The method of claim 15, wherein the chutes (1) are dimensioned and the roof is oriented according to latitude-specific angles to maximize exposure to the Sun, wherein the latitude-specific angles are based upon the latitude of the location of the greenhouse on Earth, wherein the latitude is the angle at which the greenhouse is situated on the Earth away from the Equator.

17. The method of claim 15, wherein the reflective film (22) comprises ultraviolet and infrared reflective, transparent Mylar film that reflects the ultraviolet and infrared light from the Sun up into the chutes (1) in the enclosure formed between the upper pane (19) and the lower pane (20) of the chutes (1), and the heat-absorbing material screen (21) comprises a removable cloth screen with adjustable absorption which is a high-temperature, removable cloth weave material that reduces loss of heat coming into the chutes (1) from the upper pane (19) by absorption from the Sun and to keep the heat within the chutes (1) of the greenhouse, wherein the heat-absorbing material screen (21) is attached on top of the reflective film (22), the reflective film (22) is attached on top of the lower pane (20) of the chutes (1) as viewed from the bottom of the roof of the greenhouse, and the upper pane (19), the lower pane (20), the heat-absorbing material screen (21), and the reflective film (22) in the chutes maximize energy capture from the Sun.

18. The method of claim 15, wherein the cone (2) has a wide upper opening and a narrow lower opening as a right-side-up cone as a funnel for exhausting the vortex oriented upwards and is configured to reduce drag on the vortex compared to an inverted cone, and the cone (2) is supported and held upright by the stack (16), which is a cylindrical structure just above the turbine (10) situated inside the swirl chamber (27).

19. The method of claim 15, wherein the plurality of misters (34) comprising misting nozzles and pipes comprise misters for the interior of the greenhouse (34a) that inject moisture formed by spraying a fine mist of water vapor into the heated air rising and pouring upwards from the interior of the greenhouse (55) through the interior greenhouse vents (29) to provide a saturated air environment to maximize plant growth inside the greenhouse (55) and to maintain the temperature inside the greenhouse by using the water vapor coming into the greenhouse by the misters for the interior of the greenhouse (34a) to cool down the heated air inside the interior of the greenhouse (55), and misters for the chutes (34b) that inject moisture formed by spraying a fine mist of heated water vapor into the heated air rising and pouring upwards from the each of the chutes (1) towards the turbine (10) through the chute vents (28) to increase the heated air pressure of the heated air flowing in the swirl chamber (27) to striking the blades of the turbine (43) forming a vortex to engulf and rotate the blades of the turbine (43) to enhance vortex strength and produce electricity more efficiently, wherein the misters for the interior of the greenhouse (34a) have switchable valves regulating the pipes of the misters for the interior of the greenhouse (34a) and the misters for the interior of the greenhouse (34a) are turned on by the switchable valves that open when the heat in the interior of the greenhouse (55) hits above a first minimum set temperature, and wherein the misters for the chutes (34b) have switchable valves regulating the pipes of the misters for the chutes (34b) and the misters for the chutes (34b) are turned on by the switchable valves that open when the heat in the chutes (1) hits below a second minimum set temperature, and wherein the storage tank for antifreeze solution (50) is a composite of two tanks, a large insulated tank that has a large copper coil inside it wrapped around a second, smaller tank that holds the antifreeze solution with a capacity to fill the plurality of radiators (46) encircling the lower walls of the interior of the greenhouse (55), the plurality of solar heat collectors (48), and the network of piping systems (53) connecting the solar heat collectors (48) located outside the greenhouse to the plurality of radiators (46) inside the interior of the greenhouse (55), wherein the large copper coil wrapped around the smaller tank inside the large insulated tank within the storage tank for antifreeze solution (50) acts as a heat exchanger, while the larger tank acts as an antifreeze-buffered thermal storage tank for supplying heated water to the misters for the chutes (34b) supplying heated water in the chutes (1), and wherein the antifreeze solution is pumped back through the small tank within the storage tank for antifreeze solution (50) on to the field of an array of solar heat collectors (52) until the small tank reaches a set temperature to maintain the cycle of antifreeze heating.

20. The method of claim 15, wherein the plurality of dampers and actuators (24) are operatively coupled to the chutes (1) and swirl chamber (27), said plurality of dampers being automatically controlled by thermostats (41) and anemometers (40) to regulate airflow into and out of the greenhouse.
